(19) United States
(12) Patent Application Publication
(10) Pub. No.: US 2025/0167954 A1
(43) Pub. Date: May 22, 2025

(54) METHOD AND DEVICE FOR UPLINK DATA CHANNEL TRANSMISSION IN WIRELESS COMMUNICATION SYSTEM

(71) Applicant: Samsung Electronics Co., Ltd., Suwon-si, Gyeonggi-do (KR)

(72) Inventors: Seongmok LIM, Suwon-si (KR); Kyoungmin PARK, Suwon-si (KR); Ameha Tsegaye ABEBE, Suwon-si (KR); Youngrok JANG, Suwon-si (KR); Hyoungju JI, Suwon-si (KR)

(21) Appl. No.: 18/730,651

(22) PCT Filed: Jan. 20, 2023
(86) PCT No.: PCT/KR2023/001002

§ 371 Date: Jul. 19, 2024

(30) Foreign Application Priority Data
Jan. 20, 2022 (KR) 10-2022-0008675

(51) Int. Cl. H04L 5/00; H04B 7/06

(52) U.S. Cl. CPC H04L 5/0051; H04B 7/0639

(57) ABSTRACT

The present disclosure relates to a 5G or 6G communication system for supporting a higher data transmission rate. The present disclosure relates to: a communication technique merging IoT technology with a 5G communication system for supporting a data transmission rate higher than that of a 4G system; and a system therefor. The present disclosure can be applied to intelligent services (for example, smart homes, smart buildings, smart cities, smart cars or connected cars, healthcare, digital education, small business, security- and safety-related services, and the like) on the basis of 5G communication technology and IoT-related technology. According to various embodiments of the present disclosure, a method performed by a base station in a wireless communication system comprises the steps of: receiving terminal capability report information from a terminal; transmitting, to the terminal, an upper layer parameter determined on the basis of the terminal capability report information; receiving, from the terminal, a sounding reference signal (SRS) determined by means of the upper layer parameter; determining downlink control information (DCI) for scheduling a physical uplink shared channel (PUSCH) on the basis of the SRS; transmitting a signal including the DCI to the terminal; and receiving the PUSCH and an uplink (UL) phase tracking reference signal (PTRS) from the terminal.

### TECHNICAL FIELD

The disclosure relates to the operation of a terminal and a base station in a wireless communication system. Specifically, the disclosure relates to a method of determining, by a terminal, precoding for uplink data channel transmission, and a method and a device for configuring a phase tracking reference signal (PTRS) for phase error correction in a wireless communication system.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, defi-nition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to more smoothly provide these services. Especially, required is a method for determining a precoding for effective transmission of uplink data channel and configuring a phase tracking reference signal for phase error correction.

### DISCLOSURE OF INVENTION

### Technical Problem

Various embodiments of the disclosure are to provide a device and a method capable of effectively providing a service in a wireless communication system.

### Solution to Problem

According to embodiments of the disclosure, a method performed by a base station in a wireless communication system may include receiving, from a terminal supporting 8 antenna ports, terminal capability information including information about a number of layers supported by the terminal and information about coherent supported by the terminal, wherein the maximum number of layers supported by the terminal is four or eight, transmitting, in case that the terminal supports partial coherent, to the terminal, configuration information for a coherent group based on a combination of two or four of the antenna ports supported by the terminal, and receiving an uplink signal from the terminal, based on the configuration information for the coherent group.

According to embodiments of the disclosure, a method performed by a terminal in a wireless communication system may include transmitting, to a base station, terminal capability information including information about a number of layers supported by the terminal and information about coherent supported by the terminal, wherein the terminal supports 8 antenna ports and the maximum number of layers supported by the terminal is four or eight, receiving, in case that the terminal supports partial coherent, from the base station, configuration information for a coherent group based on a combination of two or four of the antenna ports supported by the terminal, and transmitting an uplink signal to the base station, based on the configuration information for the coherent group.

According to embodiments of the disclosure, a base station in a wireless communication system may include at least one transceiver, and at least one processor functionally coupled to the at least one transceiver, wherein the at least one processor is configured to receive, from a terminal supporting 8 antenna ports, terminal capability information including information about a number of layers supported by the terminal and information about coherent supported by the terminal, wherein the maximum number of layers supported by the terminal is four or eight, transmit, in case that the terminal supports partial coherent, to the terminal, configuration information for a coherent group based on a combination of two or four of the antenna ports supported by the terminal, and receive an uplink signal from the terminal, based on the configuration information for the coherent group.

According to embodiments of the disclosure, a terminal in a wireless communication system may include at least one transceiver, and at least one processor functionally coupled to the at least one transceiver, wherein the at least one processor is configured to transmit, to a base station, terminal capability information including information about a number of layers supported by the terminal and information about coherent supported by the terminal, wherein the terminal supports 8 antenna ports and the maximum number of layers supported by the terminal is four or eight, receive, in case that the terminal supports partial coherent, from the base station, configuration information for a coherent group based on a combination of two or four of the antenna ports supported by the terminal, and transmit an uplink signal to the base station, based on the configuration information for the coherent group.

### Advantageous Effects of Invention

According to various embodiments of the disclosure, a device and a method capable of effectively providing a service in a wireless communication system are provided.

### DESCRIPTION OF DRAWINGS

FIG. 1 illustrates a basic structure of a time-frequency domain in a wireless communication system according to an embodiment of the disclosure.

FIG. 2 illustrates a structure of a frame, a subframe, and a slot in a wireless communication system according to an embodiment of the disclosure.

FIG. 3 illustrates an example of bandwidth part configuration in a wireless communication system according to an embodiment of the disclosure.

FIG. 4 illustrates an example of control resource set configuration of a downlink control channel in a wireless communication system according to an embodiment of the disclosure.

FIG. 5 illustrates a structure of a downlink control channel in a wireless communication system according to an embodiment of the disclosure.

FIG. 6 illustrates, in terms of spans, an example in which a terminal may have multiple PDCCH monitoring occasions inside a slot in a wireless communication system according to an embodiment of the disclosure.

FIG. 7 illustrates an example of beam allocation by a base station according to TCI state configuration in a wireless communication system according to an embodiment of the disclosure.

FIG. 8 illustrates an example of a method for TCI state allocation with regard to a PDCCH in a wireless communication system according to an embodiment of the disclosure.

FIG. 9 illustrates a TCI indication MAC CE signaling structure for a PDCCH DMRS in a wireless communication system according to an embodiment of the disclosure.

FIG. 10 illustrates beam configuration with regard to a control resource set and a search space in a wireless communication system according to an embodiment of the disclosure.

FIG. 11 illustrates an example of a method in which, upon receiving a downlink control channel, a terminal selects a receivable control resource set in consideration of priority in a wireless communication system according to an embodiment of the disclosure.

FIG. 12 illustrates frequency domain resource allocation with regard to a PDSCH in a wireless communication system according to an embodiment of the disclosure.

FIG. 13 illustrates time domain resource allocation with regard to a PDSCH in a wireless communication system according to an embodiment of the disclosure.

FIG. 14 illustrates time domain resource allocation according to a subcarrier spacing with regard to a data channel and a control channel in a wireless communication system according to an embodiment of the disclosure.

FIG. 15 illustrates PUSCH repeated transmission type B in a wireless communication system according to an embodiment of the disclosure.

FIG. 16 illustrates radio protocol structures of a base station and a terminal in single cell, carrier aggregation, and dual connectivity situations according to an embodiment of the disclosure.

FIG. 17 is a flowchart illustrating an operation flow of a base station for precoding configuration and PTRS configuration based on capability reporting a terminal according to an embodiment of the disclosure.

FIG. 18 is a flowchart illustrating an operation flow of a terminal for precoding configuration and PTRS configuration based on capability reporting a terminal according to an embodiment of the disclosure.

FIG. 19 illustrates a structure of a terminal in a wireless communication system according to an embodiment of the disclosure.

FIG. 20 illustrates a structure of a base station in a wireless communication system according to an embodiment of the disclosure.

### MODE FOR THE INVENTION

Hereinafter, embodiments of the disclosure will be described in detail with reference to the accompanying drawings. In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea. For the same reason, in the accompanying drawings, some elements may be exaggerated, omitted, or schematically illustrated. Furthermore, the size of each element does not completely reflect the actual size. Throughout the specification, the same or like reference signs indicate the same or like elements.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments of the disclosure are provided to completely disclose the disclosure and inform those skilled in the art of the scope of the disclosure, and the disclosure is defined only by the scope of the appended claims. Throughout the specification, the same or like reference signs indicate the same or like elements. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, a gNB, an eNode B, an eNB, a Node B, a base station (BS), a wireless access unit, a base station controller, and a node on a network. Further, a base station may support NR access link(s) to terminal(s) and integrated access and backhaul-donor (IAB-donor) which is a gNB for providing network access for terminal(s) through a network and backhaul and access links in an NR system. A base station may be a network entity including at least one of the IAB-donor or an IAB-node which is a radio access network (RAN) node supporting NR backhaul links to another IAB-node. A terminal may perform radio access via an IAB-node and transmit/receive data to/from an IAB-donor connected to at least one IAB-node via a backhaul link. A terminal may include a user equipment (UE), a mobile station (MS), a cellular phone, a smartphone, a computer, or a multimedia system capable of performing a communication function. In the disclosure, a downlink (DL) may be a radio transmission path through which a base station transmits a signal to a terminal. An uplink refers to a radio transmission path through which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation (5G) mobile communication technologies (new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to frequency division duplex (FDD) or time division duplex (TDD) systems.

Herein, it will be understood that each block of the flowchart illustrations, and combinations of blocks in the flowchart illustrations, can be implemented by computer program instructions. The computer program instructions may be loaded onto a processor of a general-purpose computer, a special-purpose computer, or other programmable data processing apparatuses. The instructions executed by a processor of a computer or other programmable data processing apparatuses generate a means for executing functions described in blocks of a flowchart. These computer program instructions may also be stored in a computer usable or computer-readable memory that can direct a computer or other programmable data processing apparatus to implement a function in a particular manner. The instructions stored in the computer usable or computer-readable memory may produce an article of manufacture including instruction means that implement the function specified in the flowchart block or blocks. The computer program instructions may also be loaded onto a computer or other programmable data processing apparatuses. The instructions executed by a computer or other programmable data processing apparatuses may generate a process, which is executed by a computer through execution of a series of operation steps in a computer or other programmable data processing apparatuses, and thus provide steps for executing functions described in blocks of a flowchart.

Furthermore, each block in the flowchart illustrations may represent a module, segment, or portion of code, which includes one or more executable instructions for implementing the specified logical function(s). Further, in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” may refer to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. The elements and “units” may be implemented to reproduce one or more CPUs within a device or a security multimedia card. Furthermore, the “unit” in various embodiments of the disclosure may include one or more processors. In describing the disclosure, a detailed description of known functions or configurations incorporated herein will be omitted when it is determined that the description may make the subject matter of the disclosure unnecessarily unclear. Hereinafter, various embodiments of the disclosure will be described with reference to the accompanying drawings.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink may refer to a radio link via which a terminal (user equipment; UE) or a mobile station (MS) transmits data or control signals to a base station (BS or eNode B). The downlink may refer to a radio link via which the base station transmits data or a control signal to a terminal. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the terminal, as well as the maximum data rate. In order to satisfy such requirements, various transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

Also, mMTC is being considered to support application services such as the Internet of Things (IoT) in the 5G communication system. The mMTC has requirements, such as support of connection of a large number of terminals in a cell, enhancement coverage of terminals, improved battery time, a reduction in the cost of a terminal, and the like, in order to effectively provide the Internet of Things. Since the Internet of Things provides communication functions while being provided to various sensors and various devices, it must support a large number of terminals (e.g., 1,000,000 UEs/km²) in a cell. In addition, the terminals supporting mMTC may require wider coverage than those of other services provided by the 5G communication system because the terminals are likely to be located in a shadow area, such as a basement of a building, which is not covered by the cell due to the nature of the service. The terminal supporting mMTC must be configured to be inexpensive, and may require a very long battery life-time such as 10 to 15 years because it is difficult to frequently replace the battery of the UE.

URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may require a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards. Furthermore, in the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

An embodiment of the disclosure is to provide a method and a device for efficiently transmitting an uplink data channel to a UE supporting multiple uplink transmission antennas in a wireless communication system. For example, the disclosure may provide a method and a device for efficiently transmitting an uplink data channel to a UE supporting 8 uplink transmission antennas, and may also provide a method and a device for efficiently transmitting an uplink data channel to a UE supporting more or fewer uplink transmission antennas.

Further, an embodiment of the disclosure may provide a device and a method, in which a UE may perform precoding for uplink data channel transmission by using multiple uplink transmission antennas, and may unambiguously associates a phase tracking reference signal (PTRS) for phase tracking with a demodulation reference signal (DMRS) in a wireless communication system. For example, the disclosure may provide a device and a method capable of performing precoding for uplink data channel transmission by using 8 uplink transmission antennas, and capable of unambiguously associating a phase tracking reference signal (PTRS) for phase tracking with a demodulation reference signal (DMRS). In addition, the disclosure may also provide a device and a method capable of performing precoding for uplink data channel transmission by using more or fewer uplink transmission antennas, and capable of unambiguously associating a phase tracking reference signal (PTRS) for phase tracking with a demodulation reference signal (DMRS).

### NR Time-Frequency Resources

Hereinafter, a frame structure of a 5G system will be described in more detail with reference to the accompanying drawings.

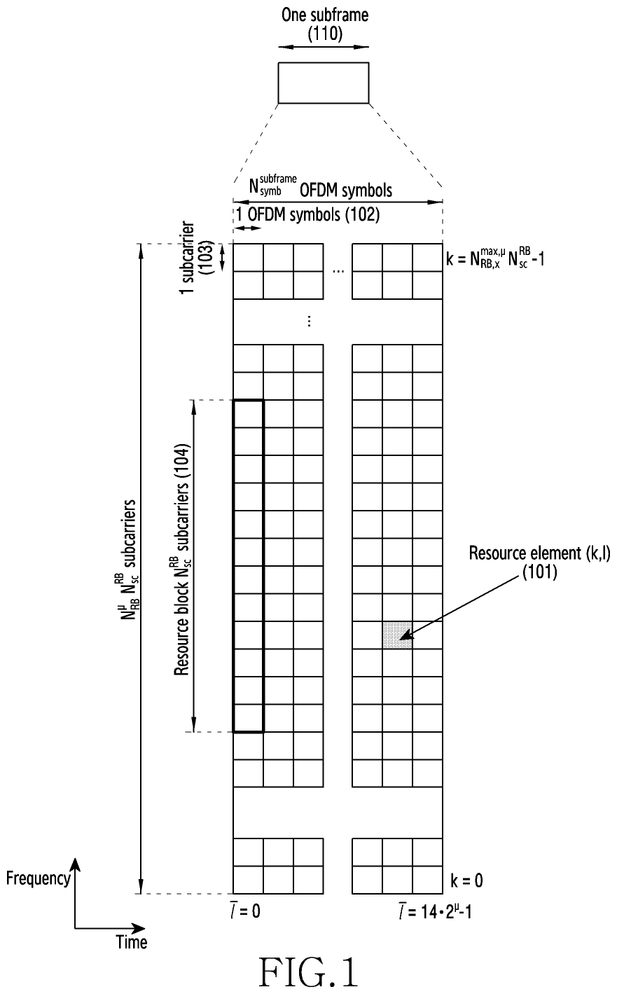

FIG. 1 illustrates a basic structure of a time-frequency domain in a wireless communication system according to an embodiment of the disclosure. FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{sc}^{RB} (for example, 12) consecutive REs may constitute one resource block (RB) 104. Referring FIG. 1, N_{symb}^{subframe,μ} denotes a number of OFDM symbols for each subframe 110 for subcarrier configuration (μ). A detailed description of the resource structure in the 5G system may refer to standard TS 38 211 section 4.

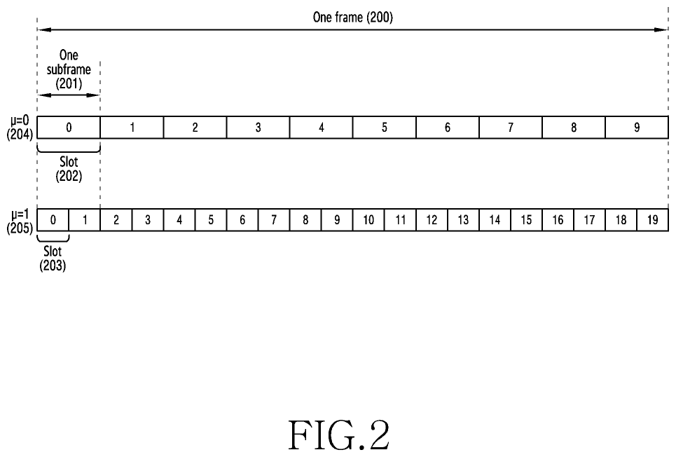

FIG. 2 illustrates a structure of a frame, a subframe, and a slot in a wireless communication system according to an embodiment of the disclosure. Specifically, FIG. 2 illustrates an example of a structure of a frame 200, a subframe 201, and a slot 202.

One frame 200 may be defined as 10 ms. One subframe 201 may be defined as 1 ms. Therefore, one frame 200 may include a total of 10 subframes. One slot 202 or 203 may be defined as 14 OFDM symbols (for example, the number Nₛₗₒₜ^{symb} of symbols for one slot may be 14). One subframe 201 may include one or multiple slots 202 and 203. The number of slots 202 or 203 per one subframe 201 may vary depending on configuration values u for the subcarrier spacing. FIG. 2 illustrates cases in which a configuration value 204 μ for the subcarrier spacing is 0 (μ=0) and a configuration value 205 μ for the subcarrier spacing is 1 (μ=1). In the case where μ=0 (204), one subframe 201 may include one slot 202. In the case where μ=1 (205), one subframe 201 may include two slots 203. That is, the number Nₛₗₒₜ^{sunframe,μ} of slots per one subframe may change according to a configuration value μ for a subcarrier spacing. The number Nₛₗₒₜ^{frame,μ} of slots per one frame may change according to a configuration value μ for a subcarrier spacing. Nₛₗₒₜ^{sunframe,μ} and Nₛₗₒₜ^{frame,μ} may be defined according to each subcarrier spacing configuration u as in Table 1 below:

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### Bandwidth Part (BWP)

Next, bandwidth part (BWP) configuration in a 5G communication system will be described in detail with reference to the accompanying drawings.

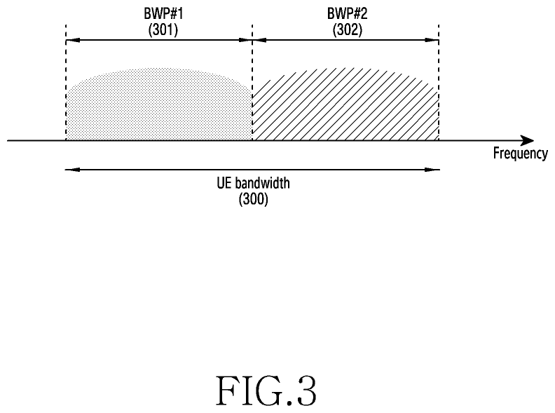

FIG. 3 illustrates an example of bandwidth part configuration in a wireless communication system according to an embodiment of the disclosure. Specifically, FIG. 3 illustrates an example in which a UE bandwidth 300 is configured to include two bandwidth parts, that is, bandwidth part #1 (BWP #1) 301 and bandwidth part #2 (BWP #2) 302.

A base station may configure one or multiple bandwidth parts for a UE. The base station may configure the following pieces of information with regard to each bandwidth part as given in Table 2 below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, |

n5},
(subcarrier spacing)

| | |
|---|---|
| cyclicPrefix | ENUMERATED { extended } |

```
    (cyclic prefix)
    }
```

Referring to Table 2, “locationAndBandwidth” indicates the location and bandwidth of a corresponding bandwidth part in the frequency domain. “SubcarrierSpacing” indicates a subcarrier spacing to be used in a corresponding bandwidth part. “CyclicPrefix” indicates whether a cyclic prefix (CP) is used for a corresponding bandwidth part.

According to an embodiment of the disclosure, the bandwidth part configuration is not limited by Table 2, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. The base station may transfer whether or not to activate a configured bandwidth part, to the UE semi-statically through RRC signaling. The base station may transfer whether or not to activate a configured bandwidth part, to the UE dynamically through downlink control information (DCI).

According to an embodiment, before a radio resource control (RRC) connection, an initial bandwidth part (BWP) for initial access may be configured for the UE by the base station through a master information block (MIB). More specifically, in the initial access step, the UE may receive, through the MIB, a control resource set (CORESET) which may be used to transmit a PDCCH for receiving system information (e.g., remaining system information (RMSI) necessary for initial access or system information block 1 (SIB1). Further, the UE may receive configuration information for a search space through the MIB. Each of the control resource set and the search space configured through the MIB may be considered to have identity (ID) 0. The control resource set and the search space configured through the MIB may be referred to as a common control resource set and a common search space, respectively. The base station may notify the UE of configuration information, such as frequency allocation information, time allocation information, and numerology, regarding control region #0 through the MIB. In addition, the base station may notify the UE of configuration information on the monitoring cycle and occasion with regard to control region #0 (that is, configuration information on search space #0), through the MIB. The UE may consider that a frequency domain configured by control resource set #0 acquired from the MIB is an initial bandwidth part for initial access. The ID of the initial bandwidth part may be considered to be 0. The control resource set may be referred to as a control region, a control resource region, etc.

According to various embodiments of the disclosure, the bandwidth part-related configuration supported by 5G may be used for various purposes.

According to an embodiment, if the bandwidth supported by the UE is smaller than the system bandwidth, a base station may support data transmission and reception of a UE through the bandwidth part configuration. For example, the base station may configure the frequency location of the bandwidth part for the UE, and the UE can transmit or receive data at a specific frequency location within the system bandwidth.

In addition, according to an embodiment, the base station may configure multiple bandwidth parts for the UE for the purpose of supporting different numerologies. For example, in order to support UE's data transmission and reception using both a subcarrier spacing of 15 kHz and a subcarrier spacing of 30 kHz, the base station may configure two bandwidth parts as subcarrier spacings of 15 kHz and 30 kHz, respectively. Different bandwidth parts may be frequency-division-multiplexed (FDDed). When a UE desires to transmit or receive data at a specific subcarrier spacing, bandwidth parts configured at the specific subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth (for example, 100 MHz) and always transmits or receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. More specifically, the UE may receive a configuration for a control resource set (CORESET) from the MIB of a physical broadcast channel (PBCH). The control resource set configured for the UE may be a control resource set for a downlink control channel available for transmission of downlink control information (DCI) for scheduling of a system information block (SIB). The bandwidth of the control resource set configured through the MIB may be regarded as an initial bandwidth part. The UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### Bandwidth Part (BWP) Change

If a UE has one or more bandwidth parts configured therefor, the base station may indicate, to the UE, to change (or switch or transition) the bandwidth parts by using a bandwidth part indicator field inside DCI.

FIG. 3 illustrates an example of bandwidth part configuration in a wireless communication system according to an embodiment of the disclosure. Referring to FIG. 3, if the currently activated bandwidth part is bandwidth part #1 301, the base station may indicate bandwidth part #2 302 with a bandwidth part indicator inside DCI. Upon receiving DCI including a bandwidth part indicator, the UE may change the bandwidth part to bandwidth part #2 302 indicated by the bandwidth part indicator.

As described above, DCI-based bandwidth part changing may be indicated by DCI for scheduling a PDSCH or a PUSCH. Upon receiving a bandwidth part change request, the UE needs to be able to receive or transmit the PDSCH or PUSCH scheduled by the corresponding DCI, in the changed bandwidth part with no problem. To this end, requirements relating to delay time (TBWP) required at the time of bandwidth part changing are defined in the standards. The requirements relating to delay time may be defined as in Table 3 below without being limited thereto.

TABLE 3

| | | BWP switch delay T_{BWP} (slots) | |
|---|---|---|---|
| μ | NR Slot length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part delay time type to the base station.

If the UE has received DCI including a bandwidth part change indicator in slot n, according to the above-described requirements regarding the bandwidth part change delay time, the UE may complete a change to the new bandwidth part indicated by the bandwidth part change indicator at a timepoint not later than slot n+TBWP. Accordingly, the UE may transmit or receive a data channel scheduled by the corresponding DCI in the changed new bandwidth part. If the base station wants to schedule a data channel by using the new bandwidth part, the base station may determine time domain resource allocation regarding the data channel in consideration of the UE's bandwidth part change delay time (TBWP). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (TBWP).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field included in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (that is, the last symbol of slot n+K−1).

### SS/PBCH Block

Next, synchronization signal (SS)/PBCH blocks in 5G will be described. An SS/PBCH block may refer to a physical layer channel block including a primary synchronization signal (PSS), a secondary synchronization signal (SSS), and a PBCH. Specifically, functions of the PSS, SSS, and PBCH are as described below.

PSS: A signal which becomes a reference signal for downlink time/frequency synchronization, and may provide a part of the information of a cell ID.

SSS: becomes a reference of downlink time/frequency synchronization, and provides remaining cell ID information not provided by the PSS. Additionally, the SSS may serve as a reference signal for demodulation of a PBCH.

PBCH: may provide essential system information necessary for the UE's data channel and control channel transmission/reception. The essential system information may include search space-related control information indicating a control channel's radio resource mapping information, scheduling control information regarding a separate data channel for transmitting system information, and the like.

SS/PBCH block: may include a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and the MIB may be used to configure, for the UE, control resource set (CORESET) #0 (for example, a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) in consideration of the selected SS/PBCH index. Upon receiving the PRACH, the base station may acquire information on the SS/PBCH block index selected by the UE. The base station may know which block the UE has selected from respective SS/PBCH blocks. The base station may know the fact that the UE has monitored control resource set #0 associated with the selected SS/PBCH block.

### PDCCH: Regarding DCI

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) may be transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the DCI message payload. The CRC may be scrambled by a radio network temporary identifier (RNTI) corresponding to the identity of the UE. Different RNTIs may be used according to the purpose of the DCI message (for example, UE-specific data transmission, power control command, or random access response, or the like). The RNTI may not be explicitly transmitted, but may be transmitted while being included in a CRC calculation process. The UE may receive a DCI message transmitted through a PDCCH. The UE may identify CRC included in the received DCI message by using the allocated RNTI. Based on a result of the CRC identification, the UE may know that the corresponding message has been transmitted to the UE.

According to an embodiment, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI). According to an embodiment, the P-RNTI and the SI-RNTI may be common RNTIs which are not allocated to a specific UE but allocated to all UEs in a cell.

DCI format 0_0 may be used as fallback DCI for scheduling the PUSCH, and the CRC may be scrambled by a C-RNTI. For example, DCI format 0_1 in which the CRC is scrambled by a C-RNTI may include the following pieces of information given in Table 4 below. However, according to an embodiment, information included in DCI format 0_0 in which the CRC is scrambled by a C-RNTI is not limited to the information in Table 4.

TABLE 4

| | |
|---|---|
| - | Identifier for DCI formats - [1] bit |
| - | Frequency domain resource assignment -[┌log₂(N_{RB}^{UL,BWP}(N_{RB}^{UL,BWP} + 1)/2) [symbol] ] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH- [2] bits |
| - | Uplink/supplementary uplink indicator (UL/SUL indicator) - 0 or 1 bit |

DCI format 0_1 may be used as non-fallback DCI for scheduling the PUSCH, and the CRC may be scrambled by a C-RNTI. DCI format 0_1 in which the CRC is scrambled by a C-RNTI may include the following pieces of information given in Table 5 below, for example.

```
TABLE 5
- Carrier indicator − 0 or 3 bits
- UL/SUL indicator − 0 or 1 bit
- Identifier for DCI formats − [1] bits
- Bandwidth part indicator − 0, 1 or 2 bits
- Frequency domain resource assignment
    • For resource allocation type 0, ┌N_{RB}^{UL,BWP} / P┐ bits
    • For resource allocation type 1, ┌log₂(N_{RB}^{UL,BWP}(N_{RB}^{UL,BWP} +
    1)/2┐ bits
- Time domain resource assignment −1, 2, 3, or 4 bits
- Virtual resource block-to-physical resource block (VRB-to-PRB)
mapping − 0 or 1 bit, only for resource allocation type 1.
    • 0 bit if only resource allocation type 0 is configured;
    • 1 bit otherwise.
- Frequency hopping flag − 0 or 1 bit, only for resource allocation type 1.
    • 0 bit if only resource allocation type 0 is configured;
    • 1 bit otherwise.
- Modulation and coding scheme − 5 bits
- New data indicator − 1 bit
- Redundancy version − 2 bits
- HARQ process number − 4 bits
- 1st downlink assignment index− 1 or 2 bits
    • 1 bit for semi-static HARQ-ACK codebook;
    • 2 bits for dynamic HARQ-ACK codebook with single HARQ-ACK
    codebook.
- 2nd downlink assignment index − 0 or 2 bits
    • 2 bits for dynamic HARQ-ACK codebook with two HARQ-ACK
    sub-codebooks;
    • 0 bit otherwise.
- TPC command for scheduled PUSCH − 2 bits
$‐ SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
    $\text{} \begin{matrix} ⌈ {log}_{2} ( {\sum }_{k = 1}^{{L}_{max}} ( \begin{matrix}{N}_{SRS} \\ k\end{matrix} ) ) ⌉ bits for non ‐ codebook based PUSCH \\ transmission ;\end{matrix}$
    • ┌log₂(N_{SRS})┐ bits for codebook based PUSCH transmission.
- Precoding information and number of layers−up to 6 bits
- Antenna ports − up to 5 bits
- SRS request − 2 bits
- CSI request − 0, 1, 2, 3, 4, 5, or 6 bits
- Code block group (CBG) transmission information − 0, 2, 4, 6, or 8 bits
- Phase tracking reference signal (PTRS)-demodulation reference signal
(DMRS) association− 0 or 2 bits.
- beta_offset indicator− 0 or 2 bits
- DMRS sequence initialization− 0 or 1 bit
```

However, according to an embodiment, information included in DCI format 0_1 in which the CRC is scrambled by a C-RNTI is not limited to the information in Table 5. DCI format 1_0 may be used as fallback DCI for scheduling the PDSCH, and the CRC may be scrambled by a C-RNTI. DCI format 0_1 in which the CRC is scrambled by a C-RNTI may include the following pieces of information given in Table 6 below, for example.

TABLE 6

| | |
|---|---|
| - | Identifier for DCI formats - [1] bit |
| - | Frequency domain resource assignment -[┌log ₂(N_{RB}^{DL,BWP} (N_{RB}^{DL,BWP} + 1) / 2)┐ ] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Physical uplink control channel (PUCCH) resource indicator- 3 bits |
| - | PDSCH-to-HARQ feedback timing indicator- [3] bits |

However, according to an embodiment, information included in DCI format 1_0 in which the CRC is scrambled by a C-RNTI is not limited to the information in Table 6. DCI format 1_1 may be used as non-fallback DCI for scheduling the PDSCH, and the CRC may be scrambled by a C-RNTI. DCI format 1_1 in which the CRC is scrambled by a C-RNTI may include the following pieces of information given in Table 7 below, for example. However, according to an embodiment, information included in DCI format 1_1 in which the CRC is scrambled by a C-RNTI is not limited to the information in Table 7.

TABLE 7

| - | Carrier indicator - 0 or 3 bits | | |
|---|---|---|---|
| - | Identifier for DCI formats - [1] bits | | |
| - | Bandwidth part indicator - 0, 1 or 2 bits | | |
| - | Frequency domain resource assignment | | |
| - | | • | For resource allocation type 0, ┌N_{RB}^{DL, BWP} / P┐ bits |
| - | | • | For resource allocation type 1, ┌log ₂ (N_{RB}^{DL, BWP} (N_{RB}^{DL,BWP} + 1) / 2)┐ bits |
| - | Time domain resource assignment -1, 2, 3, or 4 bits | | |
| - | VRB-to-PRB mapping - 0 or 1 bit, only for resource allocation type 1. | | |
| - | | • | 0 bit if only resource allocation type 0 is configured; |
| - | | • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | | |
|---|---|---|
| | - | Modulation and coding scheme - 5 bits |
| | - | New data indicator - 1 bit |
| | - | Redundancy version - 2 bits |
| - | | HARQ process number - 4 bits |
| - | | Downlink assignment index - 0 or 2 or 4 bits |
| - | | TPC command for scheduled PUCCH - 2 bits |
| - | | PUCCH resource indicator - 3 bits |
| - | | PDSCH-to-HARQ_feedback timing indicator - 3 bits |
| - | | Antenna ports - 4, 5 or 6 bits |
| - | | Transmission configuration indication- 0 or 3 bits |
| - | | SRS request - 2 bits |
| - | | CBG transmission information - 0, 2, 4, 6, or 8 bits |
| - | | CBG flushing out information - 0 or 1 bit |
| - | | DMRS sequence initialization - 1 bit |

### PDCCH: CORESET, REG, CCE, and Search Space

Hereinafter, a downlink control channel in a 5G communication system will be described in more detail with reference to the accompanying drawings.

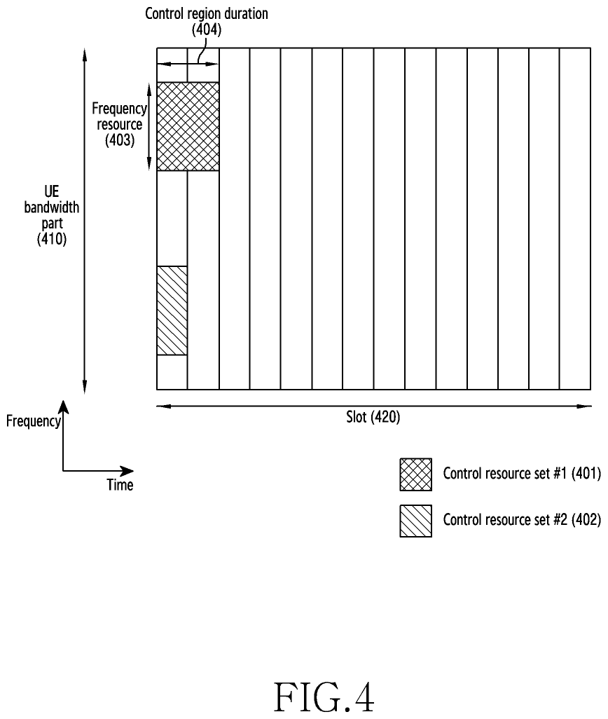

FIG. 4 illustrates an example of control resource set configuration of a downlink control channel in a wireless communication system according to an embodiment of the disclosure. More specifically, FIG. 4 illustrates an example of a control resource set used to transmit a downlink control channel in a 5G wireless communication system. FIG. 4 illustrates an example in which a UE bandwidth part 410 is configured along the frequency axis, and two control resource sets (control resource set #1 401 and control resource set #2 402) are configured within one slot 420 along the time axis. The control resource sets 401 and 402 may be configured in a specific frequency resource 403 within the entire UE bandwidth part 420 along the frequency axis. FIG. 4 illustrates an example of a frequency resource in which the specific frequency resource 403 is configured in control resource set #1 401. One or multiple OFDM symbols may be configured along the time axis, and this may be defined as a control resource set duration 404. Referring FIG. 4, according to an embodiment, control resource set #1 401 is configured to have a control resource set duration of two symbols, and control resource set #2 402 is configured to have a control resource set duration of one symbol.

The control resource set in 5G described above may be configured through upper layer signaling (for example, system information, MIB, RRC signaling) transferred from a base station to a UE. The configuring of a control resource set for a UE may be understood as providing of information, such as a control resource set identifier, a frequency location of a control resource set, or a symbol duration of a control resource set, to the UE. For example, configuration information regarding the control resource set may include the following pieces of information in Table 8.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity))

| | |
|---|---|
| frequencyDomainResources | BIT STRING (SIZE (45)), |

(frequency domain resource assignment information)

| | |
|---|---|
| duration | INTEGER |

(1..maxCoReSetDuration),
(time domain resource assignment information)

| | |
|---|---|
| cce-REG-MappingType | CHOICE |
| { | |

```
  (CCE-to-REG mapping type)
        interleaved
      SEQUENCE {
          reg-BundleSize
      ENUMERATED {n2, n3, n6},
    (REG bundle size)
          precoderGranularity
      ENUMERATED {sameAsREG-bundle, allContiguousRBs},
          interleaverSize
      ENUMERATED {n2, n3, n6}
          (interleaver size)
          shiftIndex
      INTEGER(0..maxNrofPhysicalResourceBlocks-1)
        OPTIONAL
        (interleaver shift)
    },
```

| | |
|---|---|
| nonInterleaved | NULL |

```
      },
      tci-StatesPDCCH
      SEQUENCE(SIZE (1..maxNrofTCI-StatesPDCCH)) OF
      TCI-StateId
      OPTIONAL,
  (QCL configuration information)
```

| | |
|---|---|
| tci-PresentInDCI | ENUMERATED |

{enabled}
OPTIONAL, -- Need S
}

In Table 8, tci-StatesPDCCH (i.e, transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

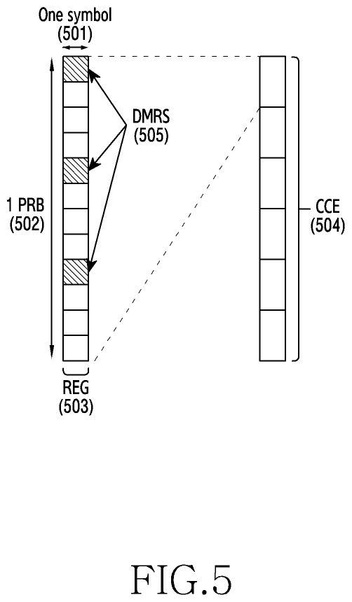

FIG. 5 illustrates a structure of a downlink control channel in a wireless communication according to an embodiment of the disclosure. FIG. 5 illustrates an example of a basic unit of time and frequency resources constituting a downlink control channel available in a 5G system. According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

As noted from FIG. 5, provided that the basic unit of downlink control channel allocation in 5G is a control channel element 504, one CCE 504 may include multiple REGs 503. Referring to the REG 503 illustrated in FIG. 5, the REG 503 may include 12 REs, If one CCE 504 includes six REGs 503, one CCE 504 may include 72 REs. A downlink control resource set, once configured, may include multiple CCEs 504. A specific downlink control channel may be mapped to one or multiple CCEs 504 and then transmitted according to the aggregation level (AL) in the control resource set. The CCEs 504 in the control resource set may be distinguished by numbers. The numbers of CCEs 504 may be allocated according to a logical mapping scheme.

The basic unit (that is, the REG 503) of the downlink control channel illustrated in FIG. 5 may include both REs to which DCI is mapped and an area to which a DMRS 505, a reference signal for decoding the same, is mapped. Referring to FIG. 5, three DRMSs 505 may be transmitted in one REG 503. The number of CCEs necessary for transmission of a PDCCH may be 1, 2, 4, 8, or 16 according to the aggregation level (AL). Different CCE numbers may be used in order to implement link adaptation of a downlink control channel. For example, when AL=L, one downlink control channel may be transmitted through L CCEs. A UE should detect a signal in a state of having no information on a downlink control channel. Therefore, a search space indicating a set of CCEs may be defined for blind decoding. The search space may be a set of downlink control channel candidates including CCEs that the UE must attempt to decode in a given aggregation level. Since there are various aggregation levels making one bundle of 1, 2, 4, 8, or 16 CCEs, the UE may have a plurality of search spaces. A search space set may be defined as a set of search spaces at all configured aggregation levels.

Search spaces may be classified into common search spaces and UE-specific search spaces. A group of UEs or all UEs may search a common search space of the PDCCH in order to perform dynamic scheduling regarding system information. In addition, a group of UEs or all UEs may search a common search space of the PDCCH in order to receive cell-common control information such as a paging message. For example, a UE may search the common search space of the PDCCH in order to receive PDSCH scheduling allocation information for transmitting an SIB including a cell operator information or the like. In the case of a common search space, a group of UEs or all UEs need to receive the PDCCH, and the same may thus be defined as a predetermined set of CCEs. Scheduling allocation information regarding a UE-specific PDSCH or PUSCH may be received by investigating the UE-specific search space of the PDCCH. The UE-specific search space may be defined UE-specifically according to a function of various system parameters and the identity of the UE.

In 5G, a parameter for a search space regarding a PDCCH may be configured for the UE by the base station by using upper layer signaling (for example, SIB, MIB, RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, configuration information for the search space regarding the PDCCH may include the following pieces of information given in Table 9 below. However, according to an embodiment, configuration information for the search space regarding the PDCCH is not limited to the information in Table 9.

TABLE 9

| | |
|---|---|
| SearchSpace ::= | SEQUENCE { |

-- Identity of the search space. SearchSpaceId = 0 identifies the SearchSpace configured
via PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

```
  (monitoring slot level periodicity)
        sl1
      NULL,
        sl2
      INTEGER (0..1),
        sl4
      INTEGER (0..3),
        sl5
      INTEGER (0..4),
        sl8
      INTEGER (0..7),
        sl10
      INTEGER (0..9),
        sl16
      INTEGER (0..15),
        sl20
      INTEGER (0..19)
      }
```

OPTIONAL,

duration(monitoring duration) INTEGER (2..2559)

| | |
|---|---|
| monitoringSymbolsWithinSlot | BIT STRING (SIZE |

```
(14))
      OPTIONAL,
  (monitoirng symbols within slot)
```

| | |
|---|---|
| nrofCandidates | SEQUENCE { |

```
  (number of PDCCH candidates for each aggregation level)
        aggregationLevel1
      ENUMERATED {n0, n1, n2, n3, n4, n5, n6, n8},
        aggregationLevel2
      ENUMERATED {n0, n1, n2, n3, n4, n5, n6, n8},
        aggregationLevel4
      ENUMERATED {n0, n1, n2, n3, n4, n5, n6, n8},
        aggregationLevel8
      ENUMERATED {n0, n1, n2, n3, n4, n5, n6, n8},
        aggregationLevel16
      ENUMERATED {n0, n1, n2, n3, n4, n5, n6, n8}
      },
```

| | |
|---|---|
| searchSpaceType | CHOICE { |

```
      (search space type)
        -- Configures this search space as common search space (CSS) and DCI formats
to monitor.
        common
      SEQUENCE {
      (common search space)
    }
        ue-Specific
      SEQUENCE {
      (UE-specific search space)
          -- Indicates whether the UE monitors in this USS for DCI formats 0-0 and
1-0 or for formats 0-1 and 1-1.
          formats
      ENUMERATED {formats0-0-And-1-0, formats0-1-And-1-1},
          ...
        }
```

According to configuration information for the search space regarding the PDCCH, the base station may configure one or multiple search space sets for the UE. According to an embodiment of the disclosure, the base station may configure search space set 1 and search space set 2 for the UE. The base station may configure DCI format A scrambled by an X-RNTI, to be monitored in a common search space in search space set 1. The base station may configure DCI format B scrambled by a Y-RNTI, to be monitored in a UE-specific search space in search space set 2. In X-RNTI and Y-RNTI, “X” and “Y” may correspond to one of various RNTIs described in the disclosure.

According to configuration information, one or multiple search space sets may exist in a common search space or a UE-specific search space. For example, search space set #1 and search space set #2 may be configured as a common search space. Search space set #3 and search space set #4 may be configured as a UE-specific search space.

Combinations of DCI formats and RNTIs given below may be monitored in a common search space. Of course, according to various embodiments of the disclosure, those combination are not limited to the examples described below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Of course, according to various embodiments of the disclosure, those combinations described above are not limited to examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI
   RNTIs described in the disclosure may follow the definition and usage given below.
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated in the disclosure may follow the definitions given in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and |
| | PUSCH |
| 2_3 | Transmission of a group of TPC commands for SRS |
| | transmissions by one or more UEs |

In 5G, the search space at aggregation level L in connection with control resource set p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 9), and the group of search space sets monitored by the UE at each timepoint may differ accordingly. For example, if search space set #1 is configured by X-slot cycle, if search space set #2 is configured at by Y-slot cycle, and if X and Y are different, the UE may monitor search space set #1 and search space set #2 both in a specific slot, and may monitor one of search space set #1 and search space set #2 in another specific slot.

### PDCCH: Span

The UE may perform UE capability reporting at each subcarrier spacing with regard to a case in which the same has multiple PDCCH monitoring occasions inside a slot. The concept “span” may be used in this regard. A span refers to consecutive symbols in which the UE can monitor a PDCCH in a slot. Each PDCCH monitoring occasion may be located within one span. A span may be expressed by (X, Y) wherein X refers to the minimum number of symbols by which the first symbols of two consecutive spans are spaced apart from each other, and Y refers to the number of consecutive symbols in which a PDCCH can be monitored within one span. Here, a UE may monitor a PDCCH in a range of Y symbols from the first symbol of the span within the span.

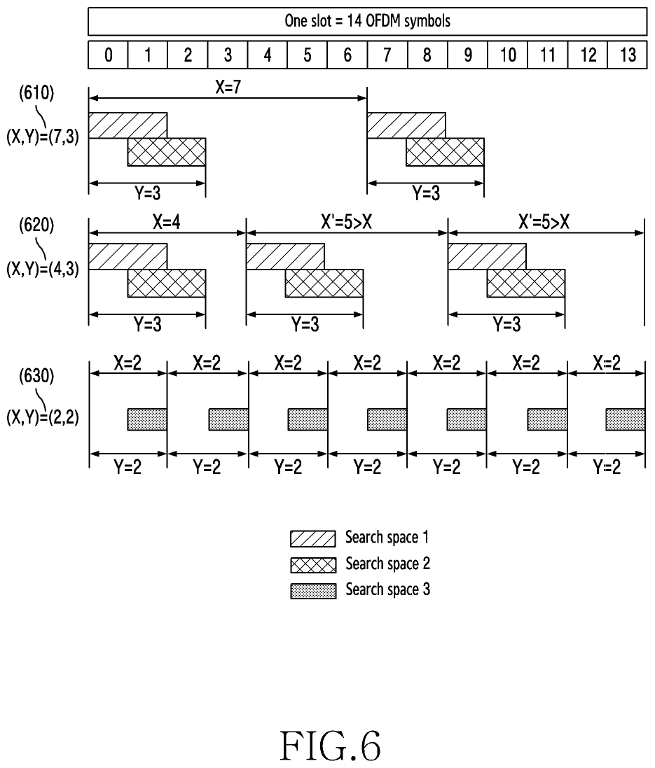

FIG. 6 illustrates an example in which, by using a span, a UE may have multiple PDCCH monitoring occasions inside a slot in a wireless communication system according to an embodiment of the disclosure.

Referring to FIG. 6, (X, Y) for expressing a span may be (7, 3), (4, 3), or (2, 2). In FIG. 6, each span is indicated by reference numeral 610, 620, or 630. According to an embodiment, the span 610 may indicate a case in which there are two spans expressible by (7,4) inside a slot. Therefore, in case of the spacing 610 of FIG. 6, the spacing X between the first symbols of the two spans is 7, and the PDCCH monitoring occasion may exist within a total of Y (i.e., 3) symbols from the first symbol of each span. In the consecutive symbols expressed by Y=3, search space 1 and search space 2 may exist. According to another embodiment, the span 620 may indicate a case in which a total of three spans expressible by (4,3) exist within a slot. In this case, the spacing X′ between the second span and the third span may be 5 (X′=5) which is larger than the minimum symbol number (i.e., 4). According to an embodiment, the span 630 may indicate a case in which a total of seven spans expressible by (2,2) exist within a slot. In this case, the PDCCH monitoring occasion may exist within a total of Y (Y=2) symbols from the first symbol of each span, and search space 3 may exist within the two symbols (Y=2).

### PDCCH: UE Capability Report

The location of a slot at which the common search space and the UE-specific search space described above are located may be indicated by the parameter of “monitoringSlotPeriodicityAndOffset” in Table 9 showing configuration information on the search spaces for the PDCCH as described above. The symbol location inside the slot is indicated by a bitmap through parameter “monitoringSymbolsWithinSlot” in Table 9. Meanwhile, the symbol location inside a slot at which the UE can monitor search spaces may be reported to the base station through the following UE capabilities.

UE capability 1 (which will be used mixedly with feature group 3-1 hereinafter) may have the following meaning: if there is one monitoring occasion (MO) regarding type 1 and type 3 common search spaces or UE-specific search spaces inside a slot, as in following Table 11, the UE can monitor the corresponding MO when the corresponding MO is located inside the first three symbols inside the slot. UE capability 1 may be mandatory capability which all UEs supporting NR should support. Whether UE capability 1 is supported may not be explicitly reported to the base station. However, the disclosure is not limited to the embodiments described above.

TABLE 11

| | | | Field |
|---|---|---|---|
| | | | name in |
| | Feature | | TS 38.331 |
| Index | group | Components | [2] |
| 3-1 | Basic | 1) One configured CORESET per BWP | n/a |
| | DL | per cell in addition to CORESET0 | |
| | control | - CORESET resource allocation of 6RB | |
| | channel | bit-map and duration of 1 - 3 OFDM | |
| | | symbols for FR1 | |
| | | - For type 1 CSS without dedicated RRC | |
| | | configuration and for type 0, 0A, and 2 | |
| | | CSSs, CORESET resource allocation of | |
| | | 6RB bit-map and duration 1-3 OFDM | |
| | | symbols for FR2 | |
| | | - For type 1 CSS with dedicated RRC | |
| | | configuration and for type 3 CSS, UE | |
| | | specific SS, CORESET resource | |
| | | allocation of 6RB bit-map and duration | |
| | | 1-2 OFDM symbols for FR2 | |
| | | - REG-bundle sizes of 2/3 RBs or 6 RBs | |
| | | - Interleaved and non-interleaved CCE- | |
| | | to-REG mapping | |
| | | - Precoder-granularity of REG-bundle | |
| | | size | |
| | | - PDCCH DMRS scrambling | |
| | | determination | |
| | | - TCI state(s) for a CORESET | |
| | | configuration | |
| | | 2) CSS and UE-SS configurations for | |
| | | unicast PDCCH transmission per BWP | |
| | | per cell | |
| | | - PDCCH aggregation levels 1, 2, 4, 8, 16 | |
| | | - UP to 3 search space sets in a slot for a | |
| | | scheduled SCell per BWP | |
| | | This search space limit is before applying | |
| | | all dropping rules. | |
| | | - For type 1 CSS with dedicated RRC | |
| | | configuration, type 3 CSS, and UE-SS, | |
| | | the monitoring occasion is within the first | |
| | | 3 OFDM symbols of a slot | |
| | | - For type 1 CSS without dedicated RRC | |
| | | configuration and for type 0, 0A, and 2 | |
| | | CSS, the monitoring occasion can be any | |
| | | OFDM symbol(s) of a slot, with the | |
| | | monitoring occasions for any of Type | |
| | | 1- CSS without dedicated RRC | |
| | | configuration, or Types 0, 0A, or 2 CSS | |
| | | configurations within a single span of | |
| | | three consecutive OFDM symbols within | |
| | | a slot | |
| | | 3) Monitoring DCI formats 0_0, 1_0, 0_1, | |
| | | 1_1 | |
| | | 4) Number of PDCCH blind decodes per | |
| | | slot with a given SCS follows Case 1-1 | |
| | | table | |
| | | 5) Processing one unicast DCI scheduling | |
| | | DL and one unicast DCI scheduling UL | |
| | | per slot per scheduled CC for FDD | |
| | | 6) Processing one unicast DCI scheduling | |
| | | DL and 2 unicast DCI scheduling UL per | |
| | | slot per scheduled CC for TDD | |

UE capability 2 (which will be used mixedly with FG 3-2 hereinafter) may have the following meaning: if there is one monitoring occasion (MO) regarding a common search space or a UE-specific search space inside a slot, as in following Table 12, the UE can monitor the corresponding MO regardless of the start symbol location of the corresponding MO. UE capability 1 may be optionally supported by a UE according to various embodiments of the disclosure. Whether UE capability 2 is supported may be explicitly reported to the base station. However, the disclosure is not limited to the embodiments described above.

TABLE 12

| | Feature | | |
|---|---|---|---|
| Index | group | Components | Field name in TS 38.331 [2] |
| 3-2 | PDCCH | For a given UE, | pdcchMonitoringSingleOccasion |
| | monitoring | all search space | |
| | on any span | configurations | |
| | of up to 3 | are within the | |
| | consecutive | same span of | |
| | OFDM | 3 consecutive | |
| | symbols of | OFDM symbols | |
| | sa lot | in the slot | |

UE capability 3 (hereinafter, mixedly used with FG 3-5, 3-5a, and 3-5b) has the following meaning: if there are multiple monitoring occasions (MOs) regarding a common search space or a UE-specific search space inside a slot, as in the following Table 13a or Table 13b, the UE may indicate the pattern of the MO which can be monitored. The above-mentioned pattern includes the spacing X between start symbols of different MOs, and the maximum symbol length Y regarding one MO. The combination of (X, Y) supported by the UE may be one or multiple among {(2,2), (4,3), (7,3)}. According to various embodiments of the disclosure, UE capability 3 may be optionally supported by a UE. Whether the capability is supported and the (X, Y) combination described above may be explicitly reported to the base station.

TABLE 13a

| Index | Feature group | Components | Field name in TS 38.331 [2] |
|---|---|---|---|
| 3-5 | For type 1 CSS | For type 1 CSS with dedicated RRC | pdcch- |
| | with dedicated | configuration, type 3 CSS, and UE-SS, | MonitoringAnyOccasions |
| | RRC | monitoring occasion can be any OFDM | { |
| | configuration, | symbol(s) of a slot for Case 2 | 3-5. withoutDCI-Gap |
| | type 3 CSS, | | 3-5a. withDCI-Gap |
| | and UE-SS, | | } |
| | monitoring | | |
| | occasion can | | |
| | be any OFDM | | |
| | symbol(s) of a | | |
| | slot for Case 2 | | |
| 3-5a | For type 1 CSS | For type 1 CSS with dedicated RRC | |
| | with dedicated | configuration, type 3 CSS and UE-SS, monitoring | |
| | RRC | occasion can be any OFDM symbol(s) of a slot | |
| | configuration, | for Case 2, with minimum time separation | |
| | type 3 CSS, | (including the cross-slot boundary case) between | |
| | and UE-SS, | two DL unicast DCIs, between two UL unicast | |
| | monitoring | DCIs, or between a DL and an UL unicast DCI in | |
| | occasion can | different monitoring occasions where at least one | |
| | be any OFDM | of them is not the monitoring occasions of FG-3- | |
| | symbol(s) of a | 1, for a same UE as | |
| | slot for Case 2 | 2OFDM symbols for 15 kHz | |
| | with a DCI gap | 4OFDM symbols for 30 kHz | |
| | | 7OFDM symbols for 60 kHz with NCP | |
| | | 11OFDM symbols for 120 kHz | |
| | | Up to one unicast DL DCI and up to one unicast | |
| | | UL DCI in a monitoring occasion except for the | |
| | | monitoring occasions of FG 3-1. | |
| | | In addition for TDD the minimum separation | |
| | | between the first two UL unicast DCIs within | |
| | | the first 3 OFDM symbols of a slot can be zero | |
| | | OFDM symbols. | |

TABLE 13b

| | | |
|---|---|---|
| 3-5b | All PDCCH | PDCCH monitoring occasions of FG-3-1, plus |
| | monitoring | additional PDCCH monitoring occasion(s) can be |
| | occasion can | any OFDM symbol(s) of a slot for Case 2, and for |
| | be any OFDM | any two PDCCH monitoring occasions belonging |
| | symbol(s) of a | to different spans, where at least one of them is |
| | slot for Case 2 | not the monitoring occasions of FG-3-1, in same |
| | with a span gap | or different search spaces, there is a minimum |
| | | time separation of X OFDM symbols (including |
| | | the cross-slot boundary case) between the start of |
| | | two spans, where each span is of length up to Y |
| | | consecutive OFDM symbols of a slot. Spans do |
| | | not overlap. Every span is contained in a single |
| | | slot. The same span pattern repeats in every slot. |
| | | The separation between consecutive spans within |
| | | and across slots may be unequal but the same (X, |
| | | Y) limit must be satisfied by all spans. Every |
| | | monitoring occasion is fully contained in one |
| | | span. In order to determine a suitable span |
| | | pattern, first a bitmap b(l), 0 <= l <= 13 is generated, |
| | | where b(l) = 1 if symbol l of any slot is part of a |
| | | monitoring occasion, b(l) = 0 otherwise. The first |
| | | span in the span pattern begins at the smallest l |
| | | for which b(l) = 1. The next span in the span |
| | | pattern begins at the smallest l not included in the |
| | | previous span(s) for which b(l) = 1. The span |
| | | duration is max{maximum value of all |
| | | CORESET durations, minimum value of Y in the |
| | | UE reported candidate value} except possibly the |
| | | last span in a slot which can be of shorter |
| | | duration. A particular PDCCH monitoring |
| | | configuration meets the UE capability limitation |
| | | if the span arrangement satisfies the gap |
| | | separation for at least one (X, Y) in the UE |
| | | reported candidate value set in every slot, |
| | | including cross slot boundary. |
| | | For the set of monitoring occasions which are |
| | | within the same span: |
| | | Processing one unicast DCI scheduling |
| | | DL and one unicast DCI scheduling UL per |
| | | scheduled CC across this set of monitoring |
| | | occasions for FDD |
| | | Processing one unicast DCI scheduling |
| | | DL and two unicast DCI scheduling UL per |
| | | scheduled CC across this set of monitoring |
| | | occasions for TDD |
| | | Processing two unicast DCI scheduling |
| | | DL and one unicast DCI scheduling UL per |
| | | scheduled CC across this set of monitoring |
| | | occasions for TDD |
| | | The number of different start symbol indices of |
| | | spans for all PDCCH monitoring occasions per |
| | | slot, including PDCCH monitoring occasions of |
| | | FG-3-1, is no more than floor(14/X) (X is |
| | | minimum among values reported by UE). |
| | | The number of different start symbol indices of |
| | | PDCCH monitoring occasions per slot including |
| | | PDCCH monitoring occasions of FG-3-1, is no |
| | | more than 7. |
| | | The number of different start symbol indices of |
| | | PDCCH monitoring occasions per half-slot |
| | | including PDCCH monitoring occasions of FG- |
| | | 3-1 is no more than 4 in SCell. |

The UE may report whether the above-described capability 2 and/or capability 3 are supported and relevant parameters to the base station. The base station may allocate time-domain resources to the common search space and the UE-specific search space, based on the UE capability report. During the resource allocation, the base station may ensure that the MO is not positioned not at a location at which the UE cannot monitor the same.

### PDCCH: BD/CCE Limit

If there are multiple search space sets configured for a UE, the following conditions may be considered in connection with a method for determining a search space set to be monitored by the UE.

According to an embodiment, if the value of “monitoringCapabilityConfig-r16” (upper layer signaling) has been configured to be “r15monitoringcapability” for the UE, the UE may define, for each slot, a maximum value for the number of PDCCH candidates that can be monitored and the number of CCEs constituting the entire search space (for example, the entire search space may refer to the entire CCE set corresponding to a union domain of multiple search space sets) with regard to each slot). According to an embodiment, if the value of “monitoringCapabilityConfig-r16” has been configured to be “r16monitoringcapability”, the UE may define a maximum value for the number of PDCCH candidates that can be monitored and the number of CCEs constituting the entire search space (for example, the entire search space may refer to the entire CCE set corresponding to a union domain of multiple search space sets) with regard to each span. The “monitoringCapabilityConfig-r16” may be determined by referring to the configuration information of Tables 14a and 14b below. However, according to various embodiments of the disclosure, the configuration information described above is not limited to those enumerated below.

TABLE 14a
PDCCH-Config information element

```
  -- ASN1START
  -- TAG-PDCCH-CONFIG-START
```

| PDCCH-Config ::= | SEQUENCE { | |
|---|---|---|
| controlResourceSetToAddModList | SEQUENCE(SIZE(1..3)) OF ControlResourceSet | OPTIONAL, -- Need N |
| controlResourceSetToReleaseList | SEQUENCE(SIZE (1..3)) OF ControlResourceSetId | OPTIONAL, -- Need N |
| searchSpacesToAddModList | SEQUENCE(SIZE (1..10)) OF SearchSpace | OPTIONAL, -- Need N |
| searchSpacesToReleaseList | SEQUENCE(SIZE (1..10)) OF SearchSpaceId | OPTIONAL, -- Need N |
| downlinkPreemption | SetupRelease { DownlinkPreemption } | OPTIONAL, -- Need M |
| tpc-PUSCH | SetupRelease { PUSCH-TPC-CommandConfig } | OPTIONAL, -- Need M |
| tpc-PUCCH | SetupRelease { PUCCH-TPC-CommandConfig } | OPTIONAL, -- Need M |
| tpc-SRS | SetupRelease { SRS-TPC-CommandConfig} | OPTIONAL, -- Need M |

```
    ...,
    [[
```

| | |
|---|---|
| controlResourceSetToAddModListSizeExt-v1610 SEQUENCE (SIZE (1..2)) OF ControlResourceSet | OPTIONAL, -- |

Need N

| | |
|---|---|
| controlResourceSetToReleaseListSizeExt-r16 SEQUENCE (SIZE (1..5)) OF ControlResourceSetId-r16 | OPTIONAL, -- Need |

N

| | | |
|---|---|---|
| searchSpacesToAddModListExt-r16 | SEQUENCE(SIZE (1..10)) OF SearchSpaceExt-r16 | OPTIONAL, -- Need N |
| uplinkCancellation-r16 | SetupRelease { UplinkCancellation-r16 } | OPTIONAL, -- Need M |
| monitoringCapabilityConfig-r16 | ENUMERATED { | OPTIONAL, - |
| | r15monitoringcapability,r16monitoringcapability } | |

- Need M

| | | |
|---|---|---|
| searchSpaceSwitchConfig-r16 | SearchSpaceSwitchConfig-r16 | OPTIONAL -- Need R |

```
    ]]
  }
```

| SearchSpaceSwitchConfig-r16 ::= | SEQUENCE { | |
|---|---|---|
| cellGroupsForSwitchList-r16 | SEQUENCE(SIZE (1..4)) OF CellGroupForSwitch-r16 | OPTIONAL, -- Need R |
| searchSpaceSwitchDelay-r16 | INTEGER (10..52) | OPTIONAL -- Need R |

}

| | |
|---|---|
| CellGroupForSwitch-r16 ::= | SEQUENCE(SIZE (1..16)) OF ServCellIndex |

```
  -- TAG-PDCCH-CONFIG-STOP
  -- ASN1STOP
```

TABLE 14b
PDCCH-Config field descriptions

controlResourceSetToAddModList, controlResourceSetToAddModListSizeExt
List of UE specifically configured Control Resource Sets (CORESETs) to be used by the UE. The network restrictions on
configuration of CORESETs per DL BWP are specified in TS 38.213 [13], clause 10.1 and TS 38.306 [26]. The UE shall consider
entries in controlResourceSetToAddModList and in controlResourceSetToAddModListSizeExt as a single list, i.e. an entry created
using controlResourceSetToAddModList can be modified using controlResourceSetToAddModListSizeExt (or deleted using
controlResourceSetToReleaseListSizeExt) and vice-versa. In case network reconfigures control resource set with the same
ControlResourceSetId as used for commonControlResourceSet configured via PDCCH-ConfigCommon, the configuration from
PDCCH-Config always takes precedence and should not be updated by the UE based on servingCellConfigCommon.
controlResourceSetToReleaseList, controlResourceSetToReleaseListSizeExt
List of UE specifically configured Control Resource Sets (CORESETs) to be released by the UE. This field only applies to
CORESETs configured by controlResourceSetToAddModList or controlResourceSetToAddModListSizeExt and does not release
the field commonControlResourceSet configured by PDCCH-ConfigCommon.
downlinkPreemption
Configuration of downlink preemption indications to be monitored in this cell (see TS 38.213 [13], clause 11.2).
monitoringCapabilityConfig
Configures either Rel-15 PDCCH monitoring capability or Rel-16 PDCCH monitoring capability for PDCCH monitoring
on a serving cell. Value r15monitoringcapablity enables the Rel-15 monitoring capability, and value
r16monitoringcapablity enables the Rel-16 PDCCH monitoring capability (see TS 38.213 [13], clause 10.1).
searchSpacesToAddModList, searchSpacesToAddModListExt
List of UE specifically configured Search Spaces. The network configures at most 10 Search Spaces per BWP per cell (including
UE-specific and common Search Spaces). If the network includes searchSpaceToAddModListExt, it includes the same number
of entries, and listed in the same order, as in searchSpacesToAddModList.
tpc-PUCCH
Enable and configure reception of group TPC commands for PUCCH.
tpc-PUSCH
Enable and configure reception of group TPC commands for PUSCH.
tpc-SRS
Enable and configure reception of group TPC commands for SRS.
uplinkCancellation
Configuration of uplink cancellation indications to be monitored in this cell (see TS 38.213 [13], clause 11.2A).

### Condition 1: Maximum Number of PDCCH Candidates Limited

According to an embodiment, in a cell, depending on a configuration value of upper layer signaling, Mu, which is a maximum number of PDCCH candidates that a UE can monitor, may be configured as a subcarrier spacing of 15·2 μkHz. According to an embodiment, Mu may follow Table 15a below when it is defined based on slot and may follow Table 15b below when it is defined based on span.

TABLE 15a

| | Maximum number of PDCCH candidates per slot and |
|---|---|
| μ | per serving cell (M^{μ}) |
| 0 | 44 |
| 1 | 36 |
| 2 | 22 |
| 3 | 20 |

TABLE 15b

| | Maximum number M^{μ} of monitored PDCCH | | |
|---|---|---|---|
| | candidates per span for combination (X, Y) and per | | |
| | serving cell | | |
| μ | (2, 2) | (4, 3) | (7, 3) |
| 0 | 14 | 28 | 44 |
| 1 | 12 | 24 | 36 |

### Condition 2: Maximum Number of CCEs Limited

According to an embodiment, in a cell, depending on a configuration value of upper layer signaling, Cu, which is the maximum number of CCEs configuring the entire search space (for example, the entire search space may refer to a set of all CCEs corresponding to a union region of multiple search space sets), may be configured as a subcarrier spacing of 15·2 μkHz. According to an embodiment, Cμ may follow Table 16a below when it is defined based on slot and may follow Table 16b below when it is defined based on span.

TABLE 16a

| | Maximum number of non-overlapped |
|---|---|
| | CCEs per slot and |
| μ | per serving cell (C^{μ}) |
| 0 | 56 |
| 1 | 56 |
| 2 | 48 |
| 3 | 32 |

TABLE 16b

| | Maximum number C^{μ} of non-overlapped CCEs per | | |
|---|---|---|---|
| | span for combination (X,Y) and per serving cell | | |
| μ | (2, 2) | (4, 3) | (7, 3) |
| 0 | 18 | 36 | 56 |
| 1 | 18 | 36 | 56 |

For the sake of descriptive convenience, a situation satisfying both conditions 1 and 2 above at a specific timepoint may be defined as “condition A”. Therefore, the description that condition A is not satisfied may mean that at least one of conditions 1 and 2 above is not satisfied.

### PDCCH: Overbooking

According to the configuration of search space sets of the base station, a case in which condition A is not satisfied may occur at a specific timepoint. If condition A is not satisfied at a specific timepoint, the UE may select and monitor only some of search space sets configured to satisfy condition A at the corresponding timepoint. If condition A is not satisfied at a specific timepoint, the base station may transmit a PDCCH to the selected search space set.

A method for selecting some search spaces from all configured search space sets may follow methods given below.

If condition A regarding a PDCCH fails to be satisfied at a specific timepoint (or a specific slot), the UE (or the base station) may preferentially select a search space set having a search space type configured as a common search space, among search space sets existing at the corresponding timepoint, over a search space set configured as a UE-specific search space.

If all search space sets configured as common search spaces have been selected (that is, if condition A is satisfied even after all search spaces configured as common search spaces have been selected), the UE (or the bae station) may select search space sets configured as UE-specific search spaces. If there are multiple search space sets configured as UE-specific search spaces, a search space set having a lower search space set index may have a higher priority. UE-specific search space sets may be selected as long as condition A is satisfied, in consideration of the priority.

### QCL, TCI State

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a quasi-co-location (QCL) configuration as in Table 17 below. A TCI state may be for indicating the QCL relation between a PDCCH (or a PDCCH DRMS) and another RS or channel. The description that a reference antenna port A (reference RS #A) and another target antenna port B (target RS #B) are QCLed with each other may mean that the UE is allowed to apply some or all of large-scale channel parameters estimated in the antenna port A to channel measurement form the antenna port B. The QCL may need to be associated with different parameters according to the situation, such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations may be supported in NR as in Table 17 below.

TABLE 17

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 18 below. Referring to Table 18, the base station may configure one or more TCI states for the UE, and inform the UE of a maximum of two kinds of QCL relations (qcl-Type1, qcl-Type2) regarding the reference signal (RS) that refers to the ID of the TCI state, that is, the target RS. Each piece of QCL information (QCL-Info) included in each TCI state may include the serving cell index and the BWP index of the reference RS indicated by the corresponding QCL information, the type and ID of the reference RS, or a QCL type as in Table 17. Of course, according to various embodiments of the disclosure, information included in QCL information is not limited to the above examples.

TABLE 18

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first refernece RS of RS (target RS) referring to corresponding TCI state
ID)

| | |
|---|---|
| qcl-Type2 | QCL-Info |

```
      OPTIONAL, -- Need R
  (QCL information of second refernece RS of RS (target RS) referring to corresponding TCI
state ID)
  ...
}
```

| | |
|---|---|
| QCL-Info ::= | SEQUENCE { |
| cell | ServCellIndex |

```
    OPTIONAL, -- Need R
  (serving cell index of reference RS indicated by corresponding QCL information)
```

| | |
|---|---|
| bwp-Id | BWP-Id |

```
  OPTIONAL, -- Cond CSI-RS-Indicated
  (BWP index of reference RS indicated by corresponding QCL information)
```

| | |
|---|---|
| referenceSignal | CHOICE { |
| csi-rs | NZP-CSI-RS- |

ResourceId,

| | |
|---|---|
| ssb | SSB- |

```
Index
    (one of CSI-RS ID or SSB ID indicated by corresponding QCL information)
  },
```

| | |
|---|---|
| qcl-Type | ENUMERATED {typeA, |

typeB, typeC, typeD},
...
}

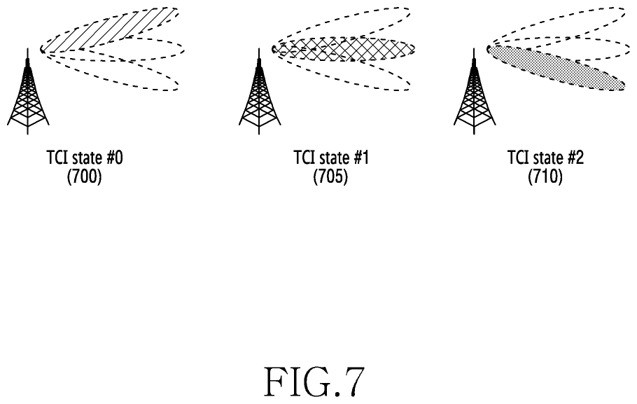

FIG. 7 illustrates an example of base station beam allocation according to TCI state configuration in a wireless communication system according to an embodiment of the disclosure. Referring to FIG. 7, the base station may transfer information regarding N different beams to the UE through N different TCI states. As illustrated in FIG. 7, for example, in the case of N=3, the base station may configure qcl-Type2 parameters included in three TCI states 700, 705, and 710 in QCL type D so that the parameters can be associated with CSI-RSs or SSBs corresponding to different beams. As a result, the base station may show that antenna ports referring to the different TCI states 700, 705, and 710 are associated with different spatial Rx parameters (i.e., different beams).

Tables 19a to 19e below show valid TCI state configurations according to the target antenna port types.

Table 19a shows valid TCI state configurations when the target antenna port is a CSI-RS for tracking (TRS). The TRS may refer to a non-zero-power (NZP) CSI-RS which has no repletion parameter configured for same and trs-Info of which is configured as true in Tables 20a and 20b below. In Table 19a, configuration no. 3 may be used for an aperiodic TRS. However, according to various embodiments of the disclosure, TCI state configuration may not be limited to the examples given in Table 19a.

TABLE 19a

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 19b shows valid TCI state configurations when the target antenna port is a CSI-RS for CSI. The CSI-RS for CSI may refer to an NZP CSI-RS which has no parameter indicating repetition (for example, repetition parameter) configured therefor, and trs-Info of which is not configured as “true”, among CRI-RSs. However, according to various embodiments of the disclosure, TCI state configuration may not be limited to the examples given in Table 19b.

TABLE 19b

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for | QCL-TypeD |
| | | | BM | |
| 3 | TRS | QCL-TypeA | TRS (same as | QCL-TypeD |
| | | | DL RS 1) | |
| 4 | TRS | QCL-TypeB | | |

Table 19c shows valid TCI state configurations when the target antenna port is a CSI-RS for beam management (for example, which has the same meaning as CSI-RS for L1 reference signal received power (RSRP) reporting). The CSI-RS for BM may refer to an NZP CSI-RS which has a repetition parameter configured to have a value of “on” or “off”, and trs-Info of which is not configured as “true”, among CRI-RSs. However, according to various embodiments of the disclosure, TCI state configurations may not be limited to the examples given in Table 19c.

TABLE 19c

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/ | QCL-TypeC | SS/ | QCL-TypeD |
| | PBCH | | PBCH | |
| | Block | | Block | |

Table 19d below shows valid TCI state configurations when the target antenna port is a PDCCH DMRS. However, according to various embodiments of the disclosure, TCI state configurations may not be limited to the examples given in Table 19d.

TABLE 19d

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS | QCL-TypeD |
| | | | (same as | |
| | | | DL RS 1) | |
| 2 | TRS | QCL-TypeA | CSI-RS (BM) | QCL-TypeD |
| 3 | CSI-RS | QCL-TypeA | CSI-RS | QCL-TypeD |
| | (CSI) | | (same as | |
| | | | DL RS 1) | |

Table 19e below shows valid TCI state configurations when the target antenna port is a PDSCH DMRS. However, according to various embodiments of the disclosure, TCI state configurations may not be limited to the examples given in Table 19e.

TABLE 19e

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (CSI) | |

In the QCL configuration method based on Tables 19a to 19e described above according to an embodiment, the target antenna port and reference antenna port for each step may be configured and operated in such a manner as “SSB”->“TRS”->“CSI-RS for CSI, or CSI-RS for BM, or PDCCH DMRS, or PDSCH DMRS”. Accordingly, it may be possible to help the UE's receiving operation by associating statistical characteristics that can be measured from the SSB and TRS with respective antenna ports.

Configuration information of trs-Info associated with NZP CSI-RS may be identified from Tables 20a and 20b below. However, according to various embodiments of the disclosure, configuration information of trs-info may not be limited to the examples given in Table 20a or Table 20b.

TABLE 20a
NZP-CSI-RS-ResourceSet information element

-- ASN1START
-- TAG-NZP-CSI-RS-RESOURCESET-START

| NZP-CSI-RS-ResourceSet ::= | SEQUENCE { | |
|---|---|---|
| nzp-CSI-ResourceSetId | NZP-CSI-RS-ResourceSetId, | |
| nzp-CSI-RS-Resources | SEQUENCE (SIZE (1..maxNrofNZP-CSI-RS-ResourcesPerSet)) OF NZP-CSI-RS-ResourceId, | |
| repetition | ENUMERATED { on, off } | OPTIONAL, -- Need S |
| aperiodicTriggeringOffset | INTEGER(0..6) | OPTIONAL, -- Need S |
| trs-Info | ENUMERATED {true} | OPTIONAL, -- Need R |

```
  ...,
  [[
```

| | | |
|---|---|---|
| aperiodicTriggeringOffset-r16 | INTEGER(0..31) | OPTIONAL -- Need S |

]]
}
-- TAG-NZP-CSI-RS-RESOURCESET-STOP
-- ASN1STOP

TABLE 20b
NZP-CSI-RS-ResourceSet field descriptions

aperiodicTriggeringOffset, aperiodicTriggeringOffset-r16
Offset X between the slot containing the DCI that triggers a set of aperiodic NZP CSI-RS resources and the slot in which the CSI-
RS resource set is transmitted. For aperiodicTriggeringOffset, the value 0 corresponds to 0 slots, value 1 corresponds to 1 slot,
value 2 corresponds to 2 slots, value 3 corresponds to 3 slots, value 4 corresponds to 4 slots, value 5 corresponds to 16 slots, value
6 corresponds to 24 slots. For aperiodicTriggeringOffset-r16, the value indicates the number of slots. The network configures only
one of the fields. When neither field is included, the UE applies the value 0.
nzp-CSI-RS-Resources
NZP-CSI-RS-Resources associated with this NZP-CSI-RS resource set (see TS 38.214 [19], clause 5.2). For CSI, there are at most
8 NZP CSI RS resources per resource set.
repetition
Indicates whether repetition is on/off. If the field is set to off or if the field is absent, the UE may not assume that the NZP-CSI-RS
resources within the resource set are transmitted with the same downlink spatial domain transmission filter (see TS 38.214 [19],
clauses 5.2.2.3.1 and 5.1.6.1.2). It can only be configured for CSI-RS resource sets which are associated with CSI-ReportConfig
with report of L1 RSRP, L1 SINR or “no report”.
trs-Info
Indicates that the antenna port for all NZP-CSI-RS resources in the CSI-RS resource set is same. If the field is absent or released
the UE applies the value false (see TS 38.214 [19], clause 5.2.2.3.1).

### PDCCH: Regarding TCI State

Specific TCI state combinations applicable to a PDCCH DMRS antenna port are given in Table 21 below. The fourth row in Table 21 corresponds to a combination assumed by the UE before RRC configuration, and no configuration may be possible after the RRC configuration.

TABLE 21

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS | QCL- | | |
| | (CSI) | TypeA | | |
| 4 | SS/PBCH | QCL- | SS/PBCH | QCL-TypeD |
| | Block | TypeA | Block | |

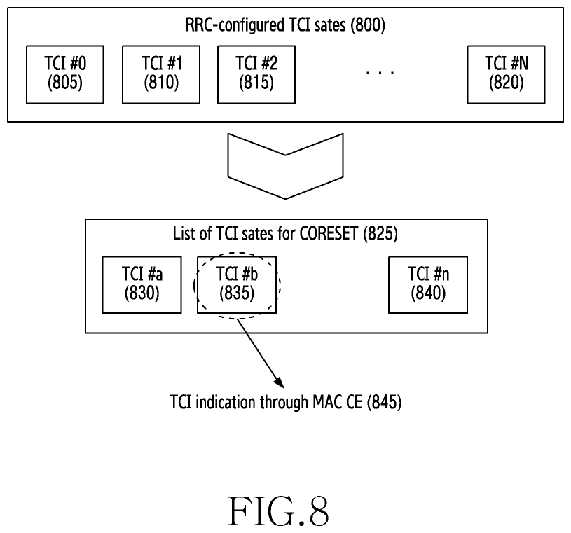

FIG. 8 illustrates an example of a method for TCI state allocation with regard to a PDCCH in a wireless communication system according to an embodiment of the disclosure. Specifically, in NR, a hierarchical signaling method as illustrated in FIG. 8 may be supported for dynamic allocation regarding a PDCCH beam.

Referring to FIG. 8, the base station may configure N TCI states 805, 810, . . . , 820 for the UE through RRC signaling 800, and may configure some of the states as TCI states for a CORESET (825). The base station may then indicate one of the TCI states 830, 835, and 840 for the CORESET to the UE through MAC control element (CE) signaling (845). Thereafter, the UE may receive a PDCCH, based on beam information included in the TCI state indicated by the MAC CE signaling.

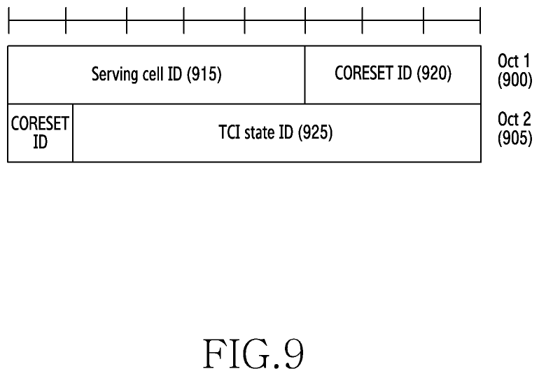

FIG. 9 illustrates a TCI indication MAC CE signaling structure for a PDCCH DMRS in a wireless communication system according to an embodiment of the disclosure.

Referring to FIG. 9, the TCI indication MAC CE signaling for the PDCCH DMRS may be configured by 2 bytes (16 bits) (Oct1 900 and Oct2 905), and may include a 5-bit serving cell ID 915, a 4-bit CORESET ID 920, and a 7-bit TCI state ID 925.

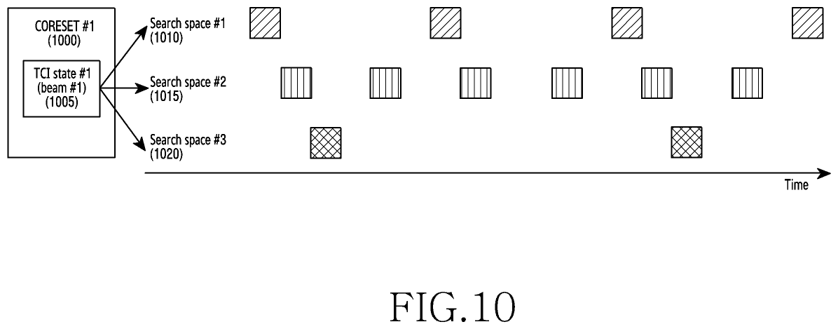

FIG. 10 illustrates beam configuration with regard to a control resource set and a search space in a wireless communication system according to an embodiment of the disclosure.

Referring to FIG. 10, the base station may indicate one 1005 of TCI state lists included in CORESET configuration 1000 through MAC CE signaling. Until a different TCI state is indicated for the corresponding CORESET through different MAC CE signaling, the UE may consider or determine that identical QCL information (beam #1) 1005 is applied to all of one or more search spaces 1010, 1015, and 1020 connected to the CORESET. By the PDCCH beam allocation method described above, it may be difficult to indicate beam change faster than MAC CE signaling delay. Further, in the PDCCH beam allocation method described above, the same beam is collectively applied to all CORESETs regardless of search space characteristics, and it may be thus difficult to achieve smooth PDCCH beam operation.

In the following embodiments of the disclosure, more flexible PDCCH beam configuration and operation methods will be provided. Although multiple distinctive examples will be provided for convenience of description of embodiments of the disclosure below, they are not mutually exclusive, and can be combined and applied appropriately for each situation.

The base station may configure one or multiple TCI states for the UE with regard to a specific control resource set. The base station may activate one of the configured TCI states through a MAC CE activation command. For example, {TCI state #0, TCI state #1, TCI state #2} may be configured as TCI states for control resource set #1. The base station may transmit an activation command to the UE through a MAC CE such that TCI state #0 is assumed as the TCI state for control resource set #1. The UE may receive the DMRS of the corresponding control resource set, based on the activation command regarding the TCI state received through the MAC CE. The UE may receive the DMRS of the corresponding control resource set, based on QCL information in the activated TCI state

With regard to a control resource set having a configured index of 0 (control resource set #0), if the UE has failed to receive a MAC CE activation command regarding the TCI state of control resource set #0, the UE may assume that the DMRS transmitted in control resource set #0 has been QCL-ed with a SS/PBCH block (SSB) identified in the initial access process or in a non-contention-based random access process not triggered by a PDCCH command.

With regard to a control resource set having a configured index value (X) other than 0 (control resource set #X), if the UE has no TCI state configured regarding control resource set #X, or if the UE has one or more TCI states configured therefor but has failed to receive a MAC CE activation command for activating one of the TCI states, the UE may assume that the DMRS transmitted in control resource set #X has been QCL-ed with a SS/PBCH block identified in the initial access process.

### PDCCH: Regarding QCL Prioritization Rule

Hereinafter, operations for determining QCL priority regarding a PDCCH will be described in detail.

The UE may perform operation for carrier aggregation (CA) within a single cell or band. If multiple control resource sets which exist in activated bandwidth parts within a single cell or multiple cells temporally overlap each other while having identical or different QCL-TypeD characteristics in a specific PDCCH monitoring interval, the UE may select a specific control resource set according to a QCL priority determining operation and may monitor control resource sets having the same QCL-TypeD characteristics as the corresponding control resource set. That is, if multiple control resource sets overlap temporally, only one QCL-TypeD characteristic can be received. The QCL priority may be determined by the following criteria.
Criterion 1: a control resource set connected to a common search space having the lowest index within a cell corresponding to the lowest index among cells including a common search space
Criterion 2: a control resource set connected to a common search space having the lowest index within a cell corresponding to the lowest index among cells including a common search space

As described above, if one criterion among the criteria is not satisfied, the next criterion may be applied. For example, if control resource sets overlap temporally in a specific PDCCH monitoring interval, and if all control resource sets are not connected to a common search space but connected to a UE-specific search space (that is, if criterion 1 is not satisfied), the UE may omit application of criterion 1 and apply criterion 2. However, according to various embodiments of the disclosure, the criteria applied by the UE may not be limited to the examples described above.

If selecting control resource set according to the above-mentioned criteria, the UE may additionally consider the two aspects with regard to QCL information configured for the control resource set. First, if control resource set 1 has CSI-RS 1 as a reference signal having a relation of QCL-TypeD, if this CSI-RS 1 has a relation of QCL-TypeD with reference signal SSB 1, and if another control resource set 2 has a relation of QCL-TypeD with reference signal SSB 1, the UE may determine or consider that the two control resource sets 1 and 2 have different QCL-TypeD characteristics. Second, if control resource set 1 has CSI-RS 1 configured in cell 1 as a reference signal having a relation of QCL-TypeD, if this CSI-RS 1 has a relation of QCL-TypeD with reference signal SSB 1, if control resource set 2 has a relation of QCL-TypeD with reference signal CSI-RS 2 configured in cell 2, and if this CSI-RS 2 has a relation of QCL-TypeD with the same reference signal SSB 1, the UE may determine or consider that the two control resource sets have the same QCL-TypeD characteristics.

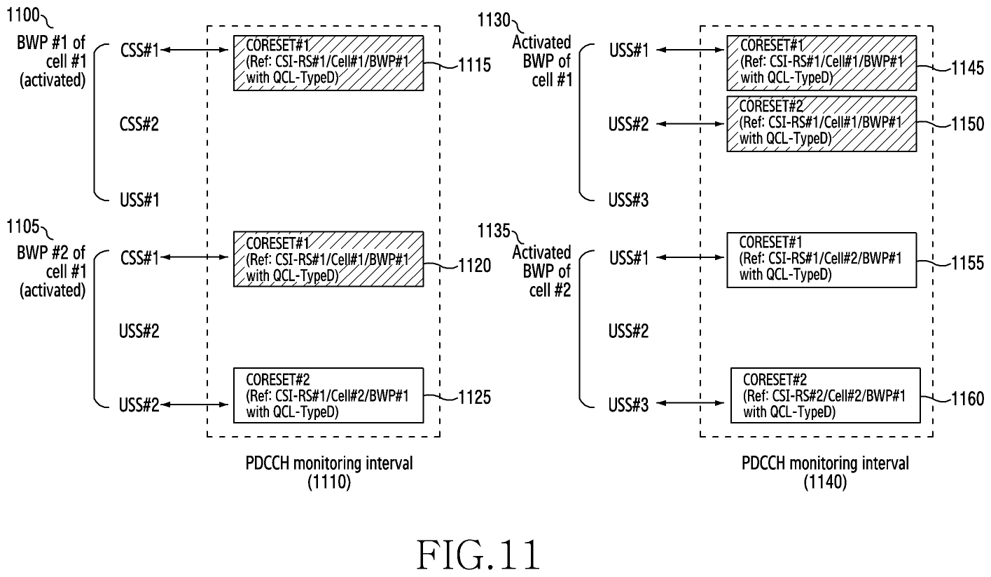

FIG. 11 illustrates an example of a method in which, upon receiving a downlink control channel, a UE selects a receivable control resource set in consideration of priority in a wireless communication system according to an embodiment of the disclosure.

According to an embodiment, the UE may be configured to receive multiple control resource sets overlapping temporally in a specific PDCCH monitoring interval 1110. The multiple control resource sets configured to be received by the UE may be connected to a common search space or a UE-specific search space with regard to multiple cells. According to an embodiment, in the corresponding PDCCH monitoring interval, control resource set (CORESET #1) connected to common search space #1 may exist in bandwidth part #1 1110 of cell #1. According to an embodiment, in the corresponding PDCCH monitoring interval, control resource set #1 (CORESET #1) 1120 connected to UE-specific search space #1 and control resource set #2 (USS #2) 1125 connected to UE-specific search space (USS #2) may exist in bandwidth part #1 1105 of cell #2. The control resource sets 1115 and 1120 may have a relation of QCL-TypeD with CSI-RS resource #1 configured in bandwidth part #1 of cell #1. The control resource set 1125 may have a relation of QCL-TypeD with CSI-RS resource #1 configured in bandwidth part #1 of cell #2. Therefore, if criterion 1 is applied to the corresponding PDCCH monitoring interval 1110, the UE may receive all other control resource sets having the same reference signal of QCL-TypeD as control resource set #1 1115. Therefore, the UE may receive the control resource sets 1115 and 1120 in the corresponding PDCCH monitoring interval 1110.

According to various embodiments, referring to FIG. 11, the UE may be configured to receive multiple control resource sets overlapping temporally in a specific PDCCH monitoring occasion 1140. The multiple control resource sets configured to be received by the UE may be connected to a common search space or a UE-specific search space with regard to multiple cells. In the corresponding PDCCH monitoring interval, control resource set #1 (CORESET #1) 1145 connected to UE-specific search space #1 (USS #1) and control resource set #2 (CORESET #2) 1150 connected to UE-specific search space #2 may exist in bandwidth part #1 1130 of cell #1. In the corresponding PDCCH monitoring interval, control resource set #1 (CORESET #1) 1155 connected to UE-specific search space #1 and control resource set #2 (CORESET #2) 1160 connected to UE-specific search space #3 may exist in bandwidth part #1 1135 of cell #2. The control resource sets 1145 and 1150 may have a relation of QCL-TypeD with CSI-RS resource #1 configured in bandwidth part #1 of cell #1. The control resource set 1155 may have a relation of QCL-TypeD with CSI-RS resource #1 configured in bandwidth part #1 of cell #2. The control resource set 1160 may have a relation of QCL-TypeD with CSI-RS resource #2 configured in bandwidth part #1 of cell #2. If criterion 1 is applied to the corresponding PDCCH monitoring interval 1140, there is no common search space, and the next criterion, that is, criterion 2, may thus be applied. If criterion 2 is applied to the corresponding PDCCH monitoring occasion 1140, the UE may receive all other control resource sets having the same reference signal of QCL-TypeD as the control resource set 1145. The UE may receive the control resource sets 1145 and 1150 in the corresponding PDCCH monitoring occasion 1140.

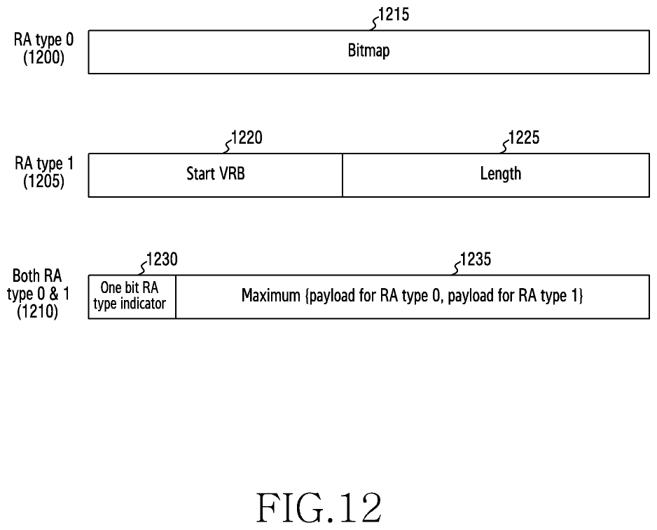

FIG. 12 illustrates an example of frequency domain resource allocation for a PDSCH in a wireless communication system according to an embodiment of the disclosure. Referring to FIG. 12, three frequency domain resource allocation methods including resource assignment (RA) type 0 (1200), RA type 1 (1205), and dynamic switching of resource assignment (RA type 0, RA type 1) (1210) are illustrated.

Referring to FIG. 12, in the case in which a UE is configured to use only resource type 0 (1200) through upper layer signaling, partial downlink control information (DCI) for allocating a PDSCH to the UE may include a bitmap 1215 including N_RBG bits. Here, NRBG may refer to the number of resource block groups (RBGs) determined according to the BWP size allocated by a BWP indicator and upper layer parameter rbg-Size, as in Table 22 below, and data is transmitted in RBGs indicated as “1” by the bitmap. According to an embodiment, data may be transmitted in an RBG indicated as “1” by the bitmap.

TABLE 22

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In case that the UE is configured to use only resource type 1 (1205) through higher layer signaling, some DCI for allocating PDSCHs to the UE may include frequency domain resource allocation information including [log₂(N_{RB}^{DL,BWP}(N_{RB}^{DL,BWP}+1)/2] bits. N^{DL,BWP}_{RB} described above is the number of RBs of a downlink bandwidth part. The base station may configure a starting virtual resource block (VRB) 1220 and the length 1225 of a frequency domain resource allocated continuously therefrom.

In the case 1210 in which the UE is configured to use both resource type 0 and resource type 1 through upper layer signaling, partial DCI for allocating a PDSCH to the corresponding UE may include frequency domain resource allocation information including as many bits as the larger value 1235 between the payload for configuring resource type 0 and the payload for configuring resource type 1. In the DCI, one bit 1230 may be added to the frontmost part (for example, the most significant bit (MSB)) of the frequency domain resource allocation information to indicate use of RA type 0 or use of RA type 1. For example, the corresponding bit 1230 may indicate use of RA type 0 when the bit has a value of “0” and indicate use of RA type 1 when the bit has a value of “1”.

### PDSCH/PUSCH: Regarding Time Resource Allocation

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of 16 entries (maxNrofDL-Allocations=16) for the PDSCH. A table including a maximum of 16 entries (maxNrofUL-Allocations=16) for the PUSCH. According to an embodiment, the time domain resource allocation information may include at least one of PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, and the mapping type of a PDSCH or PUSCH. For example, information such as in Table 23 or Table 24 below may be transmitted from the base station to the UE. However, according to an embodiment of the disclosure, information included in the time domain resource allocation information is not limited to the above examples.

TABLE 23
PDSCH-TimeDomainResourceAllocationList information element

PDSCH-TimeDomainResourceAllocationList ::= SEQUENCE (SIZE(1..maxNrofDL-Allocations)) OF
PDSCH-TimeDomainResourceAllocation

| | |
|---|---|
| PDSCH-TimeDomainResourceAllocation ::= | SEQUENCE { |
| k0 | INTEGER(0..32) |

```
  OPTIONAL, -- Need S
    (PDCCH-to-PDSCH timing, slot unit)
```

| | |
|---|---|
| mappingType | ENUMERATED {typeA, typeB}, |

(PDSCH mapping type)

| | |
|---|---|
| startSymbolAndLength | INTEGER (0..127) |

(start symbol and length of PDSCH)
}

TABLE 24
PUSCH-TimeDomainResourceAllocationList information element

PUSCH-TimeDomainResourceAllocationList ::= SEQUENCE (SIZE(1..maxNrofUL-Allocations)) OF
PUSCH-TimeDomainResourceAllocation

| PUSCH-TimeDomainResourceAllocation ::= | SEQUENCE { | |
|---|---|---|
| k2 | INTEGER(0..32) | OPTIONAL, -- Need S |

(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(start symbol and length of PUSCH)
}

The base station may notify the UF of one of the entries of the table regarding time domain resource allocation information described above through L1 signaling (for example, DCI). According to an embodiment, one of the entries of the table regarding time domain resource allocation information may be indicated by the “time domain resource allocation” field. The UE may acquire time domain resource allocation information regarding a PDSCH or PUSCH, based on the DCI acquired from the base station.

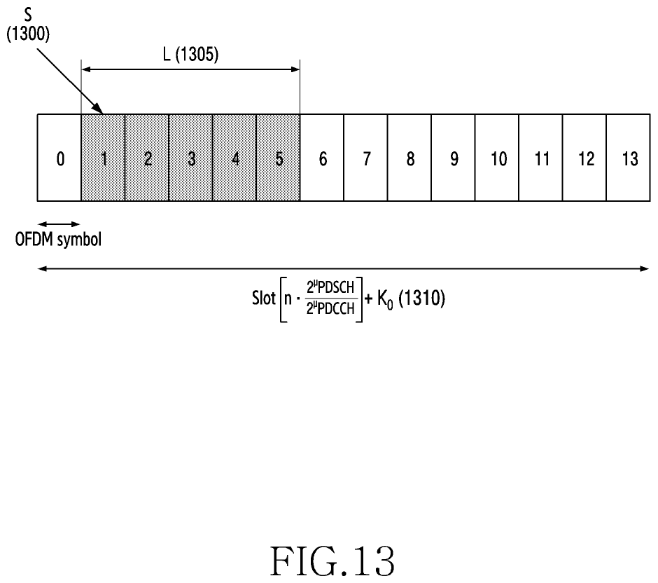

FIG. 13 illustrates an example of time domain resource allocation with regard to a PDSCH in a wireless communication system according to an embodiment of the disclosure.

Referring to FIG. 13, the UE may indicate at least one of the subcarrier spacing (SCS) (μPDSCH, μPDCCH) of a data channel and a control channel configured by using upper layer signaling, the scheduling offset (K0) value, or the time domain location of a PDSCH resource according to the OFDM symbol start location 1300 and length 1305 within one slot 1310 dynamically indicated through DCI.

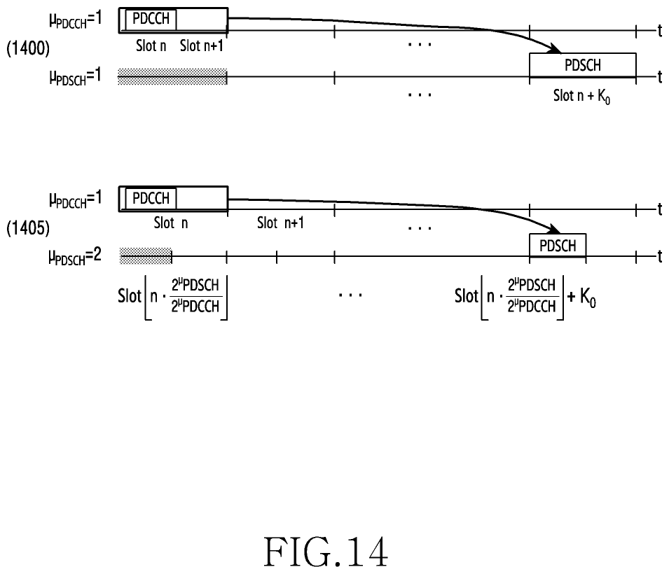

FIG. 14 illustrates an example of time domain resource allocation according to a subcarrier spacing with regard to a data channel and a control channel in a wireless communication system according to an embodiment of the disclosure.

Referring to FIG. 14, if the data channel and the control channel have the same subcarrier spacing 1400 (μPDSCH=μPDCCH), the slot number for data and that for control are identical, and the base station and the UE may accordingly generate a scheduling offset in conformity with a predetermined slot offset K0. On the other hand, if the data channel and the control channel have different subcarrier spacings 1405 (PDSCH #μPDCCH), the slot number for data and that for control are different, and the base station and the UE may accordingly generate a scheduling offset in conformity with a predetermined slot offset K0 with reference to the subcarrier spacing of the PDCCH. According to an embodiment, in case that the UE has received DCI indicating bandwidth part change in slot n and the slot offset value indicated by the DCI is K0, the UE may receive data in slot n+K0 through scheduled PDSCH.

### Related to SRS

Hereinafter, a method of estimating an uplink channel using sounding reference signal (SRS) transmission by the UE is described. The base station may configure at least one SRS configuration in every uplink BWP in order to transmit configuration information for the SRS transmission to the UE. The base station may configure at least one SRS resource set in every SRS configuration. According to an embodiment, the base station and the UE may exchange higher-layer signaling information below in order to transmit information related to an SRS resource set.
srs-ResourceSetId: SRS indicates a resource set index
srs-ResourceIdList: set of SRS resource indexes referred to by SRS resource set
resourceType: indicates a time-axis transmission configuration of SRS resources referred to by an SRS resource set and may be configured as one of ‘periodic’, ‘semi-persistent’, and ‘aperiodic’. When ‘periodic’ or ‘semi-persistent’ is configured, associated CSI-RS information may be provided according to a used place of the SRS resource set. When ‘aperiodic’ is configured, at least one of an aperiodic SRS resource trigger list and slot offset information may be provided and associated CSI-RS information may be provided according to a used place of the SRS resource set.
usage: indicates a configuration for a used place of SRS resources referred to by the SRS resource set and may be configured as one of ‘beamManagement’, ‘codebook’, ‘nonCodebook’, and ‘antennaSwitching’.
alpha, p0, pathlossReferenceRS, srs-PowerControlAdjustmentStates: provides a parameter configuration for controlling transmission power of SRS resources referred to by the SRS resource set.

The UE may understand that SRS resources included in the set of SRS resource indexes referred to by the SRS resource set follow information configured in the SRS resource set

The base station and the UE may transmit and receive high-layer signaling information in order to transmit individual configuration information for SRS resources. According to an embodiment, the individual configuration information for SRS resources may include time-frequency axis mapping information within the slot of SRS resources. The time-frequency axis mapping information within the slot of SRS resources may include information on intra-slot or inter-slot frequency hopping of SRS resources. According to an embodiment, the individual configuration information for SRS resources may include a time-axis transmission configuration of SRS resources. The time-axis transmission of SRS resources may be configured as one of ‘periodic’, ‘semi-persistent’, and ‘aperiodic’. The time-axis transmission of SRS resources may be limited to have the time-axis transmission configuration such as the SRS resources set including SRS resources. When the time-axis transmission configuration of SRS resources is configured as ‘periodic’ or ‘semi-persistent’, an SRS resource transmission period and a slot offset (e.g., periodicityAndOffset) may be additionally configured in the time-axis transmission configuration.

The base station may activate, deactivate, or trigger the SRS transmission to the UE through higher-layer signaling including RRC signaling or MAC CE signaling or L 1 signaling (e.g., DCI). For example, the base station may activate or deactivate periodic SRS transmission to the UE through higher-layer signaling. The base station may indicate activation of an SRS resource set having a resourceType configured as periodic through higher-layer signaling. The UE may transmit SRS resources referred to by the activated SRS resource set. Time-frequency axis resource mapping within the slot of the transmission SRS resources follows resource mapping information configured in the SRS resources, and slot mapping including the transmission period and the slot offset follows a periodicityAndOffset configured in the SRS resources. Further, a spatial domain transmission filter applied to the transmission SRS resources may refer to spatial relation info configured in the SRS resources or refer to associated CSI-RS information configured in the SRS resource set including the SRS resources. The UE may transmit SRS resources within an uplink BWP activated for activated semi-persistent SRS resources through higher-layer signaling.

The base station may activate or deactivate semi-persistent SRS transmission to the UE through high-layer signaling. The base station may indicate activation of the SRS resource set through MAC CE signaling. The UE may transmit SRS resources referred to by the activated SRS resource set. The SRS resource set activated through MAC CE signaling may be limited to an SRS resource set having the resourceType configured as semi-persistent. Time-frequency axis resource mapping within the slot of the transmission SRS resources follows resource mapping information configured in the SRS resources, and slot mapping including the transmission period and the slot offset follows a periodicityAndOffset configured in the SRS resources. A spatial domain transmission filter applied to the transmission SRS resources may refer to spatial relation info configured in the SRS resources or refer to associated CSI-RS information configured in the SRS resource set including the SRS resources. When spatial relation info is configured in the SRS resources, a spatial domain transmission filter may be determined with reference to configuration information for spatial relation info transmitted through MAC CE signaling activating semi-persistent SRS transmission without following the spatial relation info. The UE may transmit SRS resources within an uplink BWP activated for activated semi-persistent SRS resources through higher-layer signaling.

The base station may trigger aperiodic SRS transmission to the UE through the DCI. The base station may indicate one of the aperiodic SRS resource triggers (aperiodicSRS-ResourceTrigger) through an SRS request field of the DCI. The UE may understand that an SRS resource set including the aperiodic SRS resource trigger indicated through the DCI in an aperiodic SRS resource trigger list among SRS resource set configuration information is triggered. The UE may transmit the SRS resources referred to by the triggered SRS resource set. Time-frequency axis resource mapping within the slot of the transmitted SRS resources follows resource mapping information configured in the SRS resources. Slot mapping of the transmitted SRS resources may be determined through a slot offset between a PDCCH including DCI and the SRS resources, which may refer to a value(s) included in a slot offset set configured in the SRS resource set. Specifically, the slot offset between the PDCCH including DCI and the SRS resources may apply a value indicated by a time domain resource assignment field of DCI among an offset value(s) included in the slot offset set configured in the SRS resource set. A spatial domain transmission filter applied to the transmission SRS resources may refer to spatial relation info configured in the SRS resources or refer to associated CSI-RS information configured in the SRS resource set including the SRS resources. The UE may transmit SRS resources within an uplink BWP activated for triggered aperiodic SRS resources through the DCI.

When the base station triggers aperiodic SRS transmission to the UE through the DCI, the UE may need a minimum time interval between the PDCCH including DCI for triggering aperiodic SRS transmission and the transmitted SRS in order to transmit the SRS through the application of configuration information for SRS resource. The time interval for the SRS transmission by the UE may be defined as the number of symbols between the last symbol of the PDCCH including DCI for triggering aperiodic SRS transmission and the first symbol to which the SRS resource that is first transmitted among the transmitted SRS resource(s) is mapped. The minimum time interval may be defined with reference to a PUSCH preparation procedure time required for preparing the PUSCH transmission by the UE. Further, the minimum time interval may have different values according to a used place of the SRS resource set including the transmitted SRS resource. For example, the minimum time interval may be defined as N2 symbols defined in consideration of the UE processing capability according to the UE capability with reference to the PUSCH preparation procedure of the UE. Further, the minimum time interval may be determined as N2 symbols when the used place of the SRS resource set is configured as ‘codebook’ or ‘antennaSwitching’ in consideration of the used place of the SRS resource set including the transmitted SRS resource, and may be determined as (N2+14) symbols when the used place of the SRS resource set is configured as ‘nonCodebook’ or ‘beamManagement’. The UE may perform aperiodic SRS transmission when the time interval for aperiodic SRS transmission is longer than or equal to the minimum time interval. The UE may ignore the DCI for triggering the aperiodic SRS when the time interval for aperiodic SRS transmission is shorter than the minimum time interval.

TABLE 25

| | |
|---|---|
| [symbol] -Resource ::= | SEQUENCE [symbol] |
| [symbol] -ResourceId | [symbol] -ResourceId [symbol] |
| [symbol] | ENUMERATED [symbol] port1, port [symbol] , port [symbol] , |

| | |
|---|---|
| strs-Port [symbol] ndex | ENUMERATED [symbol] |

OPTIONAL, -- Need R

| | |
|---|---|
| transmissionComb | CHOICE [symbol] |
| n2 | SEQUENCE [symbol] |
| combOffset-n2 | INTEGER (0..1) [symbol] |
| cyclicShift-n2 | INTEGER (0..7) |

[symbol]

| | |
|---|---|
| n4 | SEQUENCE [symbol] |
| combOffset-n4 | INTEGER (0..9) [symbol] |
| cyclicShift-n4 | INTEGER (0..11) |

[symbol]

[symbol]

| | |
|---|---|
| resourceMapping | SEQUENCE [symbol] |
| startPosition | INTEGER ( [symbol] ) [symbol] |
| [symbol] ofSymbols | ENUMERATED [symbol] n1, n2, n4 [symbol] |
| repetitionFactor | ENUMERATED [symbol] n1, n2, n4 [symbol] |

[symbol]

| | |
|---|---|
| freq [symbol] Position | INTEGER (0.. [symbol] ) [symbol] |
| freq [symbol] Shift | INTEGER (0..268) [symbol] |
| freqHopping | SEQUENCE [symbol] |
| [symbol] -SRS | INTEGER (0.. [symbol] ) [symbol] |
| [symbol] -SRS | INTEGER (0.. [symbol] ) [symbol] |
| [symbol] | INTEGER (0..3) |

},

| | |
|---|---|
| groupOrSequenceHopping | ENUMERATED [symbol] neither, groupHopping, sequenceHopping [symbol] |
| resourceType | CHOICE [symbol] |
| [symbol] | SEQUENCE [symbol] |

...

[symbol]

| | |
|---|---|
| [symbol] | SEQUENCE [symbol] |
| [symbol] | [symbol] |

[symbol]

[symbol]

| | |
|---|---|
| periodic | SEQUENCE [symbol] |
| [symbol] | SRS- [symbol] |

...

[symbol]

[symbol]

| | |
|---|---|
| sequenceId | INTEGER (0.. [symbol] ) [symbol] |

| | |
|---|---|
| [symbol] | SRS-Spatial [symbol] |

OPTIONAL, -- Need R
...

[symbol]

[symbol]

indicates data missing or illegible when filed

In Table 25 above, spatialRelationInfo configuration information is applied to a beam used for corresponding SRS information of beam information of the corresponding reference signal with reference to one reference signal. For example, the configuration of spatialRelationInto may include information shown in Table 26 below. However, the configuration may not be limited to the examples disclosed in Table 25 and Table 26 according to embodiments of the disclosure.

TABLE 26

| SRS-SpatialRelationInfo ::= | SEQUENCE [symbol] | |
|---|---|---|
| servingCellId | ServCellIndex | OPTIONAL, -- Need S |

| | |
|---|---|
| referenceSignal | CHOICE [symbol] |
| [symbol] -Index | [symbol] -Index, |
| csi- [symbol] -Index | [symbol] -CSI-RS-ResourceId, |
| [symbol] | SEQUENCE [symbol] |
| resourceId | SRS-ResourceId, |
| [symbol] | BWP-Id |

[symbol]

[symbol]

[symbol]

[symbol]

indicates data missing or illegible when filed

Referring to the spatialRelationInfo configuration, an SS/PBCH block index, a CSI-RS index, or an SRS index may be configured as an index of a reference signal that the UE is to refer to use beam information of a specific reference signal from the base station. Higher-layer signaling referenceSignal is configuration information indicating a reference signal of which beam information is referred to for corresponding SRS transmission, ssb-Index is an index of an SS/PBCH block, csi-RS-Index is an index of a CSI-RS, and srs is an index of an SRS. When a value of higher-layer signaling referenceSignal is configured as ‘ssb-Index’, the UE may apply a reception beam used for receiving the SS/PBCH block corresponding to ssb-Index as a transmission beam of the corresponding SRS transmission. When a value of higher-layer signaling referenceSignal is configured as ‘csi-RS-Index’, the UE may apply a reception beam used for receiving the CSI-RS corresponding to csi-RS-Index as a transmission beam of the corresponding SRS transmission. When a value of higher-layer signaling referenceSignal is configured as ‘srs’, the UE may apply a transmission beam used for transmitting the SRS corresponding to srs as a transmission beam of the corresponding SRS transmission.

### PUSCH: Related to Transmission Scheme

Hereinafter, a scheduling scheme of the PUSCH transmission is described. The PUSCH transmission may be dynamically scheduled by a UL grant in DCI or may operate by configured grant Type 1 or Type 2. Dynamic scheduling of the PUSCH transmission may be indicated by DCI format 0_0 or 0_1.

Configured grant Type 1 PUSCH transmission may be semi-statically configured through reception of configuredGrantConfig including rrc-ConfiguredUplinkGrant in Table 27 through higher-layer signaling without reception of a UL grant in DCI. Configured grant Type 2 PUSCH transmission may be semi-persistently scheduled by a UL grant in DCI after reception of configuredGrantConfig which does not include rrc-ConfiguredUplinkGrant in Table 27 through higher-layer signaling. When the PUSCH transmission operates by a configured grant, parameters applied to the PUSCH transmission are applied through configuredGrantConfig which is higher-layer signaling of Table 27 except for dataScramblingIdentityPUSCH, txConfig, codebookSubset, maxRank, and scaling of UCI-OnPUSCH provided as pusch-Config of Table 28 which is higher-layer signaling. When the UE receives transformPrecoder within configuredGrantConfig which is higher-layer signaling of Table 27, the UE may apply tp-pi2BPSK within pusch-Config of Table 28 to the PUSCH transmission operating by the configured grant. However, in accordance with various embodiments of the disclosure, the parameters to be applied may not be limited to the above examples.

TABLE 27

| | |
|---|---|
| Configured [symbol] Config ::= | SEQUENCE [symbol] |
| FrequencyHopping | ENUMERATED [symbol] intraSlot, interSlot [symbol] |

OPTIONAL, -- Need

[symbol]

| | |
|---|---|
| [symbol] -DMRS-Configuration | [symbol] |
| [symbol] -Table | ENUMERATED [symbol] |

OPTIONAL, -- Need S

| | |
|---|---|
| scs-Table [symbol] | ENUMERATED [symbol] |

OPTIONAL, -- Need S

| | |
|---|---|
| [symbol] | [symbol] |

OPTIONAL, -- Need

[symbol]

| | |
|---|---|
| resourceAllocation | ENUMERATED [symbol] resourceAllocationType [symbol] resourceAllocationType [symbol] |

[symbol]

| | |
|---|---|
| [symbol] | ENUMERATED [symbol] |

OPTIONAL, -- Need S

| | |
|---|---|
| [symbol] | ENUMERATED [symbol] |
| [symbol] -PUSCH- [symbol] | P0-PUSCH- [symbol] |
| [symbol] Precoder | ENUMERATED [symbol] |

OPTIONAL, -- Need S

| | |
|---|---|
| [symbol] | [symbol] |
| [symbol] | ENUMERATED [symbol] |
| [symbol] | ENUMERATED [symbol] |

OPTIONAL, -- Need S

| | |
|---|---|
| periodicity | ENUMERATED [symbol] |
| | [symbol] |

[symbol]

[symbol]

[symbol]

[symbol]

[symbol]

[symbol]

[symbol]

[symbol]

[symbol]

[symbol]

| | |
|---|---|
| [symbol] | INTEGER [symbol] |

OPTIONAL, -- Need R

| | |
|---|---|
| [symbol] | SEQUENCE [symbol] |
| time [symbol] Offset | INTEGER [symbol] |
| time [symbol] Allocation | INTEGER [symbol] |
| [symbol] Allocation | BIT STRING [symbol] |
| antennaPort | INTEGER [symbol] |
| [symbol] | INTEGER [symbol] |

OPTIONAL, -- Need R

| | |
|---|---|
| precoding [symbol] | INTEGER [symbol] |
| [symbol] | INTEGER [symbol] |

OPTIONAL, -- Need R

| | |
|---|---|
| [symbol] | INTEGER [symbol] |
| [symbol] Offset | INTEGER [symbol] |

OPTIONAL, -- Need R

| | |
|---|---|
| [symbol] | INTEGER [symbol] |

```
    ...

[symbol]

OPTIONAL, -- Need R
  ...

[symbol]

[symbol]

indicates data missing or illegible when filed
```

Hereinafter, a PUSCH transmission method is described. A DMRS antenna port for the PUSCH transmission is the same as an antenna port for the SRS transmission. The PUSCH transmission may follow each of a codebook-based transmission method and a non-codebook-based transmission method according to whether a value of txConfig within pusch-Config of Table 28 which is higher-layer signaling is ‘codebook’ or ‘nonCodebook’.

As described above, the PUSCH transmission may be dynamically scheduled through DCI format 0_0 or 0_1 or semi-statically configured by the configured grant. When the UE receives an indication of scheduling of the PUSCH transmission through DCI format 0_0, the UE may perform a beam configuration for the PUSCH transmission by using pucch-spatialRelationInfoID corresponding to a UE-specific PUCCH resource corresponding to a minimum ID within the activated uplink BWP in the serving cell, and in this case, the PUSCH transmission may be performed based on a single antenna port. The UE may not expect scheduling of the PUSCH transmission through DCI format 0_0 within a BWP in which the PUCCH resource including pucch-spatialRelationInfo is not configured. When the UE does not receive a configuration of txConfig within pusch-Config of Table 28, the UE may not expect reception of scheduling through DCI format 0_1.

TABLE 28

| | |
|---|---|
| PUSCH-Config ::= | SEQUENCE [symbol] |
| data [symbol] | INTEGER [symbol] |

OPTIONAL, -- Need S

| | |
|---|---|
| txConfig | ENUMERATED [symbol] codebook, [symbol] |

OPTIONAL, -- Need S

| | |
|---|---|
| [symbol] | SetupRelease [symbol] |

OPTIONAL, -- Need

[symbol]

| | |
|---|---|
| [symbol] MappingType [symbol] | SetupRelease [symbol] |

OPTIONAL, Need

[symbol]

| | |
|---|---|
| pusch-PowerControl | [symbol] -PowerControl |

OPTIONAL, -- Need

[symbol]

| | |
|---|---|
| frequencyHopping | ENUMERATED [symbol] intraSlot, interSlot [symbol] |

OPTIONAL, -- Need S

| | |
|---|---|
| freuencyHopping [symbol] | SEQUNECE (SIZE (1..4)) OF INTEGER |

(1.. maxNrofPhysicalResourceBlock [symbol] -1)
OPTIONAL, -- Need M

| | |
|---|---|
| resourceAllocation | ENUMERATED [symbol] |

[symbol]

| | |
|---|---|
| pusch- [symbol] AllocationList | SetupRelease |
| | [symbol] PUSCH-Time [symbol] AllocationList [symbol] |

OPTIONAL, -- Need M

| | |
|---|---|
| pusch-AggregationFactor | ENUMERATED [symbol] n2, n4, [symbol] [symbol] |

OPTIONAL, -- Need S

| | |
|---|---|
| [symbol] -Table | ENUMERATED [symbol] |

OPTIONAL, -- Need S

| | |
|---|---|
| [symbol] -TableTransform [symbol] | ENUMERATED [symbol] |

OPTIONAL, -- Need S

| | |
|---|---|
| transformPrecoder | ENUMERATED [symbol] enabled, disabled [symbol] |

OPTIONAL, -- Need S

| | |
|---|---|
| codebookSubset | ENUMERATED [symbol] fullyAndPartialAndNon [symbol] |

partialAndNonCoherent,nonCoherent)
OPTIONAL, -- Cond

[symbol]

| | |
|---|---|
| [symbol] | INTEGER (1.. [symbol] ) |

OPTIONAL, -- Cond

[symbol]

| | |
|---|---|
| [symbol] | ENUMERATED [symbol] config2 [symbol] |

OPTIONAL, -- Need

[symbol]

| | |
|---|---|
| uci-OnPUSCH | SetupRelease [symbol] UCI-OnPUSCH [symbol] |

OPTIONAL, -- Need M

| | |
|---|---|
| [symbol] | ENUMERATED [symbol] enabled [symbol] |

OPTIONAL, -- Need S
...

[symbol]

[symbol]

indicates data missing or illegible when filed

Hereinafter, codebook-based PUSCH transmission is described. Codebook-based PUSCH transmission may be dynamically scheduled through DCI format 0_0 or 0_1 or semi-statically operate by the configured grant. When codebook-based PUSCH is dynamically scheduled by DCI format 0_1 or is semi-statically configured by the configured grant, the UE may determine a precoder for the PUSCH transmission, based on an SRS resource indicator (SRI), a transmission precoding matrix indicator (TPMI), and a transmission rank (i.e., the number of PUSCH transmission layers).

The SRI may be given through an SRS resource indicator field in the DCI or may be configured through srs-ResourceIndicator which is higher-layer signaling. In codebook-based PUSCH transmission, the UE may receive a configuration of at least one SRS resource and a maximum of two SRS resources. When the UE receives the SRI through the DCI, the SRS resource indicated by the corresponding SRI may refer to the SRS resource corresponding to the SRI among SRS resources transmitted earlier than the PDCCH including the corresponding SRI. Further, the TPMI and the transmission rank may be given through field precoding information and number of layers in the DCI or may be configured through precodingAndNumberOfLayers which is higher-layer signaling. The TPMI may be used to indicate a precoder applied to the PUSCH transmission. When the UE receives a configuration of one SRS resource, the TPMI may be used to indicate a precoder to be applied to the one configured SRS resource. When the UE receives a configuration of multiple SRS resources, the TPMI may be used to indicate a precoder to be applied to SRS resources indicated through the SRI.

The precoder to be used for the PUSCH transmission may be selected from an uplink codebook having the number of antenna ports which is the same as a value of nrofSRS-Ports within SRS-Config which is higher-layer signaling. In codebook-based PUSCH transmission, the UE may determine a codebook subset based on the TPMI and a codebookSubset within pusch-Config which is higher-layer signaling. The codebookSubset within pusch-Config which is higher-layer signaling may be configured as one of ‘fullyAndPartialAndNonCoherent’, ‘partialAndNonCoherent’, or ‘nonCoherent’, based on the UE capability which the UE reports to the base station. When the UE reports ‘partialAndNonCoherent’ as the UE capability, the UE does not expect a configuration of the value of the codebookSubset which is higher-layer signaling as ‘fullyAndPartialAndNonCoherent’. When the UE reports ‘nonCoherent’ as the UE capability, the UE may not expect a configuration of the value of the codebookSubset which is higher-layer signaling as ‘fullyAndPartialAndNonCoherent’ or ‘partialAndNonCoherent’. When nrofSRS-Ports within SRS-ResourceSet which is higher-layer signaling indicate two SRS antenna ports, the UE may not expect a configuration of the value of the codebookSubset which is higher-layer signaling as ‘partialAndNonCoherent’.

The UE may receive a configuration of one SRS resource set having a value of usage within SRS-ResourceSet which is higher-layer signaling configured as ‘codebook’, and one SRS resource may be indicated through the SRI within the corresponding SRS resource set. When several SRS resources are configured within the SRS resource set having the value of usage within SRS-ResourceSet which is higher-layer signaling configured as ‘codebook’, the UE may expect a configuration of the same value of nrofSRS-Ports within the SRS-Resource which is higher-layer signaling for all SRS resources.

The UE may transmit one or multiple SRS resources included in the SRS resource set having the value of usage configured as ‘codebook’ to the base station according to higher-layer signaling. The base station may select one of the SRS resources transmitted by the UE and instruct the UE to perform the PUSCH transmission by using transmission beam information of the corresponding SRS resource. At this time, in codebook-based PUSCH transmission, the SRI is used as information for selecting an index of one SRS resource and is included in the DCI. In addition, the base station may include, in the DCI, information indicating the TPMI and the rank to be used for the PUSCH transmission by the UE. The UE may use the SRS resource indicated by the SRI. The rank and the TPMI may be indicated based on the transmission beam of the SRS resource indicated by the SRI. The UE may perform the PUSCH transmission by applying a precoder indicated by the rank and the TPMI indicated based on the transmission beam of the SRS resource indicated by the SRI.

Subsequently, non-codebook-based PUSCH transmission is described. Non-codebook-based PUSCH transmission may be dynamically scheduled through DCI format 0_0 or 0_1 or semi-statically operate by the configured grant. When at least one SRS resource is configured within the SRS resource set having the value of usage configured as ‘nonCodebook’ within SRS-ResourceSet which is higher-layer signaling, the UE may receive scheduling of non-codebook-based PUSCH transmission through DCI format 0_1.

For the SRS resource set having the value of usage configured as ‘nonCodebook’ within SRS-ResourceSet which is higher-layer signaling, the UE may receive a configuration of one connected non-zero power CSI-RS (NZP CSI-RS). The UE may calculate a precoder for the SRS transmission through measurement for the NZP CSI-RS resource connected to the SRS resource set. When a difference between the last reception symbol of the aperiodic NZP CSI-RS resource connected to the SRS resource set and the first symbol of aperiodic SRS transmission in the UE is smaller than 42 symbols, the UE may not expect an update of information on the precoder for the SRS transmission.

When the value of resourceType within SRS-ResourceSet which is higher-layer signaling is configured as ‘aperiodic’, the connected NZP CSI-RS may be indicated by an SRS request which is a field within DCI format 0_1 or 1_1. When the connected NZP CSI-RS resource is an aperiodic NZP CSI-RS resource, the case in which the value of the SRS request field within DCI format 0_1 or 1_1 is not ‘00’ indicates the existence of the connected NZP CSI-RS. In this case, the corresponding DCI should not indicate cross carrier or cross BWP scheduling. Further, when the value of the SRS request indicates the existence of the NZP CSI-RS, the corresponding NZP CSI-RS may be located in a slot in which the PDCCH including the SRS request field is transmitted. Here, TCI states configured in the scheduled subcarrier may not be configured as QCL-TypeD.

When the periodic or semi-persistent SRS resource set is configured, the connected NZP CSI-RS may be indicated through an associatedCSI-RS within SRS-ResourceSet which is higher-layer signaling. For non-codebook-based transmission, the UE may not expect configurations of both spatialRelationInfo which is higher layer signaling for the SRS resource and associatedCSI-RS within SRS-ResourceSet which is higher-layer signaling.

When the UE receives a configuration of multiple SRS resources, the UE may determine a precoder and a transmission rank to be applied to the PUSCH transmission based on an SRI indicated by the base station. At this time, the SRI may be indicated through an SRS resource indicator field in the DCI or may be configured through srs-ResourceIndicator which is higher-layer signaling. Like the codebook-based PUSCH transmission, when the UE receives the SRI through the DCI, the SRS resource indicated by the corresponding SRI may refer to the SRS resource corresponding to the SRI among SRS resources transmitted earlier than the PDCCH including the corresponding SRI. The UE may use one or multiple SRS resources for the SRS transmission. The maximum number of SRS resources which may be simultaneously transmitted in the same symbol within one SRS resource set and the maximum number of SRS resources may be determined by the UE capability which the UE reports to the base station. Here, SRS resources which the UE simultaneously transmits may occupy the same RB. The UE may configure one SRS port for each SRS resource. The number of SRS resource sets having the value of usage configured as ‘nonCodebook’ within SRS-ResourceSet which is higher-layer signaling may be configured as only one, and the maximum number of SRS resources for non-codebook-based PUSCH transmission may be configured as 4.

The base station may transmit one NZP-CSI-RS connected to the SRS resource set to the UE. The UE may perform calculation of a precoder to be used for one or multiple SRS resource transmissions within the SRS resource set connected to the NZP-CSI-RS, based on the measurement result when the NZP-CSI-RS is received. When transmitting one or multiple SRS resources within the SRS resource set having usage configured as ‘nonCodebook’ to the base station, the UE may apply the calculated precoder. The base station may select one or multiple SRS resources from among the one or plurality of received SRS resources. At this time, in non-codebook-based PUSCH transmission, the SRI may indicate an index which may express one SRS resource or a combination of multiple SRS resources. The SRI may be included in the DCI. The number of SRS resources indicated by the SRI transmitted by the base station may be the number of transmission layers of the PUSCH. The UE may transmit the PUSCH by applying the precoder applied to SRS resources to each layer.

### PUSCH: Preparation Procedure Time

Hereinafter, a PUSCH preparation procedure time is described. When the base station schedules to transmit a PUSCH to the UE by using DCI format 0_0, 0_1, or 0_2, the UE may need a PUSCH preparation procedure time for transmitting a PUSCH by applying a transmission method (a transmission precoding method of SRS resources, the number of transmission layers, and a spatial domain transmission filter) indicated through the DCI. In NR, the PUSCH preparation procedure time considering the same is defined. The PUSCH preparation procedure time of the UE may follow Equation 2 below.

$$Equation 2$$

$${T}_{proc , 2} = max ( ( {N}_{2} + {d}_{2 , 1} + {d}_{2} ) ( 2048 + 144 \text{?} {2}^{- μ} \text{?} + \text{?} + {T}_{switch} , \text{?} )$$

$$\text{?} \text{indicates text missing or illegible when filed}$$

In T_{proc,2} described in Equation 2, each parameter may have the following meaning.

N2: may denote the number of symbols determined according to UE processing capability 1 or 2 based on a UE capability 1 or 2 and numerology u. N1 may have a value in Table 29 when UE processing capability 1 is reported according to a UE capability report. N1 may have a value in Table 30 when UE processing capability 2 is reported and information indicating that UE processing capability 2 may be used is configured through higher-layer signaling.

TABLE 29

| | PUSCH preparation time N₂ |
|---|---|
| μ | [symbols] |
| 0 | 10 |
| 1 | 12 |
| 2 | 23 |
| 3 | 36 |

TABLE 30

| | PUSCH preparation time N₂ |
|---|---|
| μ | [symbols] |
| 0 | 5 |
| 1 | 5.5 |
| 2 | 11 for frquency range 1 |

d_{2,1}: this may denote the number of symbols determined as 0 when all resource elements of a first OFDM symbol in the PUSCH transmission are configured to include only DM-RSs and, otherwise, determined as 1.
κ: 64
μ: this may follow a value among μ_{DL} or μ_{UL} making T_{proc,2} larger. μ_{DL} may refer to downlink numerology for transmitting a PDCCH including DCI scheduling a PUSCH, and μ_{UL} may refer to uplink numerology for transmitting a PUSCH.
Tc: this may have a value of 1/(Δfₘₐₓ·N_{f}), and may be Δfₘₐₓ=480·10³ Hz and N_{f}=4096.
d_{2,2}: this may follow a BWP switching time when the DCI scheduling a PUSCH indicates BWP switching and, otherwise, has a value of 0.
d₂: a value of d₂ of a PUSCH having a high priority index may be used when OFDM symbols of the PUCCH, the PUSCH having the high priority index, and a PUCCH having a low priority index overlap in the time. Otherwise, d₂ may have a value of 0.
Tₑₓₜ: the UE may calculate Tₑₓₜ and apply the same to a PUSCH processing time when the UE uses a shared spectrum channel access scheme. Otherwise, it is assumed that Tₑₓₜ is 0.
T_{switch}: it is assumed that T_{switch} is a switching interval time when an uplink switching interval is triggered. Otherwise, it is assumed that T_{switch} is 0.

In consideration of time axis resource mapping information of the PUSCH scheduled through the DCI and an effect of uplink-downlink timing advance (TA), the base station and the UE may determine that the PUSCH preparation procedure time is not sufficient when a first symbol of the PUSCH starts earlier than a first uplink symbol at which the CP starts after T_{proc,2} from a last symbol of the PDCCH including the DCI scheduling the PUSCH. Otherwise, the base station and the UE may determine that the PUSCH preparation procedure time is sufficient. The UE may transmit the PUSCH only when the PUSCH preparation procedure time is sufficient, and may ignore the DCI scheduling the PUSCH when the PUSCH preparation procedure time is not sufficient.

### PUSCH: Related to Repeated Transmission

Hereinafter, repeated transmission of an uplink data channel in a 5G system is described in detail. In the 5G system, two types (e.g., a PUSCH repeated transmission type A and a PUSCH repeated transmission type B) are supported as the repeated transmission method of the uplink data channel. The UE may receive a configuration of one of PUSCH repeated transmission type A or B through higher-layer signaling.

### PUSCH Repeated Transmission Type A

As described above, the symbol length of the uplink data channel and the location of a start symbol may be determined through the time domain resource allocation method within one slot. The base station may notify the UE of the number of repeated transmissions through higher-layer signaling (e.g., RRC signaling) or L1 signaling (e.g., DCI).
The UE may repeatedly transmit uplink data channels having the configured same uplink data channel length and start symbol in successive slots based on the number of repeated transmissions received from the base station. Here, when slots which the base station configures in the UE in the downlink or one or more symbols among the symbols of uplink data channels configured in the UE are configured as the downlink, the UE may omit uplink data channel transmission but may count the number of repeated transmissions of the uplink data channel.

### PUSCH Repeated Transmission Type B

As described above, the symbol length of the uplink data channel and the location of a start symbol may be determined through the time domain resource allocation method within one slot. The base station may notify the UE of numberofrepetitions, which is the number of repeated transmissions, through higher-layer signaling (e.g., RRC signaling) or L1 signaling (e.g., DCI).
First, nominal repetition of the uplink data channel may be determined based on the start symbol and the length of the configured uplink data channel. A slot in which nth nominal repetition starts may be given by

$$\text{?} + ⌊ \frac{s + \text{?}}{{N}_{symb}^{slot}} ⌋$$

$$\text{?} \text{indicates text missing or illegible when filed}$$

and a symbol starting in the slot may be given by mod(S+n·L, N_{symb}^{slot}). A slot in which nth nominal repetition ends may be given by

$$\text{?} + ⌊ \frac{\text{?} + ( \text{?} + 1 ) \text{?} L - 1}{{N}_{symb}^{slot}} ⌋ ,$$

$$\text{?} \text{indicates text missing or illegible when filed}$$

and a symbol ending in the slot may be given by mod(S+(n+1)·L−1, N_{symb}^{slot}). Here, n may have a value (n=0, . . . , numberofrepetitions−1). S may indicate a start symbol of a configured uplink data channel. L may indicate the symbol length of the configured uplink data channel. Kₛ may indicate a slot in which the PUSCH transmission starts. N_{symb}^{slot} may indicate the number of symbols per slot.
The UE may determine an invalid symbol for the PUSCH repeated transmission type B. A symbol configured as the downlink by tdd-UL-DL-ConfigurationCommon or tdd-UL-DL-ConfigurationDedicated may be determined as an invalid symbol for the PUSCH repeated transmission type B. In addition, the invalid symbol may be configured in a higher-layer parameter (e.g., InvalidSymbolPattern). The higher-layer parameter (e.g., InvalidSymbolPattern) may provide a symbol level bit map over one or two slots to configure the invalid symbol. In the bitmap, 1 may indicate an invalid symbol. In addition, a period and a pattern of the bitmap may be configured through a higher-layer parameter (e.g., periodicityAndPattern). When the higher-layer parameter (e.g., InvalidSymbolPattern) is configured, the UE may apply an invalid symbol pattern if an InvalidSymbolPatternIndicator-ForDCIFormat0_1 or InvalidSymbolPatternIndicator-ForDCIFormat0_2 parameter indicates 1, or the UE may not apply the invalid symbol pattern if the InvalidSymbolPatternIndicator-ForDCIFormat0_1 or InvalidSymbolPatternIndicator-ForDCIFormat0_2 parameter indicates 0. When the higher-layer parameters (e.g., InvalidSymbolPattern) is configured and the InvalidSymbolPatternIndicator-ForDCIFormat0_1 or InvalidSymbolPatternIndicator-ForDCIFormat0_2 is not configured, the UE may apply the invalid symbol pattern.

After the invalid symbol may be determined, for each nominal repetition, the UE may consider symbols except for the invalid symbol as valid symbols. When one or more valid symbols are included in each nominal repetition, the nominal repetition may include one or more actual repetitions. Each actual repetition includes successive sets of valid symbols which may be used for the PUSCH repeated transmissions type B in one slot.

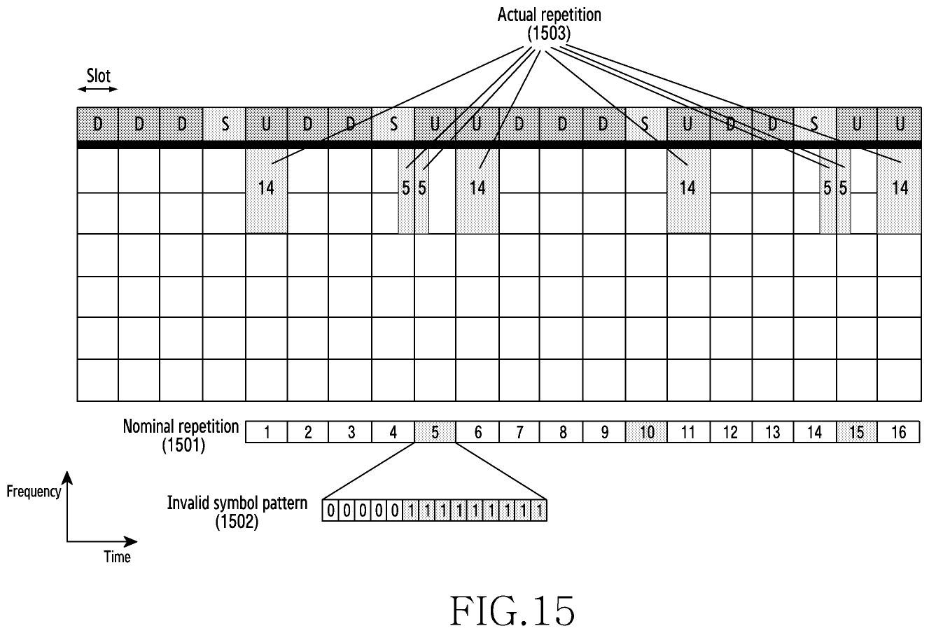

FIG. 15 illustrates an example of the PUSCH repeated transmission type B in a wireless communication system according to an embodiment of the disclosure.

Referring to FIG. 15, the UE may receive a configuration of the start symbol S of the uplink data channel as 0, the length L of the uplink data channel as 14, and the number of repeated transmissions as 16. In this case, nominal repetition (as indicated by reference numeral 1501) appears in 16 successive slots. Thereafter, the UE may determine a symbol configured as a downlink system in each nominal repetition 1501 as an invalid symbol. Further, the UE may determine symbols configured as 1 in an invalid symbol pattern 1502 as invalid symbols. When valid symbols other than the invalid symbol in each nominal repetition includes one or more successive symbols in one slot, the valid symbols are configured as an actual repetition (as indicated by reference number 1503) and transmitted.

Further, for PUSCH repeated transmission, the following additional methods may be defined for UL grant-based PUSCH transmission and configured grant-based PUSCH transmission beyond the slot boundary in NR Release 16.
Method 1 (mini-slot level repetition): two or more PUSCH repeated transmissions may be scheduled within one slot or beyond the boundary of successive slots through one UL grant. Further, for method 1, time domain resource allocation information in the DCI may indicate resources of first repeated transmission. In addition, time domain resource information of the remaining repeated transmissions may be determined according to the time domain resource information of first repeated transmission and an uplink or downlink direction determined for each symbol of each slot. Each repeated transmission may occupy successive symbols.
Method 2 (multi-segment transmission): two or more PUSCH repeated transmissions may be scheduled in successive slots through one UL grant. At this time, one transmission is indicated for each slot, and start points or repetition lengths may differ depending on each transmission. Further, in method 2, the time domain resource allocation information in the DCI may indicate start points and repetition lengths of all repeated transmissions. In addition, when repeated transmission is performed within a single slot through method 2, if there are sets of successive uplink symbols within the corresponding slot, each repeated transmission may be performed for each uplink symbol set. When there is only one set of successive uplink symbols within the corresponding slot, one PUSCH repeated transmission may be performed according to the method of NR Release 15.
Method 3: two or more PUSCH repeated transmissions may be scheduled in successive slots through two or more UL grants. At this time, one transmission is indicated for each slot, and an nth UL grant may be received before the PUSCH transmission scheduled by an (n−1)th UL grant ends.
Method 4: one or multiple PUSCH repeated transmissions may be supported within a single slot through one UL grant or one configured grant. Alternatively, two or more PUSCH repeated transmissions may be supported over boundaries of successive slots. The number of repetitions which the base station indicates to the UE is only a nominal value, and the number of PUSCH repeated transmissions which the UE actually performs may be larger than the nominal number of repetitions. Time domain resource allocation information in the DCI or the configured grant may refer to resources of the first repeated transmission indicated by the base station. Time domain resource information of the remaining repeated transmissions may be determined with reference to resource information of the first repeated transmission and uplink or downlink directions of symbols. When the time domain resource information of repeated transmission indicated by the base station is over the slot boundary or includes an uplink/downlink switching point, the corresponding repeated transmission may be divided into multiple repeated transmissions. Here, one repeated transmission may be included for each uplink period in one slot.

### PUSCH: Frequency Hopping Process

Hereinafter, frequency hopping of an uplink data channel (PUSCH) in a 5G system is described in detail.

In 5G, two methods may be supported for each PUSCH repeated transmission type as the frequency hopping method of the uplink data channel. First, intra-slot frequency hopping and inter-slot frequency hopping may be supported in a PUSCH repeated transmission type A. Inter-repetition frequency hopping and inter-slot frequency hopping may be supported in a PUSCH repeated transmission type B. However, in accordance with various embodiments of the disclosure, examples of frequency hopping support may not be limited to the examples described above.

The intra-slot frequency hopping method supported in the PUSCH repeated transmission type A may include a method of changing allocated resources in the frequency domain by a configured frequency offset in two hops within one slot to perform transmission. In intra-slot frequency hopping, a start RB of each hop may be indicated through Equation 3.

$$R \text{?} = \{ \begin{matrix}R \text{?} & \text{?} = 0 \\ ( R \text{?} + R \text{?} ) mod \text{?} & \text{?} = 1\end{matrix} \qquad Equation 3$$

$$\text{?} \text{indicates text missing or illegible when filed}$$

In Equation 3, i=0 and i=1 may denote a first hop and a second hop, and RBₛₜₐᵣₜ may denote a start RB in an UL BWP, and may be calculated by a frequency resource allocation method. RB_{offset} may denote a frequency offset between two hops through a higher-layer parameter. The number of symbols of the first hop may be indicated as └N_{symb}^{PUCCHs}/2┘ and the number of symbols of the second hop may be indicated as N_{symb}^{PUSCHs}−└N_{symb}^{PUSCHs}/2┘. N_{symb}^{PUSCHs} may denote the length of the PUSCH transmission within one slot and indicated by the number of OFDM symbols.

The inter-slot frequency hopping method supported in the PUSCH repeated transmission types A and B may include a method by which the UE changes allocated resources in the frequency domain by a configured frequency offset in every slot to perform transmission. In inter-slot frequency hopping, a start RB during nₛ^{μ} slots may be indicated through Equation 4.

$${RB}_{start} ( \text{?} ) = \{ \begin{matrix}{RB}_{start} & \text{?} mod 2 = 0 \\ ( {RB}_{start} + {RB}_{offset} ) mod \text{?} & \text{?} mod 2 = 1\end{matrix} \qquad Equation 4$$

$$\text{?} \text{indicates text missing or illegible when filed}$$

In Equation 4, may denote a current slot number in multi-slot PUSCH transmission, and RBₛₜₐᵣₜ may denote a start RB in an UP BWP, and may be calculated by a frequency resource allocation method. RB_{offset} may denote a frequency offset between two hops through a higher-layer parameter.

The inter-repetition frequency hopping method supported in the PUSCH repeated transmission type B may include a method of moving allocated resources in the frequency domain by a configured frequency offset to perform transmission for one or multiple actual repetitions within each nominal repetition. For one or multiple actual repetitions within an nth nominal repetition, RBₛₜₐᵣₜ(n) which is an index of the start RB in the frequency domain may follow Equation 5 below.

$$R \text{?} ( n ) = \{ \begin{matrix}R \text{?} & \text{?} 2 = 0 \\ ( R \text{?} + R \text{?} ) mod \text{?} & \text{?} 2 = 1\end{matrix} \qquad Equation 5$$

$$\text{?} \text{indicates text missing or illegible when filed}$$

In Equation 5, n may denote an index of nominal repetition. RB_{offset} may denote an RB offset between two hops through a higher-layer parameter.

### [Regarding PUSCH Transmission Power]

Hereinafter, a method of determining the transmission power of an uplink data channel in a 5G system will be described in detail.

In the 5G system, the transmission power of the uplink data channel may be determined through Equation 6 below.

$$\text{?} = min \{ \begin{matrix}\text{?} \\ \text{?}\end{matrix} \} \qquad Equation 6$$

$$[ \text{?} ]$$

$$\text{?} \text{indicates text missing or illegible when filed}$$

In Equation 6, j may denote a grant type of PUSCH. Specifically, j=0 may denote a PUSCH grant for a random access response, and j=1 may denote a configured grant. j∈{2, 3, . . . . J−1} may denote dynamic grant. P_{CMAX,f,c}(i) may denote the maximum output power configured in the UE with respect to carrier f of a support cell c for the PUSCH transmission occasion i. P_{O_PUSCH,b,f,c}(j) may be a parameter configured by the sum of P_{O_NOMINAL_PUSCH,f,c}(j), which is configured via a higher layer parameter, and, P_{O_UE_PUSCH,b,f,c}(j), which may be determined via a higher layer configuration and SRI (in a case of dynamic grant PUSCH). M_{RB,b,f,c}^{PUSCH}(i) may denote a bandwidth for resource allocation expressed by the number of resource blocks for PUSCH transmission occasion i. Δ_{TF,b,f,c}(i) may denote a value determined according to the type of information transmitted through a PUSCH and a modulation coding scheme (MCS) (e.g., whether or not UL-SCH is included or CSI is included, etc.). α_{b,f,c}(j) is a value for compensating for pathloss and may denote a value that may be determined via the higher layer configuration and SRS resource indicator (SRI) (in a case of dynamic grant PUSCH). PL_{b,f,c}(q_{d}) may denote a downlink path loss estimation value, which is estimated by the UE through a reference signal having the reference signal index qd. The reference signal index qd may be determined by the UE through higher layer configuration and SRI (in a case of dynamic grant PUSCH or ConfiguredGrantConfig-based configured grant PUSCH (type 2 configured grant PUSCH) that does not include higher layer configuration rrc-ConfiguredUplinkGrant) or through higher layer configuration. f_{b,f,c}(i,l) is a closed loop power adjustment value and may be supported by the accumulation method and absolute method. When the higher layer parameter tpc-Accumulation is not configured in the UE, the closed-loop power adjustment value may be determined by the accumulation method. f_{b,f,c} (i,l) may be determined by

$$\text{?} ( i - \text{?} , l ) + \text{?} ( m , l ) ,$$

$$\text{?} \text{indicates text missing or illegible when filed}$$

obtained by adding the closed-loop power adjustment value for the previous PUSCH transmission occasion (i−i0) and the TPC command values for closed-loop index 1 received through the DCI between the time before the KPUSCH(i−i0)−1 symbol from the start of transmission of PUSCH transmission occasion (i−i0) and the time before the KPUSCH (i) symbol from the start of transmission of PUSCH transmission occasion i. When the higher layer parameter tpc-Accumulation is configured in the UE, f_{b,f,c}(i,l) may be determined as the TPC command value δ_{PUSCH,b,f,c}(i,l) for the closed loop index 1 received through the DCI. The closed loop index 1 may be configured to be a value of 0 or 1 when the higher layer parameter twoPUSCH-PC-AdjustementStates is configured in the UE, and the value may be determined through the higher layer configuration and SRI (in a case of dynamic grant PUSCH). The mapping relationship between the TPC command field and the TPC value δ_{PUSCH,b,f,c} in the DCI according to the accumulation method and the absolute method may be defined as shown in Table 31 below.

TABLE 31

| TPC command field | Accumulated δ [symbol] [dB] | Absolute δ [symbol] [dB] |
|---|---|---|
| 0 | −1 | −4 |
| 1 | 0 | −1 |
| 2 | 1 | 1 |
| 3 | 3 | 4 |

[symbol]

indicates data missing or illegible when filed

### Regarding UL PTRS

A UE may configure phaseTrackingRS, which is a higher layer parameter for a PTRS, on a higher layer parameter DMRS-UplinkConfig. When a PUSCH is transmitted to a base station, the UE may transmit the phase tracking reference signal (PTRS) for tracking a phase regarding an uplink channel. A procedure by which the UE transmits a UL PTRS may be determined based on whether transform precoding is performed during PUSCH transmission. When the transform precoding is performed and a transformPrecoderEnabled field is configured in a higher layer parameter PTRS-UplinkConfig, sampleDensity in the transformPrecoderEnabled field may indicate a sample density threshold indicated by N_{RB0} to N_{RB4} of Table 32. When transform precoding is performed and a transformPrecoderEnabled field is configured in a higher layer parameter PTRS-UplinkConfig, the UE may determine a PT-RS group pattern for a resource N_{RB} scheduled according to Table 32. In addition, when a transform precoder is applied to the PUSCH transmission, the number of bits in a PTRS-DMRS association field for indicating an association between PTRS and DMRS is 0 in DCI format 0_1 or 0_2.

TABLE 32

| Scheduled | Number of PT- | Number of samples |
|---|---|---|
| bandwidth | RS groups | per PT-RS group |
| [symbol] | 2 | 2 |
| [symbol] | 2 | 4 |
| [symbol] | 4 | 2 |
| [symbol] | 4 | 4 |
| [symbol] | 8 | 4 |

[symbol]

indicates data missing or illegible when filed

When the transform precoding is not applied to the PUSCH transmission and phaseTrackingRS that is a higher layer parameter is configured, the UE may indicate N_{RB0} to N_{RB1} as frequencyDensity in a transformPrecoderDisabled field in the higher layer parameter PTRS-UplinkConfig, and may indicate ptrs-MCS₁ to ptrs-MCS₃ as timeDensity. The UE may determine PT-RS density of a time domain (L_{PT-RS}) and PT-RS density of a frequency domain (K_{PT-RS}), as described in Tables 33-1 and 33-2, respectively, according to MCS (l_{MCS}) and RB (N_{RB}) of the scheduled PUSCH. In Table 33-1, although ptrs-MCS₄ is not explicitly stated as a higher layer parameter, the base station and the UE may aware that ptrs-MCS₄ is 29 or 28 according to a configured MCS table.

TABLE 33-1

| Scheduled MCS | Time Density (L_{PT-RS}) |
|---|---|
| I_{MCS} < ptrs-MCS₁ | PT-RS is not present |
| ptrs-MCS [symbol] ≤ I_{MCS} < ptrs-MCS₂ | 4 |
| ptrs-MCS [symbol] ≤ I_{MCS} < ptrs-MCS₃ | 2 |
| ptrs-MCS [symbol] ≤ I_{MCS} < ptrs-MCS₄ | 1 |

[symbol]

indicates data missing or illegible when filed

TABLE 33-2

| Scheduled bandwidth | Frequnecy density (K_{PT-RS}) |
|---|---|
| N [symbol] < N [symbol] | PT-RS is not present |
| N [symbol] ≤ NRB < N [symbol] | 2 |
| N [symbol] ≤ NRB | 4 |

[symbol]

indicates data missing or illegible when filed

When the transform precoder is not applied to the PUSCH transmission and PTRS-UplinkConfig is configured, the base station may provide, to the UE, an indication of the ‘PTRS-DMRS association’ field of 2 bits so as to indicate the association between the PTRS and DMRS in the DCI format 0_1 or 0_2. The indicated PTRS-DMRS association field of 2 bits may be applied to Table 34-1 or 34-2 below according to the maximum number of ports of PTRS configured by maxNrofPorts in the higher layer parameter PTRS-UplinkConfig. When the maximum number of PTRS ports is 1, the UE may determine the association between the PTRS and DMRS by Table 34-1 and the 2 bits indicated as the PTRS-DMRS association field, and may transmit the PTRS according to the determined association. When the maximum number of PTRS ports is 2, the UE may determine the association between the PTRS and DMRS by Table 34-2 and the 2 bits indicated as the PTRS-DMRS association field, and may transmit the PTRS according to the determined association.

TABLE 34-1

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 34-2

| Value of | | Value of | |
|---|---|---|---|
| MSB | DMRS port | LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

A DMRS port of Tables 34-1 and 34-2 may be determined by a table determined by higher layer parameter configuration and ‘Antenna ports’ field indicated by the same DCI as the DCI indicating PTRS-DMRS association. When the transform precoder is not configured via higher configuration of the PUSCH, dmrs-Type is configured to 1 and maxLength is configured to 2 for the DMRS, and a rank of PUSCH is configured to 2, the UE may determine the DMRS port via a bit indicated by the antenna port fields and a table regarding ‘Antenna port(s)’ as Table 35. When a non-codebook-based PUSCH is supported, the UE may determine a value of rank by referring to the SRI field indicated by the same DCI as the DCI including the ‘Antenna ports’ field (i.e., when the SRI field does not exist, the UE may consider rank to be 1). When rank supports a codebook-based PUSCH, the UE may determine a value of rank by referring to the TPMI region indicated by the same DCI as the DCI including the ‘Antenna ports’ field. Table 35 is an example of the antenna port table being referred to during the PUSCH configuration described above, but is not limited to this, and when the PUSCH has been configured by another parameter, the DMRS port may be determined according to a bit of the ‘Antenna ports’ field indicated by the DCI and the ‘Antenna port’ table according to the configuration.

TABLE 35

| | Number of DMRS | | Number of |
|---|---|---|---|
| | CDM group(s) | DMRS | front-load |
| Value | without data | port(s) | symbols |
| 0 | 1 | 0.1 | 1 |
| 1 | 2 | 0.1 | 1 |
| 2 | 2 | 2.3 | 1 |
| 3 | 2 | 0.2 | 1 |
| 4 | 2 | 0.1 | 2 |
| 5 | 2 | 2.0 | 2 |
| 6 | 2 | 4.5 | 2 |
| 7 | 2 | 6.7 | 2 |
| 8 | 2 | 0.4 | 2 |
| 9 | 2 | 2.6 | 2 |
| 10-15 | Reserved | Reserved | Reserved |

The 1^{st} scheduled DMRS to 4th scheduled DMRS of Table 34-1 may be defined as values sequentially mapping DMRS ports indicated by the ‘antenna port’ table according to the higher layer configuration and the bit of the ‘Antenna ports’ field of DCI. For example, when the bits of the ‘Antenna ports’ field of DCI is 0001 and the DMRS ports are determined by referring to Table 35, the scheduled DMRS ports may have a value of 0 and 1, wherein the DMRS port 0 may be defined as 1^{st} scheduled DMRS and the DMRS port 1 may be defined as 2^{nd} scheduled DMRS. This may be similarly applied to a DMRS port determined by a bit of another ‘Antenna ports’ field and an ‘antenna port’ table according to another higher layer configuration. Among the DMRS ports defined as above, the UE may determine one DMRS port to be associated with a PTRS port by referring to a bit indicated by the PTRS-DMRS association in the DCI, and transmits the PTRS according to the determined DMRS port.

In Table 34-2, a DMRS port sharing a PTRS port 0 and a DMRS port sharing a PTRS port 1 may be defined according to the codebook-based PUSCH transmission or non-codebook-based PUSCH transmission. When the UE transmits the PUSCH based on a partial-coherent or non-coherent codebook, an uplink layer transmitted through PUSCH antenna ports 1000 and 1002 may be associated with the PTRS port 0, and an uplink layer transmitted by PUSCH antenna ports 1001 and 1003 may be associated with the PTRS port 1. More specifically, when layer 3: TPMI=2 is selected for the codebook-based PUSCH transmission, a first layer may be associated with the PTRS port 0 because the first layer is transmitted through the PUSCH antenna ports 1000 and 1002, and a second layer and a third layer may be associated with the PTRS port 1 because the second layer may be transmitted through the PUSCH antenna port 1001 and the third layer may be transmitted through the PUSCH antenna port 1002. The three layers each denote a DMRS port. The DMRS port regarding the first layer may correspond to ‘1^{st} DMRS port which shares PTRS port 0’ in Table 19-2, the DMRS port regarding the second layer may correspond to ‘1^{st} DMRS port which shares PTRS port 1’ in Table 34-2, and the DMRS port regarding the third layer may correspond to ‘2^{nd} DMRS port which shares PTRS port 1’ in Table 34-2. Similarly, the DMRS port associated with the PTRS port 0 and the DMRS port associated with the PTRS port 1 may be determined according to TPMI and the different numbers of layers. When the UE transmits the PUSCH based on a non-codebook, the DMRS port associated with the PTRS port 0 and the DMRS port associated with the PTRS port 1 may be distinguished according to antenna ports and SRI indicated by the DCI. More specifically, the SRS resource included in the SRS resource set in which the usage is ‘nonCodebook’ may be configured whether the SRS is associated with the PTRS port 0 or the PTRS port 1 by a higher layer parameter ptrs-PortIndex. The base station may indicate the SRS resource for non-codebook-based PUSCH transmission by the SRI. Here, ports of indicated SRS resources may be mapped to PUSCH DMRS ports in a one-to-one manner. An association between a PUSCH DMRS port and a PTRS port may be determined according to the higher layer parameter ptrs-PortIndex of the SRS resource mapped to the DMRS port. More specifically, in case that ptrs-PortIndex is configured to be n0, n0, n1, and n1, respectively, for SRS resources 1 to 4 included in the SRS resource set for which the usage is nonCodebook, that the PUSCH is indicated to be transmitted through SRS resources 1, 2, and 4 by SRI, and that DMRS ports 0, 1, and 2 are indicated as antenna port fields, ports of the SRS resources 1, 2, and 4 may be mapped to the DMRS ports 0, 1, and 2, respectively. In addition, the DMRS ports 0 and 1 may be associated with the PTRS port 0 and the DMRS port 2 may be associated with the PTRS port 1, according to ptrs-PortIndex in the SRS resource. Accordingly, in Table 19-2, the DMRS port 0 may correspond to ‘1^{st} DMRS port which shares PTRS port 0’, the DMRS port 1 may correspond to ‘2^{nd} DMRS port which shares PTRS port 0’, and the DMRS port 2 may correspond to ‘1^{st} DMRS port which shares PTRS port 1’. Similarly, the DMRS port associated with the PTRS port 0 and the DMRS port associated with the PTRS port 1 may be determined according to different SRI values and a ptrs-PortIndex configuration method in the SRS resources of different patterns. The UE may determine the association between the DMRS port and the PTRS port as described above for two PTRS ports. The UE may, among multiple DMRS ports associated with each PTRS port, determine the DMRS port to be associated with the PTRS port 0 by referring to MSB of PTRS-DMRS association. The UE may determine the DMRS port to be associated with the PTRS port 1 by referring to LSB, and transmit the PTRS.

### Regarding UE Capability Report

In an LTE and NR system, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to a UE in a connected state so as to request a capability report. The message may include a UE capability request with regard to each radio access technology (RAT) type of the base station. The RAT type-specific request may include supported frequency band combination information and the like. Further, the UE capability enquiry message may include requests for UE capability according to multiple RAT types, through one RRC message container transmitted by the base station. The base station may transfer a UE capability enquiry message including multiple UE capability requests with regard to respective RAT types, to the UE. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

According to an embodiment, upon receiving the UE capability report request from the base station, the UE may configure UE capability according to band information and RAT type requested by the base station. The method in which the UE configures UE capability in an NR system is summarized below:

1. If the UE receives a list regarding LTE and/or NR bands from the base station at a UE capability request, the UE may construct band combinations (BCs) regarding EN-DC and NR standalone (SA). For example, the UE may configure a candidate list of BCs regarding EN-DC and NR SA, based on bands received from the base station at a request through FreqBandList. Bands may have priority in the order described in FreqBandList.

2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.

3. The UE may then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step may be applied in MR-DC as well (that is, LTE bands may also be applied). BCs remaining after the above step may constitute the final “candidate BC list”.

4. The UE may select BCs appropriate for the requested RAT type from the final “candidate BC list” and select BCs to report. In this step, the UE may configure supportedBandCombinationList in a determined order. For example, the UE may configure BCs and UE capability to report according to a preconfigured rat-Type order (nr->eutra-nr->eutra). In addition, the UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be obtained from feature set combinations of containers of UE-NR-Capabilities and UE-MRDC-Capabilities.

5. Further, if the requested RAT type is eutra-nr and has an influence, featureSetCombinations may be included in both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base stations may perform scheduling and transmission/reception management appropriate for the UE, based on the UE capability received from the UE.

### Regarding CA/DC

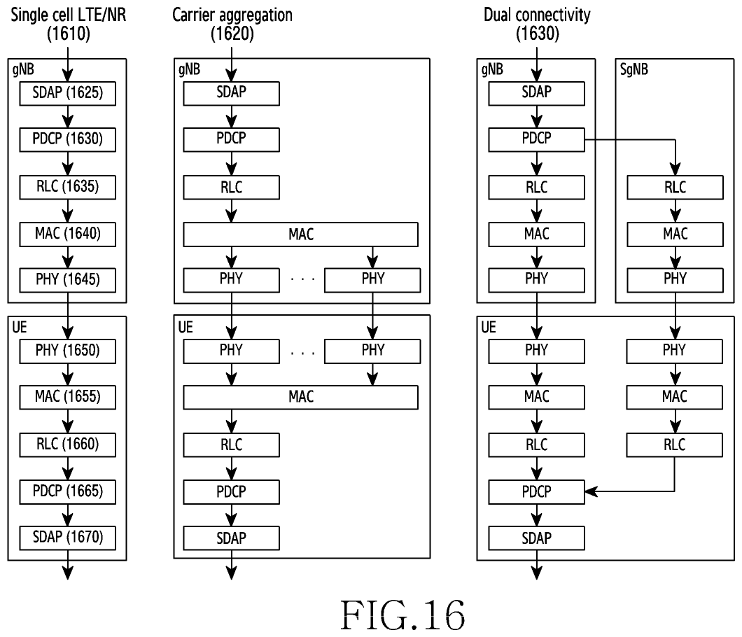

FIG. 16 illustrates a radio protocol structure of a base station and a UE in a situation of a single cell 1610, carrier aggregation 1620, and dual connectivity 1630 according to an embodiment of the disclosure.

Referring to FIG. 16, the radio protocol of a next-generation mobile communication system may include layers of an NR service data adaptation protocol (SDAP) 1625 or 1670, an NR packet data convergence protocol (PDCP) 1630 or 1665, an NR radio link control (RLC) 1635 or 1660, and an NR medium access control (MAC) 1640 or 1655, on each of UE and NR base station sides. However, according to various embodiments of the disclosure, radio protocols are not limited to those example described above and may include a larger or smaller number of layers. In the following description, each layer device may be understood as a function block of the corresponding layer.

The main functions of the NR SDAP 1025 or 1070 may include some of functions below. However, according to various embodiments of the disclosure, those functions may not be limited to the enumerated examples.
Transfer of user plane data
Mapping between a QoS flow and a DRB for both DL and UL
Marking QoS flow ID in both DL and UL packets
Mapping a reflective QoS flow to a data bearer with respect to UL SDAP PDUs (reflective QoS flow to DRB mapping for the UL SDAP PDUs)

With regard to the SDAP layer device, the UE may be configured, through an RRC message, whether to use the header of the SDAP layer device with regard to each PDCP layer device or with regard to each bearer or with regard to each logical channel, or whether to use functions of the SDAP layer device. Further, if an SDAP header is configured, the NAS QOS reflection configuration 1-bit indicator (NAS reflective QoS) of the SDAP header and the AS QoS reflection configuration 1-bit indicator (AS reflective QoS) thereof may be indicated by the base station, so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1630 or 1665 may include some of the following functions: below. However, according to various embodiments of the disclosure, the main functions of the NR PDCP may not be limited to the described functions.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device refers to a function of reordering PDCP PDUs received from a lower layer in an order based on the PDCP sequence number (SN), and may include a function of transferring data to an upper layer in the reordered sequence. The reordering of the NR PDCP device may include a function of instantly transferring data without considering the order, and may include a function of recording PDCP PDUs lost as a result of reordering. The reordering may include a function of reporting the state of the lost PDCP PDUs to the transmitting side, and may include a function of requesting retransmission of the lost PDCP PDUs.

The main functions of the NR RLC 1635 or 1660 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device may refer to a function of successively delivering RLC SDUs received from the lower layer to the upper layer. The in-sequence delivery of the NR RLC device may include a function of, when multiple RLC SDUs split from one RLC SDU have been received, reassembling the received RLC SDUs and transferring the same or rearranging the received RLC SDUs based on the RLC sequence number (SN) or PDCP sequence number (SN). The in-sequence delivery of the NR RLC device may include a function of recording lost RLC PDUs by rearranging the sequence thereof, sending status report on lost RLC PDUs to the transmitter side, or requesting re-transmission of the lost RLC PDUs. The in-sequence delivery function of the NR RLC device may include a function of, if there is a lost RLC SDU, sequentially delivering only RLC SDUs before the lost RLC SDU to the upper layer, and a function of, if a predetermined timer has expired although there is a lost RLC SDU, sequentially delivering all RLC SDUs received before the timer was started to the upper layer. The in-sequence delivery of the NR RLC device may include a function of, although there is a lost RLC SDU, if a predetermined timer has expired, sequentially transferring all the RLC SDUs received up to the current, to an upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device may refer to a function of instantly delivering RLC SDUs received from the lower layer to the upper layer regardless of the order. The out-of-sequence delivery of the NR RLC device may include a function of, when multiple RLC SDUs split from one original RLC SDU have been received, reassembling the received RLC SDUs and transferring the same, or storing RLC SN or PDCP SN of the received RLC SDUs and rearranging the received RLC SDUs, thereby recording the same.

The NR MAC 1640 or 1655 may be connected to multiple NR RLC layer devices configured in one UE, and the main functions of the NR MAC may include some of functions below. However, according to various embodiments of the disclosure, the main functions of the NR MAC may not be limited to the described functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layer 1645 or 1650 may perform operations of channel-coding and modulating upper layer data, thereby obtaining OFDM symbols, and delivering the same through a radio channel. The NR PHY layer may perform operations of demodulating OFDM symbols received through the radio channel, channel-decoding the same, and delivering the same to the upper layer.

The detailed structure of the radio protocol structure may be variously changed according to the carrier (or cell) operating scheme. As an example, assuming that the base station transmits data to the UE based on a single carrier (or cell), the base station and the UE use a protocol structure having a single structure with regard to each layer, such as reference numeral 1610 in FIG. 16. On the other hand, assuming that the base station transmits data to the UE, based on carrier aggregation (CA) which uses multiple carriers in a single TRP, the base station and the UE use a protocol structure which has a single structure up to the RLC, such as reference numeral 1620, but multiplexes the PHY layer through a MAC layer. On the other hand, assuming that the base station transmits data to the UE, based on dual connectivity (DC) using multiple carriers in multiple TRPs, the base station and the UE use a protocol structure which has a single structure up to the RLC, such as 1630, but multiplexes the PHY layer through a MAC layer.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may improve the PDCCH reception reliability of a UE by providing a PDCCH repetitive transmission method through multiple transmission points (TRPs). Specific methods thereof will be described hereinafter through the embodiments below.

The disclosure may be at least one of FDD or TDD systems. However, this is only an example, and the disclosure may be applied to a cross division duplex system in which FDD or TDD systems are combined. As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling”, “PDCP signaling”, or “MAC control element (MAC CE)”.

In the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. In the following description, for the sake of descriptive convenience, non-coherent joint transmission (NC-JT) case may refer to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through multiple embodiments, but they are not independent of each other, and one or more embodiments may be applied simultaneously or in combination.

Various embodiments of the disclosure may require measures to improve the performance of uplinks that have lower performance than that of downlinks in terms of throughput, etc., and to provide equipment for uplink support that is larger than typical mobile terminals (e.g., customer premise equipment (CPE), fixed wireless access (FWA), etc.). Further, to this end, an enhancement to the PUSCH transmission technique may be required to support a larger number of uplink antennas (e.g., a maximum of 8 antennas or more), instead of the maximum of 4 for uplinks introduced by Rel-17. In the following, 8 uplink antennas are described as an example for ease of explanation, but it will be appreciated that the examples of the disclosure apply to a larger number of uplink antennas.

When supporting codebook-based PUSCH using 8 uplink antenna ports, the codebooks of the four antenna ports may be augmented or a new type of codebook may be considered. In addition, depending on the antenna implementation of the UE, the number and combination of antennas through which coherent transmission is possible may be considered.

Furthermore, when the codebook-based PUSCH and non-codebook-based PUSCH support 8 uplink antenna ports and more than four layers, the PTRS-DMRS association method designed to account for the four layers introduced by Rel-17 (e.g., four PUSCH DMRS ports) may need to be augmented. In accordance with various embodiments of the disclosure, methods for configuring a codebook for codebook-based PUSCH support considering 8 uplink antenna ports and a UE operation for the PTRS-DMRS association method when supporting 8 uplink antenna ports are specifically disclosed.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, in actual applications, a TRP, a beam, or a TCI state may be appropriately replaced with one of the above terms.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

In the following description of the disclosure, upper layer signaling may refer to signaling corresponding to at least one signaling among the following signaling, or a combination of one or more thereof. However, according to various embodiments of the disclosure, upper layer signaling may not be limited to the signaling described below.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof. However, according to various embodiments of the disclosure, L1 signaling may not be limited to the signaling described below.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through multiple embodiments, but they are not independent of each other, and one or more embodiments may be applied simultaneously or in combination.

### First Embodiment: Uplink Codebook Configuration Method for Supporting Codebook-Based PUSCH Transmission Through 8 Uplink Transmission Antennas

The first embodiment of the disclosure may include a method of configuring an uplink codebook used by a UE supporting 8 transmission antennas for uplink to transmit an uplink data signal. The 8 transmission antennas for uplink may refer to 8 physical antennas, or refer to a case in which a UE has more (or less) than 8 actual physical antennas but the physical antennas are configured with 8 uplink transmission ports through antenna virtualization. However, various embodiments of the disclosure are not limited to 8 transmission antennas for the uplink, but may include all of cases where a UE may be assumed to have 8 transmission antennas through other antenna configuration methods or the like. Further, the case of having fewer or more transmission antennas than 8 (e.g., six, twelve, sixteen, etc.) may also be included within embodiments of the disclosure.

In NR Releases 15 to 17, a maximum of four uplink antennas may be used for uplink data channel transmission. However, in a future NR release (e.g., NR Release 18), in order to improve uplink transmission that has lower performance than downlink in terms of throughput, etc., uplink data channel transmission techniques using a maximum of 8 uplink antennas may be considered.

When the UE transmits the uplink data channel (PUSCH) to the base station, as described above in the section on PUSCH transmission method, the PUSCH transmission method may be differentiated into “codebook”-based PUSCH transmission and “nonCodebook”-based PUSCH transmission. When the UE performs a ‘codebook’ based PUSCH transmission, the UE may transmit the SRS resource(s), which may be configured by multiple SRS ports (or may be configured by a single SRS port), and the base station may receive the SRS resource(s). Thereafter, the base station may select one of the multiple SRS resources (e.g., when receiving multiple SRS resources) based on the uplink channel information obtained through the received SRS resources to determine an SRI field in the DCI for scheduling the PUSCH.

In addition, based on the determined SRS resource, the base station may select a layer and precoder for the uplink data channel to determine the TPMI region in the DCI that schedules the same PUSCH as that including the SRI field. The codebook up to NR Release 17 has considered the case of a maximum of four uplink antennas. The rows of the precoder indicated by the TPMI may refer to transmission antennas (e.g., in [a b c d]^{T}, where a is a value for a first transmission antenna, b is a value for a second transmission antenna, c is a value for a third transmission antenna, and d is a value for a fourth transmission antenna), and may consist of a maximum of four rows. In accordance with an embodiment, when a maximum of 8 transmission antennas, rather than a maximum of four, are utilized to support the codebook-based uplink data channel (which may also include, for example, an uplink control channel), a new codebook capable of supporting a maximum of 8 transmission antennas as well as a codebook capable of supporting a maximum of four transmission antennas may be required. Hereinafter, in the (1-1)th and (1-2)th embodiments, methods for configuring a codebook considering 8 uplink transmission antennas are described.

### The (1-1)Th Embodiment: A Method of Extending an Uplink Codebook to Enable the Codebook to Support 8 Antennas

According to an embodiment of the disclosure, a method of extending an uplink codebook for supporting codebook-based PUSCH transmissions of Rel-15 to Rel-17 so as to enable the codebook to support a maximum of 8 transmission antennas, beyond a maximum of four transmission antennas is described.

For uplink codebooks up to NR Release 17, a UE capability is reported to a base station to support one of ‘fullCoherent’, ‘partialCoherent’, or ‘nonCoherent’ according to antenna coherency supportable by the UE, and the base station may configure, based on the reported UE capability, the higher layer parameter ‘codebookSubset’ (or ‘codebookSubsetDCI-0-2-r16’) in the UE to indicate a subset of the supported uplink codebook. Here, a value of the higher layer parameter may be configured to be one of ‘fullyAndPartialAndNonCoherent’, where the subset of codebooks is available for full coherent codebooks, ‘partialAndNonCoherent’, where partial coherent or non-coherent codebooks are available, or ‘nonCoherent’, where only non-coherent codebooks are available. The indicated codebook subset may signify that, when full coherent transmission is supported based on four uplink transmission antennas, the corresponding layer of PUSCH is transmitted using all four antennas (e.g., signify that a precoding matrix with four non-zero values is used in the columns of the precoding matrix representing the precoders for each layer, and precoding matrices for Releases 15 to 17 in this disclosure signify precoding matrices defined in 3GPP standard document TS38.211 Clause 6.3.1.5). The indicated codebook subset may signify that the corresponding layer of PUSCH is transmitted using two antennas through which coherent transmission is possible (e.g., signify that a precoding matrix with two non-zero values is used in the columns of the precoding matrix representing the precoders for each layer), when partial coherent transmission is supported. The indicated codebook subset may signify that, when non-coherent transmission is supported, one antenna is utilized (e.g., signify that a precoding matrix with one non-zero value is used in the column of the precoding matrix that represents the precoder for each layer) to support the selection of the antenna port of transmitting the corresponding layer of PUSCH. In this case, as described in Clause 6.4D.4 of 3GPP standard document 38.101-1, the requirements for coherent uplink transmission may be allowed for coherent uplink MIMO if, for different antenna ports, the difference between the relative power and phase error, which are measured at a predetermined slot within a specific time window (e.g., a time window of Table 36) from the most recently transmitted SRS to the same antenna port as the antenna ports, and the values measured by the most recently transmitted SRS (e.g., relative power and phase error) is less than or equal to a value defined in standard document TS 38.101-1, as shown in Table 36.

TABLE 36

| Difference of relative | Difference of relative | Time |
|---|---|---|
| phase error | power error | window |
| 40 degrees | 4 dB | 20 msec |

According to an embodiment, when the difference of the power and phase error between antenna ports within a specific time window has a value within an allowance (e.g., when the power and phase error difference characteristics between antenna ports are maintained) when compared with the value of the power and phase error between the ports at the time of transmission of the SRS, the corresponding antenna port may be considered to support coherent uplink transmission. Supporting full coherent uplink transmission by the UE for four transmission antennas may signify that coherent transmissions through four transmission antennas are all possible. Supporting partial coherent uplink transmission by the UE for four transmission antennas may signify that coherent transmission is possible for two antenna combinations configured by two transmission antennas, but support for coherent transmission cannot be guaranteed for two antenna ports that are not an antenna combination through which coherent transmission is possible (e.g., instead of signifying that coherent transmission is impossible, this signifies that requirements for coherent uplink transmission within a specific time window are unable to be guaranteed). In case of supporting codebook-based PUSCH in consideration of whether coherent transmission is supported between antenna ports, the UE may support a subset of the full codebook. Here, the full codebook may be defined as a combination of precoders considering characteristics of full, partial, and non-coherent transmission.

According to an embodiment of the disclosure, when the maximum number of uplink transmission antennas is increased from 4 to 8, a codebook for supporting 8 antenna ports may be defined. According to an embodiment, in NR Releases 15 to 17, a codebook for uplink transmission may be defined based on antenna coherency that a UE is able to support.

When a UE is capable of performing full coherent transmission through 8 uplink transmission antennas, an uplink codebook configured by an 8×1 vector may be defined as shown in Equation 7. However, in accordance with various embodiments of the disclosure, the 8×1 vector described herein are exemplary and not limiting, and an uplink codebook configured by fewer or more vectors (e.g., 6×1 vectors, 12×1 vectors, 16×1 vectors) may be defined based on the number of antennas. Further, in accordance with various embodiments of the disclosure, while the parameters, configurations, etc. described below are described based on an 8×1 vector, corresponding parameters, configurations, etc. may be applied based on the number of antennas implemented and vectors corresponding thereto.

$${[ \text{?} ]}^{T} \qquad Equation 7$$

$$\text{?} \text{indicates text missing or illegible when filed}$$

Referring to Equation 7, each e^{j·3π·θ}^{₁} has a value other than zero, and θ₁ may have a value that prevents 8 elements of the corresponding vector from being zero. For example, e^{j·2π·θ}^{₁} may have a value of one of 1, −1, j, or −j.

According to an embodiment, when one layer is supported by 8 transmission antennas, the base station may select one of precoding matrix candidates configured by one 8×1 vector. The base station may provide an indication of a precoding matrix to the UE through a TPMI included in DCI for scheduling the codebook-based PUSCH. Signaling transmitted by the base station to indicate the precoding matrix to the UE is not limited to the above example, and may include any signaling (e.g., higher layer parameter configuration for CG PUSCH support, etc.) to indicate a precoding matrix. According to an embodiment, when two or more layers are supported by 8 transmission antennas, the base station may select one of 8×l precoding matrix candidates configured by l number of 8×1 vectors, wherein l indicates the number of the corresponding layers. The base station may provide an indication of a corresponding precoding matrix to a UE through a TPMI included in DCI for scheduling a codebook-based PUSCH. Signaling transmitted by the base station to indicate the precoding matrix to the UE is not limited to the above example, and may include any signaling (e.g., higher layer parameter configuration for CG PUSCH support, etc.) to indicate the precoding matrix. The l number of 8×1 vectors corresponding to each column of the 8×l precoding matrix may be designed to have orthogonal characteristics to each other. The number of supported layers, l, may be greater than 4 (e.g., a maximum to 8 layers) as well as 4, which has been supported until NR Release 17. In order to support the layers greater than 4, the base station may identify the capability that the UE may support layers greater than 4 by using the capability report of the UE. The base station may support uplink transmission using layers greater than 4 based on higher layer parameter configurations (e.g., maxRank configuration of higher layer parameter PUSCH-Config). A UE capable of full coherent transmission may also support a precoding matrix for partial coherent transmission or a precoding matrix for non-coherent transmission, which will be described later.

In case that the UE may support only non-coherent transmission through 8 uplink transmission antennas, an uplink codebook configured by 8×1 vectors may be defined as shown in Equation 8 below.

$${[ \begin{matrix}a & b & c & d & e & f & g & h\end{matrix} ]}^{T} \qquad Equation 8$$

Referring to Equation 8, only one of the values a, b, c, d, e, f, g, and h may be 1, and all other values should be configured by 0.

In both cases in which the UE supports only 1 layer and supports more than 2 layers through 8 transmission antennas, the base station may support the UE by using the precoding matrix configured by 8×1 vectors defined in Equation 7, which is the same as for the full coherent described above (e.g., in case of supporting 1 layer), or by using an 8×l precoding matrix configured by the l number of 8×1 vectors defined in Equation 7 (e.g., in case of supporting l layers). A UE capable of supporting only non-coherent may not be supported by the precoding matrix for full coherent transmission described above and the precoding matrix for partial coherent transmission described later.

In case that the UE may support partial coherent transmission through 8 uplink transmission antennas, an uplink codebook configured by 8×1 vectors may be defined in consideration of the following situations.

[Situation 1] Case in which a UE may support coherent transmission between two antenna ports: Situation 1 corresponds to a case in which the UE may support coherent transmission for only a combination of two antenna ports among 8 antenna ports. For example, among antenna ports 0 to 7, coherent transmission through antenna ports {0, 4} is possible, and similarly, coherent transmission through antenna port combinations of {1,5}, {2, 6}, and {3, 7} is possible These combinations are only an exemplary and are not limited to the combinations described above, and any combination of two antenna ports, such as {0, 1}, {2, 3}, {4, 5}, {6, 7}, etc. through which coherent transmission is possible, among 8 antenna ports may correspond to situation 1. In the disclosure, for convenience of explanation, antenna ports {0, 4}, {1,5}, {2, 6}, and {3, 7} are assumed to be combinations through which coherent transmission is possible (signify that various embodiments of the disclosure are not limited to the described combination only). Designing the UE to enable coherent transmission through a combination of two antenna ports among 8 antenna ports may be supported with a complexity similar to that of the implementation for supporting partial coherent transmission configured by a total of four antenna ports. According to an embodiment of the disclosure, the coherent antenna assumption for PUSCH transmission may be implemented similarly to that described above, although the number of antenna port combinations capable of full partial coherent transmission may increase, thereby increasing the overall design complexity. When coherent transmission is possible for a combination of antenna ports, an uplink codebook configured by 8×1 vectors may be defined as shown in Equation 9 below.

$$[ \begin{matrix}\text{?} & {\begin{matrix}0 & 0 & 0 & \text{?} & 0 & 0 & 0\end{matrix} ]}^{T} ,\end{matrix} [ \begin{matrix}0 & {\begin{matrix}\text{?} & 0 & 0 & 0 & \text{?} & 0 & 0\end{matrix} ]}^{T} ,\end{matrix} \qquad Equation 9$$

$${[ \begin{matrix}0 & 0 & \text{?} & 0 & 0 & 0 & \text{?} & 0\end{matrix} ]}^{T} , {[ \begin{matrix}0 & 0 & 0 & \text{?} & 0 & 0 & 0 & \text{?}\end{matrix} ]}^{T} ,$$

$$\text{?} \text{indicates text missing or illegible when filed}$$

Referring to Equation 9, each e^{j·2π·θ}^{_{i,k}} has a value other than zero, and θ_{i,k} may be a value that prevents 8 elements of the corresponding vector from being zero. For example, e^{j·2π·θ}^{_{i,k}} may have a value of one of 1, −1, j, or −j.

In both cases where the UE supports only 1 layer or more than 2 layers through 8 transmission antennas, the base station may support the UE by using the precoding matrix configured by 8×1 vectors defined in Equation 7, which is the same as for the full coherent described above (e.g., in case of supporting 1 layer), or using an 8×l precoding matrix configured by the l number of 8×1 vectors defined in Equation 7 (e.g., in case of supporting l layers).

A UE capable of partial coherent transmission may also support the precoding matrix for non-coherent transmission described above. Since the method in situation 1 supports coherent transmission only for a combination between two antennas, the performance gain in terms of antenna diversity may be small compared to situation 2, which supports coherent transmissions between four antenna ports, described below.

[Situation 2] Case in which a UE may support coherent transmission between four antenna ports: Situation 2 corresponds to a case in which the UE may support coherent transmission for only a combination of four antenna ports among 8 antenna ports. For example, among antenna ports 0 to 7, coherent transmission through antenna ports {0, 2, 4, 6} is possible, and similarly, coherent transmission through antenna port combinations of {1, 3, 5, 7} may also be possible. These combinations are only an exemplary and are not limited to the combinations described above, and any combination of four antenna ports, such as {0, 1, 2, 3}, {4, 5, 6, 7} through which coherent transmission is possible, among 8 antenna ports, may correspond to situation 2. According to an embodiment of the disclosure, for convenience of explanation, antenna ports {0, 2, 4, 6} and {1, 3, 5, 7} are assumed to be combinations through which coherent transmission is possible (signify that various embodiments of the disclosure are not limited to the described combination). Designing the UE to enable coherent transmission through a combination of four antenna ports among the 8 antenna ports may provide a large diversity performance gain at the expense of increased implementation complexity compared to performing partial coherent transmission with two of the existing four antenna ports. If coherent transmission is possible for these antenna port combinations, an uplink codebook configured by 8×1 vectors may be defined as shown in Equation 10 below.

$${[ \begin{matrix}\text{?} & 0 & \text{?} & \begin{matrix}0 & \text{?}\end{matrix} & \begin{matrix}0 & \text{?}\end{matrix} & 0\end{matrix} ]}^{T} \text{?} \qquad Equation 10$$

$${[ \begin{matrix}0 & \text{?} & 0 & \text{?} & 0 & \text{?} & 0 & \text{?}\end{matrix} ]}^{T}$$

$$\text{?} \text{indicates text missing or illegible when filed}$$

Referring to Equation 10, each e^{j·2π·θ}^{_{i,k}} has a value other than zero, and θ_{i,k} may be a value that prevents 8 elements of the corresponding vector from being zero. For example, e^{j·2π·θ}^{_{i,k}} may have a value of one of 1, −1, j, or −j.

In both cases where the UE supports only 1 layer or more than 2 layers through 8 transmission antennas, the base station may support the UE by using the precoding matrix configured by 8×1 vectors defined in Equation 7, which is the same as the full coherent described above (e.g., in case of supporting 1 layer), or using an 8×l precoding matrix configured by the l number of 8×1 vectors defined in Equation 7 (e.g., in case of supporting/layers).

A UE capable of partial coherent transmission may also support the precoding matrix for non-coherent transmission described above. In addition, depending on the UE design, partial coherent transmission may also be supported, which supports coherent transmission between two antenna ports.

[Situation 3] Case in which coherent transmission is supportable by a combination that may be configured by a different number of antenna ports rather than an antenna port combination consisting of the same number of antenna ports as the case in which only two or four antenna ports are configured: Unlike Situations 1 and 2, the UE may be designed such that coherent transmission is possible between different numbers of antenna ports rather than between antenna port combinations consisting of the same number of antenna ports, according to the antenna configuration method of the UE. For example, the UE may be designed such that coherent transmission through two antenna ports among the 8 antenna ports is possible and coherent transmission through the remaining six antenna ports is possible. Alternatively, the UE may be designed to support coherent transmission for other combinations, such as three and five antenna ports, etc. In such cases, the supportable coherent type may be redefined for reporting of UE capabilities between the base station and the UE, and reporting parameters may be newly introduced to support the new coherent antennas, such as patialCoh3_5 or paritlaCoh2_6, for example. When these new UE capabilities are reported by the UE to the base station, the base station may schedule a PUSCH by using the corresponding uplink codebook. Equation 11 below shows an example of an uplink codebook configured by an 8×1 vector when two antenna ports and six antenna ports are each capable of coherent transmission.

$${[ \begin{matrix}\text{?} & \text{?} & 0 & 0 & 0 & 0 & 0 & 0 & 0\end{matrix} ]}^{T} , \qquad Equation 11$$

$${[ \begin{matrix}0 & 0 & \text{?} & \text{?} & \text{?} & \text{?} & \text{?} & \text{?}\end{matrix} ]}^{T}$$

$$\text{?} \text{indicates text missing or illegible when filed}$$

Referring to Equation 11, each e^{j·2π·θ}^{_{i,k}} has a value other than zero, and θ_{i,k} may be a value that prevents 8 elements of the corresponding vector from being zero. For example, e^{j·2π·θ}^{_{i,k}} may have a value of one of 1, −1, j, or −j.

As such, a method such as situation 1 may also be supported according to an antenna implementation method of a UE supporting a new type of partial coherent transmission. Alternatively, situation 2 other than situation 1 or other situations may also be considered.

Situation 4 Support for multiple partial coherent transmission methods which a UE is supportable in any of Situations 1 to 3: Higher layer parameters may be newly defined to support multiple partial coherent transmission methods among situations 1 to 3 according to the antenna implementation method of the UE. The UE may add a new partialCoherent assumption as well as the existing nonCoherent, partialCoherent, and fullCoherent assumptions to the UE capability report transmitted to the base station. For example, the UE may add partialCoherent2, partialCoherent4, or the aforementioned patialCoh3_5 or paritlaCoh2_6 to the UE capability report. The UE may report one or multiple new UE capabilities to the base station. Alternatively, one UE reporting parameter, such as partialCoherent2_4, may be defined to report the fact that coherent transmission for two antenna ports and coherent transmission for four antenna ports are possible. Thereafter, the base station may configure a supported codebook subset, such as Partial2AndNonCoherent, Partial4AndNonCoherent, or Partial4AndPartial2AndNonCoherent, as codebookSubset when configuring higher layer parameters related to PUSCH transmission based on the UE capability report reported by the UE. This is just one example, and various combinations such as FullyAndPartial2AndNonCoherent may be considered.

### The (1-2)Th Embodiment: Method of Configuring an Uplink Codebook for 8 Antennas in Two Stages by Considering Polarization

According to an embodiment of the disclosure, the (1-2)th embodiment specifically describes a method for configuring an uplink codebook for supporting 8 antennas in two phases, by considering polarization.

In order to configure a codebook for 8 antennas, an example of uplink codebook configured by an 8×1 vector when co-phase terms are considered may be shown as shown in Equation 12.

$$\text{?} = [ \begin{matrix}a \\ b \\ c \\ d\end{matrix} ] , w = \frac{1}{\sqrt{8}} [ \begin{matrix}\text{?} \\ \text{?}\end{matrix} ] \qquad Equation 12$$

$$\text{?} \text{indicates text missing or illegible when filed}$$

Referring to Equation 12, v_{l,m} is a vector that may include non-zero coefficients, and at least one of coefficients a, b, c, and d, or some or all of coefficients may be a non-zero value. Similar to the examples described above, v_{l,m} may be expressed in the form of e^{j·2π·θ}^{_{i,k}}, and may have a value of one of 0, 1, −1, j, and −j but not all of which are zero. v_{l,m} having been configured through the method described above may be the same or similar to the vectors for supporting the four antenna ports used in NR Releases 15 through 17. Thereafter, the 8×1 vector may be configured using a co-phase term φₙ in consideration of the polarization between the antennas.

In both cases in which the UE supports only 1 layer or more than 2 layers through 8 transmission antennas, the base station may support the UE by using the precoding matrix configured by the 8×1 vector defined in Equation 7 (e.g., in case of supporting 1 layer), or using an 8×l precoding matrix configured by l number of 8×1 vectors defined in Equation 7 (in case of supporting l layers), which is the same as for the above-described situations in the (1-1)th embodiment described above.

### Second Embodiment: Method of Determining Association Between PTRS and DMRS to Support Codebook-Based PUSCH Transmission Through 8 Uplink Transmission Antennas

According to an embodiment of the disclosure, a specific method of associating an uplink PTRS with a PUSCH DMRS when supporting a codebook for supporting 8 uplink transmission antennas is described.

Depending on the case in which a codebook for supporting 8 uplink transmission antennas as described in the first embodiment is configured as in the (1-1) embodiment and the case in which the same is configured as the (1-2) embodiment, a method for determining an association between PTRS and DMRS may be considered.

### The (2-1)Th Embodiment: Method of Determining Association Between PTRS and DMRS when Using Extended Uplink Codebook to Support 8 Transmission Antennas

The (2-1)th embodiment of the disclosure describes a specific method for determining the association between PTRS and DMRS of PUSCH when the existing codebook for 4 uplink transmissions is extended for transmission of 8 uplink antennas as for the (1-1)th embodiment.

For codebook-based PUSCH support, when the codebook subset is non-coherent or partial coherent, the base station may indicate, to the UE, the association between the PTRS and DMRS and the information of the DMRS port to which the PTRS port is associated, through a predefined rule and the PTRS-DMRS association field included in the DCI. When the UE transmits the PTRS, the PUSCH DMRS which serves as a base for transmission is indicated, and thus the PTRS and DMRS included in the PUSCH received by the base station may be used together to perform more accurate uplink data reception through phase estimation and phase error correction. As described above, in a codebook-based PUSCH transmission with two PTRS ports, the uplink layer transmitted to PUSCH antenna ports 1000 and 1002 may be associated with PTRS port 0, and the uplink layer transmitted to PUSCH antenna ports 1001 and 1003 may be associated with PTRS port 1. Here, an antenna port may be defined, based on a channel through which a symbol transmitted to a specific antenna port passes, as a channel through which another symbol transmitted to the same antenna port passes may be inferred. In other words, this may be understood as meaning that different symbols transmitted to the same antenna port are transmitted though the same physical antenna. Based on the antenna port, a relationship may be inferred between the channels passed by symbols transmitted to the same antenna port with or without additional information (e.g., statistical channel characteristics, etc.). The PUSCH antenna ports 1000 to 1003 described above may be understood as logically indexed values to distinguish the antenna ports to which the PUSCH is actually transmitted. For example, the layer (e.g., DMRS port) associated with PTRS with respect to a partial antenna among the four antenna ports may be supported such that the base station and the UE define rules in advance, and based on the defined rules, the PTRS-DMRS association field included in the DCI may be interpreted and the association between PTRS and DMRS may be determined by the UE and used for PUSCH transmission. On the other hand, when some antenna combinations of the 8 antenna ports support partial coherent transmission where coherent transmission is possible, the base station and the UE may define rules in advance for the layers associated with the PTRS according to situations 1 to 4 described above in the (1-1)th embodiment. For simplicity of explanation, Methods 1 and 2 may assume that the same two PTRS ports are supported as before.

[Method 1: When Partial Coherent Transmission is Supported by Considering a Case in which Coherent Uplink Transmission is Possible Between Two Antenna Ports as for Situation 1 of the (1-1)Th Embodiment]

In NR Releases 15 to 17, in case that coherent transmission is possible or even when non-coherent transmission occurs, layers transmitted to PUSCH ports 0 and 2 are defined to be associated with PTRS port 0, layers transmitted to PUSCH ports 1 and 3 are associated with PTRS port 1, and layers transmitted to PUSCH ports 2 and 3 are associated with PTRS port 0, by using a partial coherent transmission method. However, in situation 1, a total of four antenna port groups through which coherent uplink transmission is possible may be defined (e.g., four antenna port groups such as {0, 4}, {1,5}, {2, 6}, {3, 7} may be considered). For the four antenna port groups, the base station and the UE may determine rules in advance so that the layer transmitted through the n antenna port groups is associated with PTRS port 0 and the layer transmitted through the remaining (4−n) antenna port groups is associated with PTRS port 1. As an example, the base station and the UE may determine such that the layers transmitted through the antenna port groups {0, 4} and {2, 6} are associated with PTRS port 0, and the layers transmitted through the antenna port groups {1, 5} and {3, 7} are associated with PTRS port 1. Alternatively, the base station and the UE may also determine such that the layer transmitted through the antenna port groups {0, 4}, {1, 5} is associated with PTRS port 0 (or PTRS port 1) and the layer transmitted through the antenna port group {2, 6}, {3, 7} is associated with PTRS port 1 (or PTRS port 0). However, according to various embodiments of the disclosure, it is not limited to the above example, and any other combination may be considered. In addition to the aforementioned antenna port group, an antenna port group configured by other antennas may also determine a relationship with a PTRS port through a similar method.

[Method 2: When Partial Coherent Transmission is Supported by Considering a Case in which Coherent Uplink Transmission is Possible Between Four Antenna Ports as for the Situation 2 of the (1-1)Th Embodiment]

In situation 2, two antenna port groups configured by four antenna ports through which coherent uplink transmission is possible may be distinguished. Therefore, the base station and the UE may determine such that two PTRS ports are associated with ach antenna port group. For example, if an antenna port group through which coherent transmission is possible is configured, such as {0, 2, 4, 6} or {1, 3, 5, 7}, a layer transmitted through {0, 2, 4, 6} may be associated with PTRS port 0 (or PTRS port 1), and a layer transmitted through {1, 3, 5, 7} may be associated with PTRS port 1 (or PTRS port 0). However, according to various embodiments of the disclosure, it is not limited to the above example, and any other combination may be considered. In addition to the aforementioned antenna port group, an antenna port group configured by other antennas may also determine a relationship with a PTRS port through a similar method.

### [Method 3: Method of Indicating an Antenna Port Sharing a PTRS Port]

A base station may receive a report of UE capability for coherent transmission for 8 uplink antennas from a UE, and based on the received UE capability report, may determine an antenna port that shares a PTRS port. According to an embodiment, an antenna port sharing a PTRS port may be determined based on an antenna port group configured by antenna ports through which coherent transmission is possible, or may be determined considering only individual antenna ports. The base station that has determined the antenna port group(s) or antenna port(s) sharing the PTRS port may configure, in the UE, information on the antenna port sharing the PTRS port through a higher layer parameter (or an indication through signaling such as MAC CE or DCI). As an example, the base station may configure an antenna port group that may be associated with PTRS port 0 by defining a new higher layer parameter sharingPTRS. Coherent transmission is possible only for two antenna ports on the UE, and as shown in an example of the situation 1 of the (1-1)th embodiment, {0, 4}, {1,5}, {2, 6}, {3, 7} are assumed to be configured as a set of antenna ports, and the base station and the UE may identify that {0,4} is set 1, {1,5} is set 2, {2,6} is set 3, and {3,7} is set 4 according to predefined rules. These predefined rules may be defined by a standard to use a single method, may be determined by adding lists to the higher layer configuration, or may be determined by other signaling methods. In case that set 1 and set 2 are configured in the new higher layer parameter sharingPTRS and the number of uplink PTRS ports is configured two, PTRS port 0 may be associated with layers transmitted to set 1 and set 2 according to the rules predefined by the base station and the UE, and layers transmitted to other sets may be associated with PTRS port 1. In the higher layer parameter sharingPTRS, an antenna port that may be associated with PTRS port 0 rather than an antenna port group may be configured to have a value for the correspond area, and the UE may determine that the remaining antenna ports that are not configured are associated with PTRS port 1.

In methods 1 to 3, the case of using two PTRS ports has been described. However, a future NR Release may introduce a number of PTRS ports greater than two. In this case, the method described above in the (2-1)th embodiment may be extended to the case in which the number of PTRS ports greater than two and used. As an example, if four antenna port groups such as {0, 4}, {1, 5}, {2, 6}, {3, 7} are considered for a UE capable of coherent transmission for two antennas, the base station and the UE may determine that the layer transmitted by the first antenna group {0, 4} is associated with PTRS port 0, the layer transmitted by the second antenna group {1, 5} is associated with PTRS port 1, the layer transmitted by the third antenna group {2, 6} is associated with PTRS port 2, and the layer transmitted by the fourth antenna group {3, 7} is associated with PTRS port 3. However, according to various embodiments of the disclosure, it is not limited to the above-described examples, and other mapping methods to enable an association between antenna ports or antenna port groups and PTRS ports to be established may be considered.

### The (2-2)Th Embodiment: Method of Determining Association Between PTRS and DMRS when Using Uplink Codebook for Supporting 8 Transmission Antennas Considering Polarization

The (2-2)th embodiment of the disclosure describes a specific method for determining an association between PTRS and DMRS with respect to the case of using a codebook for supporting uplink 8 transmission antennas by considering polarization as in the (1-2)th Embodiment.

When the codebook is defined to support 8 transmission antennas using a co-phase term, the two PTRS ports may be associated with the corresponding DMRS ports through the following methods.

### [Method 1: A Layer Transmitted Through an Antenna Port Configured by the Same Co-Phase Term Shares the Same PTRS Port]

Method 1 may be used when transmitting to a group of antennas for the same co-phase term during partially coherent transmission. In the (1-2)th embodiment, when transmitting an uplink codebook to support 8 transmission antennas as defined in Equation 12, the first four antenna ports may be classified into the same co-phase group and the next four antenna ports may be classified into the same co-phase group according to the co-phase term φₙ. For two antenna groups classified according to the co-phase term, the layer transmitted to the antenna group for the first co-phase term may be associated with PTRS port 0. Similarly, the layer transmitted to the antenna group for the second co-phase term may be associated with PTRS port 1.

### [Method 2: A Layer Transmitted Through Antenna Ports Configured by Different Co-Phase Terms Share the Same PTRS Port]

Method 2 may be used when grouping and transmitting antennas for different co-phase terms during partial coherent transmission. For example, referring to Equation 12 in the (1-2)th embodiment, the first antenna port and the fifth antenna port have the same “a” value, but may be distinguished by different co-phase terms. As such, the UE may perform partial coherent transmission by defining this combination as an antenna port group through which coherent transmission is possible. When two antenna ports are partially-coherently transmitted by considering one antenna port from each co-phase term, a method similar to Method 1 of the (2-1)th embodiment may be applied. In this case, an association with a PTRS port may be determined for an antenna group capable of a total of four partial coherent transmissions by considering one antenna port for each co-phase term. The base station and the UE may define that layers transmitted in n groups among four antenna groups capable of coherent transmission considering a co-phase term are associated with PTRS port 0. The base station and the UE may define that layers transmitted in the remaining (4-n) groups are associated with PTRS port 1. As an example, four antenna groups capable of coherent transmission such as {0, 4}, {1, 5}, {2, 6}, and {3, 7} may be defined in consideration of the co-phase term. In this case, the base station and the UE may define a layer transmitted through antenna ports {0, 4} or {1, 5} to be associated with PTRS port 0. The base station and the UE may define a layer transmitted through antenna ports {2, 6} or {3, 7} to be associated with PTRS port 1. Here, the definition between the base station and the UE may be considered to be fixed in the standard. Alternatively, a new UE report and higher layer parameter may be introduced, and the base station may determine to configure higher layer parameters in the UE based on the UE report. However, various embodiments of the disclosure are not limited to the examples described above, the four groups of antennas capable of coherent transmission may be defined differently, and different combinations of antenna port groups associated with PTRS port0 or port1 may be contemplated.

### Third Embodiment: Method of Determining Association Between PTRS and DMRS to Support Non-Codebook-Based PUSCH Transmission Through 8 Uplink Transmission Antennas

The third embodiment of the disclosure describes a specific method for determining an association between a PTRS port and a DMRS port of a PUSCH when non-codebook-based PUSCH transmission is supported through 8 uplink transmission antennas.

In NR Releases 15 to 17, when the UE transmits a non-codebook-based PUSCH, a DMRS port of a PUSCH associated with a PTRS port may be determined according to SRS resource configuration within an SRS resource set associated with PUSCH transmission (e.g., SRS resource set for which usage is ‘nonCodebook’) as described in the uplink PTRS related section. As an example, the higher layer parameter ptrs-PortIndex for the first and second SRS resources among the four SRS resources configured in the SRS resource set may be configured as ‘n0’. This may signify that the two SRS resources have an association with PTRS port 0. Similarly, among the four SRS resources configured in the SRS resource set, the higher layer parameter ptrs-PortIndex for the third and fourth SRS resources may be configured as ‘n1’, which may signify that the two SRS resources have an association with PTRS port 1. Thereafter, when the base station schedules a PUSCH through DCI based on the received SRS for non-codebook, the PTRS port associated with the SRS resource(s) indicated by the SRI in the DCI may be transmitted together during PUSCH transmission. Here, each indicated SRS resource is configured by one port, the PUSCH port for PUSCH transmission may be configured identically to the indicated SRS port, and the UE may transmit the configured port.

In addition, each PUSCH port may refer to each layer for PUSCH transmission. When multiple associated layers are indicated for one PTRS port, the base station may indicate a DMRS port (layer) with which the PTRS port is associated through a PTRS-DMRS association field included in the same DCI as the DCI for scheduling the PUSCH. This may correspond to a method of indicating an association between PTRS and DMRS for 4 SRS resources based on four transmission antennas, and an enhanced method may be required to support PUSCH transmission using 8 transmission antennas. In the case of supporting non-codebook-based PUSCH using 8 transmission antennas, the enhanced method may be configured differently according to the number of SRS resources for non-codebook use determined by higher layer configurations. Here, the number of SRS resources for non-codebook use may be the number of SRS resources included in one SRS resource set for non-codebook use or the total number of SRS resources included in two SRS resource sets for non-codebook use, similar to the prior art. Alternatively, if n SRS resource sets for non-codebook use are defined in a future NR release, the total number of SRS resources included in the total number of n SRS resource sets for non-codebook use may be considered. According to an embodiment, even if multiple SRS resource sets for non-codebook use are configured, only the number of SRS resources in one set may be considered. In the third embodiment of the disclosure, it is assumed that the number of SRS resources for non-codebook-based PUSCH transmission to be currently supported may be determined through predetermined assumptions and configurations. In this case, it is assumed that the number of SRS resources is 8. However, this may not be understood as meaning that the method is limited only to the case in which the number of SRS resources is 8, and the method may be extended to be applied to other cases.

When configuring the higher layer for 8 SRS resources, the base station may configure the ptrs-PortIndex as ‘n0’ or ‘n1’ for each SRS resource. Here, the base station may configure the value of ptrs-PortIndex of the SRS resource in consideration of the following method. When a base station establishes an association between an SRS and a PTRS port by using the methods below, one SRS resource should be associated with one PTRS port.

[Method 1: The Number of SRS Resources Associated with Each PTRS Port is Same]

Method 1 may include a method of configuring the number of SRS resources associated with PTRS port 0 and PTRS port 1 to be the same. According to an embodiment, when 8 SRS resources are included in an SRS resource set for one non-codebook, 4 SRS resources may have ptrs-PortIndex configured as ‘n0’ to be associated with PTRS port0, and the remaining four SRS resources may have ptrs-PortIndex configured as ‘n1’ to be associated with PTRS port1. When the number of SRS resources in the SRS resource set is an odd number, there may be one more SRS resources associated with either PTRS port0 or PTRS port1. For example, if the number of SRS resources is seven, four SRS resources may be associated with PTRS port0 and three SRS resources may be associated with PTRS port1.

[Method 2: A Predetermined Number of SRS Resources are Associated with Each PTRS Port]

Method 2 of the third embodiment may differ from method 1 of the third embodiment in that there is no constraint that the same number of SRS resources (e.g., if the number of SRS resources is even or odd, one port is associated with one more SRS resources) are associated with each PTRS port. An SRS resource may have ptrs-PortIndex configured as ‘n0’ so that n SRS resources are associated with PTRS port0, and the remaining (8−n) SRS resources may have ptrs-PortIndex configured as ‘n1’. In this case, n may not be expected to be configured as 0 and the maximum number of SRS resources (e.g., 8). As an example, the method may allow the base station to configure PTRS port 0 to be associated with 6 SRS resources and PTRS port 1 to be associated with 2 SRS resources. This configuration may be determined by the base station based on receiving new or existing UE capability reports from the UE. The new or existing UE capability report that may be associated may include a UE report regarding whether coherent transmission through the uplink transmission antenna of the UE is possible (e.g., select one of full, partial, or noncoherent transmissions) or regarding an antenna group through which new coherent transmission is possible described above, or a predetermined UE capability report that may be associated with antenna implementation of another UE. According to some embodiments, the UE may also report new UE capability with respect to the PTRS port configuration to the base station. Referring to the UE capability report, the base station may configure the PTRS port associated with the SRS resource in the higher layer parameter SRS-Resource through the ptrs-PortIndex.

### Fourth Embodiment: Method of Configuring Field in Downlink Control Information According to PTRS-DMRS Association Determination when Supporting 8 Uplink Transmission Antennas

According to an embodiment of the disclosure, when the PTRS-DMRS association method is reinforced to transmit 8 uplink antennas, a specific method of configuring a PTRS-DMRS association field included in downlink control information (DCI) is described.

In NR Releases 15 to 17, the number of bits of the PTRS-DMRS association field included in DCI may be determined as 0 bits (e.g., this corresponds to a case in which the number of ranks (layers) supported is 1, and includes cases in which the number of layers is 1, such as when DFT-s-OFDM is supported or the higher layer parameter maxRank is configured as 1) or 2 bits. In case that 8 uplink antennas are supported to support a maximum of 8 layers (e.g., DMRS ports), where the maximum number of layers supported is greater than four, the number of PTRS-DMRS association fields may need to be reinforced. According to various embodiments of the disclosure, a case in which a maximum of 8 layers are supported is assumed, and a method of configuring a PTRS-DMRS association field in a DCI field is described. However, the disclosure is not limited thereto, and may be extended to support less than 8 (e.g., a maximum of 6 layers) or greater than 8 (e.g., a maximum of 10 layers, in this case the number of uplink antennas supported by the UE may also be greater than 8 layers) so that fields in the DCI may be configured.
When the number of supported PTRS ports is 1: When the number of supported PTRS ports is 1, the number of bits of the PTRS-DMRS association field may be configured so that one of the total 8 layers may be selected. That is, one DMRS port, which is associated with a PTRS port, among 8 DMRS ports may be indicated using 3 bits. Table 37 shows the meaning of code points for interpreting the PTRS-DMRS association field that may be supported when the number of supported PTRS ports is 1 and support for a maximum of 8 layers is possible.

TABLE 37

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |
| 4 | 5^{th} scheduled DMRS port |
| 5 | 6^{th} scheduled DMRS port |
| 6 | 7^{th} scheduled DMRS port |
| 7 | 8^{th} scheduled DMRS port |

When the number of PTRS ports supported is 2: when the number of PTRS ports is 2, the first a bits for PTRS port 0 and b bits for PTRS port 1 may be configured according to the number of maximum layers associated with each PTRS port (e.g., if codebook-based, the number of layers associated with each PTRS port among all layers according to each antenna port group, or if non-codebook based, the number of layers associated with each PTRS port among all layers according to the higher layer configuration in SRS resource). For example, as in method 1 of the (2-1)th embodiment, antenna port groups associated with two PTRS ports and layers transmitted to corresponding antenna port groups may be considered. In this case, if in the codebook for 8 layers, four layers are transmitted to the antenna port groups associated with PTRS port0 and the remaining four layers are transmitted to the antenna port groups associated with PTRS port1, two bits each may be required to indicate an association between each PTRS port and each DMRS. For example, when configuring the PTRS-DMRS association field, the first 2 bits may be instructed by the base station to the UE to indicate the association between PTRS port 0 and the PUSCH DMRS port (layer) that may be associated with the PTRS port 0, and the next 2 bits may be instructed by the base station to the UE to indicate the association between PTRS port 1 and the PUSCH DMRS port (layer) that may be associated with the PTRS port 1. In other words, the number of bits of the full PTRS-DMRS association field may be a total of 4 bits, and the first 2 bits may be used for PTRS port 0 and the next 2 bits may be used for PTRS port 1. In the case of codebook PUSCH, when the UE interprets the corresponding PTRS-DMRS association field included in the DCI, the precoding matrix and layer information selected by the SRI and TPMI indicated by the same DCI are identified, and based on the identified precoding matrix and layer information, the PUSCH DMRS port associated with the two PTRS ports may be identified first. Thereafter, when multiple DMRS ports can be associated with a PTRS port, a PUSCH port associated with a PTRS port may be finally determined through the PTRS-DMRS association field, and the UE transmits the PUSCH and PTRS to the base station based on the determined PUSCH port. In the case of non-codebook PUSCH, the number of bits may be determined according to the number of SRS resources associated with each PTRS port for 8 SRS resources. When two PTRS ports are equally associated with four SRS resources, as in method 1 of the third embodiment, the first two bits may be used for PTRS port 0 and the next 2 bits may be used for PTRS port 1. Table 38 shows the meaning of codepoints for interpreting the PTRS-DMRS association field when the number of layers (PUSCH ports) associated with the two PTRS ports is the same as 4, respectively.

TABLE 38

| Value of | | Value of | |
|---|---|---|---|
| MSB | DMRS port | LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |
| 2 | 3^{rd} DMRS port which | 2 | 3^{rd} DMRS port which |
| | shares PTRS port 0 | | shares PTRS port 1 |
| 3 | 4^{th} DMRS port which | 3 | 4^{th} DMRS port which |
| | shares PTRS port 0 | | shares PTRS port 1 |

If the number of layers (PUSCH ports) associated with two PTRS ports is not the same, the meaning of the codepoint for the PTRS-DMRS association field may be different. As an example, when the number of layers associated with PTRS port 0 is 6 and the number of layers associated with PTRS port 1 is 2, the interpretation method for the codepoints of each MSB and LSB may be different as shown in Table 39.

TABLE 39

| Value of | | Value of | |
|---|---|---|---|
| MSB | DMRS port | LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |
| 2 | 3^{rd} DMRS port which | | |
| | shares PTRS port 0 | | |
| 3 | 4^{th} DMRS port which | | |
| | shares PTRS port 0 | | |
| 4 | 5^{th} DMRS port which | | |
| | shares PTRS port 0 | | |
| 5 | 6^{th} DMRS port which | | |
| | shares PTRS port 0 | | |
| 6-7 | Reserved | | |

Referring to Table 39, 3-bit MSB may be used to determine a DMRS port associated with PTRS port 0 and 1-bit LSB may be used to determine a DMRS port associated with PTRS port 1. Similarly, when two layers are associated with PTRS port 0 and 6 layers are associated with PTRS port 1, 2 MSB codepoints may be used and 6 LSB codepoints may be used. In this case, as the total number of bits is 4 bits, a PTRS-DMRS association field having the same number of bits as in the previous case in which two PTRS ports are associated with the same number of layers may be used. However, various embodiments of the disclosure are not limited to the above examples, the number of MSB bits of the PTRS-DMRS association field for PTRS port 0 and the number of LSB bits of the PTRS-DMRS association field for PTRS port may vary depending on the configurations, etc., and accordingly, the total number of bits of the PTRS-DMRS association field may not be 4 bits.
When the number of supported PTRS ports is P greater than 2: When a number of PTRS ports greater than 2 are supported, bits for P different PTRS-DMRS associations may be defined according to the number of layers associated with each PTRS port, and these bits may be defined to collectively form one PTRS-DMRS association field. When the number of layers associated with the PTRS port p is Lₚ, the number of codepoints required to indicate this may be at least Lₚ. Accordingly, when calculating the number of bits to represent the same, ┌log₂(Lₚ)┐ bits may be required. Therefore, the number of bits of the full PTRS-DMRS association field may be represented as Σₚ₌₀^{p-1}┌log₂(Lₚ)┐ and the code points for the respective ┌log₂(Lₚ)┐ bits may be used to determine the DMRS port associated with the PTRS port p. Table 40 shows the meaning of the code points of the PTRS-DMRS association field that may be configured when supporting P PTRS ports.

TABLE 40

| | | | | |
|---|---|---|---|---|
| Value | | | Value | |
| of | | | of | |
| MSB | DMRS port | . . . | LSB | DMRS port |

| | | | |
|---|---|---|---|
| 0 | 1^{st} DMRS port which | 0 | 1^{st} DMRS port which |
| | shares PTRS port 0 | | shares PTRS port 0 |
| 1 | 2^{nd} DMRS port which | 1 | 2^{nd} DMRS port which |
| | shares PTRS port 0 | | shares PTRS port 0 |
| . . . | 3^{rd} DMRS port which | . . . | 3^{rd} DMRS port which |
| | shares PTRS port 0 | | shares PTRS port 0 |
| [symbol] | [symbol] DMRS port which | [symbol] | [symbol] DMRS port which |
| | shares PTRS port 0 | | shares PTRS port 0 |
| [symbol] | Reserved (if exist) | [symbol] | Reserved (if exist) |

[symbol]

indicates data missing or illegible when filed

### Fifth Embodiment: Method of Determining Association Between DMRS and PTRS-DMRS According to Codewords when Supporting 8 Uplink Transmission Antennas

According to an embodiment of the disclosure, when 8 uplink transmission antennas are supported, if two (or two or more) codewords are configured to transmit a PUSCH, a specific method for determining an association between a DMRS and a PTRS-DMRS considering each codeword is described.

As 8 uplink transmission antennas are supported, a UE may support two (or more) codewords (CW) instead of one codeword in NR Releases 15 through 17. In this case, a mapping relationship between each PUSCH layer and each codeword may be determined. Each codeword may be transmitted through a mapped PUSCH layer. According to specific embodiments, a case in which a UE supporting 8 uplink transmission antennas transmits two codewords to 8 layers and supports one or two PTRS ports is specifically described. However, this is only an example. K codewords and P PTRS ports are generalized, and an association between K codewords and P PTRS is defined, so that the PUSCH DMRS port to which the PTRS port is associated may be finally determined.

When two codewords and two PTRS ports are supported, each PTRS port may be associated with each codeword, and a PUSCH DMRS port associated with a predetermined PTRS port may be determined as one of multiple PUSCH DMRS ports for the associated codeword. As a specific example, when the first codeword is transmitted through layers 0, 1, 2, and 3 and the first codeword is associated with PTRS port 0, the PUSCH DMRS port that may be associated with PTRS port 0 may be one of the PUSCH DMRS ports for layers 0, 1, 2, and 3. When the second codeword is transmitted through layers 4, 5, 6, and 7 and the second codeword is associated with PTRS port 1, the PUSCH DMRS port that may be associated with PTRS port 1 may be one of the PUSCH DMRS ports for layers 4, 5, 6, and 7. A method of selecting one of the four candidates for each PTRS port may be determined according to the DCI-based PTRS-DMRS association field as described above. According to another method, a PUSCH DMRS port having the lowest index among candidates may be selected. When selection of PTRS port is determined according to the DCI-based PTRS-DMRS association field, similar to the specific example of the above-described embodiment, the first two bits may be used to indicate one of four PUSCH DMRS ports that may be associated with PTRS port 0, and then the next 2 bits may be used to indicate one of four PUSCH DMRS ports that may be associated with PTRS port 1. As another example, two PTRS ports may be associated with only one codeword, and two of multiple PUSCH DMRS ports for transmitting a layer for the associated codeword may be determined and associated with each PTRS port. In this case, codewords associated with the two PTRS ports may be determined based on scheduling information of a PUSCH for transmitting each codeword. As an example, when DCI scheduling a PUSCH for transmitting two codewords includes an MCS field for each codeword, a codeword scheduled with a higher MCS field value among the two MCSs may be determined. However, this is only an example, and is not limited thereto, and when the DCI scheduling the PUSCH for transmitting two codewords includes the MCS field for each codeword, a codeword scheduled with a lower MCS field value may be determined. According to an embodiment, if the two MCSs have the same value, the first codeword (or the second codeword) may be determined to be associated with the two PTRS ports. Two layers among layers for transmitting codewords associated with the two PTRS ports may be determined to be associated with the two PTRS ports, and the base station may instruct the UE to enable association of the PUSCH DMRS ports for the determined two layers with the two PTRS ports. In this case, a method for indicating an association between a PUSCH DMRS port and a PTRS port may be determined according to a DCI-based PTRS-DMRS association field as described above. As another method, the first two PUSCH DMRS ports having the lowest indices among the candidates may be used. Among layers for one determined codeword, a layer that may be associated with each PTRS port may be determined according to the transmission antenna port in the case of a codebook-based PUSCH as described above, or may be determined according to the ptrs-PortIndex configured in the higher layer parameter SRS-Resource in the case of a non-codebook-based PUSCH. Alternatively, the base station and the UE may define a rule in advance so that m layers among M multiple layers for the determined codeword are associated with PTRS port 0 and (M-m) layers are associated with PTRS port 1. When the maximum number of supportable layers for transmission of two codewords is configured as 5 to 7 layers instead of 8 layers, mapping between codewords and layers for PUSCH transmission may be the same as (or similar to) the PDSCH layer-codeword mapping for receiving two codewords, and accordingly, the PTRS-DMRS association field (e.g., the number of bits in the field, the number of bits in the field for each PTRS port, etc.) may be determined. Alternatively, a PTRS-DMRS association field fixed to a predetermined bit value (e.g., 4 bits according to the above-described embodiments of the disclosure) may be supported regardless of the maximum number of supportable layers.

When two codewords and one PTRS port are supported, a codeword associated with one PTRS port may be determined based on scheduling information of a PUSCH for transmitting each codeword. For example, if DCI scheduling a PUSCH for transmitting two codewords includes an MCS field for each codeword, a codeword scheduled with a higher MCS field value among two MCSs may be determined. However, this is only an example and is not limited thereto, and when the DCI scheduling the PUSCH for transmitting two codewords includes the MCS field for each codeword, the codeword scheduled with a lower MCS field value may be determined. Alternatively, if the two MCSs have the same value, the first codeword (or the second codeword) may be determined to be associated with the PTRS port. One of the layers for transmitting a codeword associated with one PTRS port may be determined to be associated with the PTRS port, and the base station may instruct the UE to enable association of the PUSCH DMRS port for the determined one layer with the PTRS port. Here, a method for indicating the association between the PUSCH DMRS port and the PTRS port may be determined according to the DCI-based PTRS-DMRS association field as described above. Alternatively, the first PUSCH DMRS port having the lowest index among the candidates may be used.

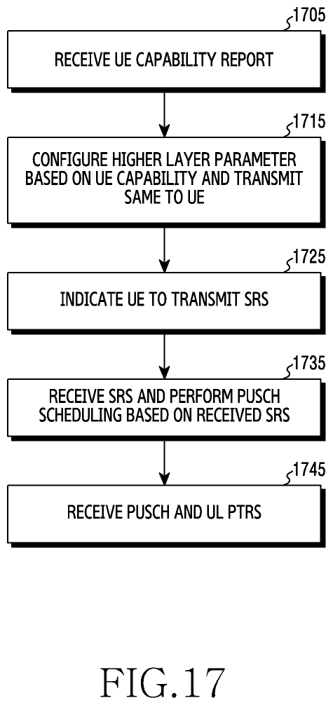

FIG. 17 illustrates an operation flow of a base station for configuring a PTRS and determining precoding based on a capability report of a UE according to an embodiment of the disclosure.

Referring to FIG. 17, in operation 1705, the base station may receive a UE capability report from the UE. The UE capability report received by the base station may include information regarding antenna coherency of the UE and the like.

In operation 1715, the base station may configure a higher layer parameter for supporting the UE based on the UE capability report reported by the UE and transmit the same to the UE. The higher layer parameter configured by the base station may include at least one of precoder subset information for uplink transmission, SRS resource set information, or information regarding an indicator indicating whether a codebook-based PUSCH or non-codebook-based PUSCH is supported. The higher layer parameter configured by the base station may include all higher layer parameters related to PUSCH transmission of the UE.

In operation 1725, the base station may schedule an SRS transmitted by the UE before performing PUSCH scheduling. The SRS transmitted by the UE may have either a codebook use or nonCodebook use. Scheduling performed by the base station may be performed by at least one of the methods such as, DCI-based aperiodic, semi-persistent, which performs periodic reporting based on activation, or periodic, which performs periodic reporting based on higher layer configurations.

In operation 1735, the base station may schedule the PUSCH based on the received SRS. The SRS transmitted by the UE may have either a codebook use or nonCodebook use. The scheduled PUSCH may be a dynamic grant PUSCH based on DCI format 0_1 or DCI format 0_2. DCI scheduling the PUSCH may include at least one of SRI, TPMI, antenna port field, or PTRS-DMRS association field.

In operation 1745, the base station may receive the PUSCH and UL PTRS transmitted by the UE. The base station may estimate a phase error by using the PUSCH DMRS associated with the received UL PTRS. The base station may perform phase error correction by using the estimated phase error.

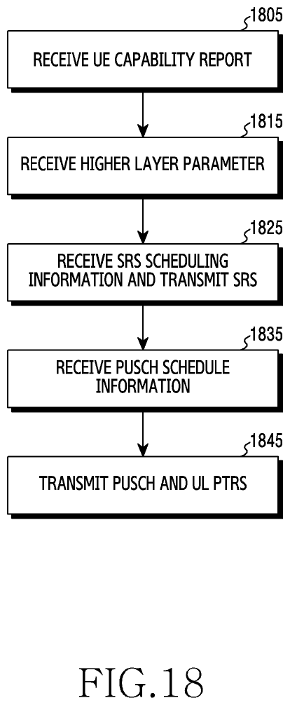

FIG. 18 illustrates an operation flow of a UE for configuring a PTRS and determining precoding based on a capability report of a UE according to an embodiment of the disclosure.

Referring to FIG. 18, in operation 1805, the UE may transmit a UE capability report to a base station. The UE capability report transmitted by the UE may include information regarding antenna coherency of the UE and the like.

In operation 1815, the UE may receive a higher layer parameter transmitted by the base station. The higher layer parameter received by the UE may include at least one of precoder subset information for uplink transmission, SRS resource set information, or information regarding an indicator indicating whether a codebook-based PUSCH or non-codebook-based PUSCH is supported. The higher layer parameter received by the UE may include all higher layer parameters related to PUSCH transmission of the UE.

In operation 1825, the UE may receive an SRS scheduled from the base station and transmit the corresponding SRS to the base station. The SRS transmitted by the UE may have either a codebook use or nonCodebook use. Scheduling performed by the base station may be performed by at least one method, such as DCI-based aperiodic, semi-persistent, which performs periodic reporting based on activation, or periodic, which performs periodic reporting based on higher layer configurations.

In operation 1835, the UE may receive PUSCH scheduling. The scheduled PUSCH may be a dynamic grant PUSCH based on DCI format 0_1 or DCI format 0_2. DCI scheduling the PUSCH may include at least one of SRI, TPMI, antenna port field, or PTRS-DMRS association field.

In operation 1845, the UE may transmit a PUSCH and a UL PTRS. The PUSCH and UL PTRS transmitted by the UE may be configured based on the DCI transmitted by the base station.

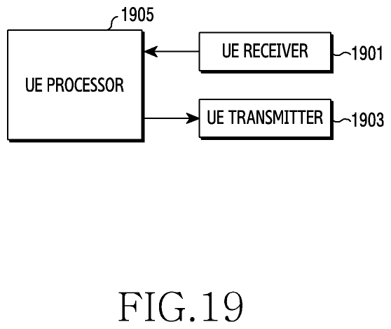

FIG. 19 illustrates a configuration of a UE in a wireless communication system according to an embodiment of the disclosure.

Referring to FIG. 19, a UE may include a transceiver that refers to a receiver 1901 and a transmitter 1903, a memory (not shown), and a UE processor 1905. The UE processor 1905 may be at least one processor, and may also be referred to as a controller. Hereinafter, the UE processor 1905 will be described as a processor. According to various embodiments of the disclosure described above, the processor may control the overall device of the UE so that the UE operates according to a combination of at least one embodiment. However, the elements of the UE are not limited to the above-described examples. For example, the UE may include more or fewer elements than the aforementioned elements. Furthermore, the UE receiver 1901, the UE transmitter 1903, the UE processor 1905, and the memory may be implemented as a single chip.

The transceivers 1901 and 1903 may transmit and receive signals to and from the base station. Here, the signal may include control information and data. To this end, the transceiver may include an RF transmitter for up-converting and amplifying the frequency of a transmitted signal, and an RF receiver for low-noise amplifying a received signal and down-converting the frequency thereof. However, this is only an embodiment of the transceiver, and elements of the transceiver are not limited to the RF transmitter and the RF receiver.

In addition, the transceiver may receive a signal through a radio channel, output the signal to the processor, and transmit the signal output from the processor through the radio channel.

The memory may store programs and data required for the operation of the UE. In addition, the memory may store control information or data included in signals transmitted and received by the UE. The memory may include a storage medium such as a ROM, a RAM, a hard disk, a CD-ROM, and a DVD, or a combination of storage media. In addition, there may be multiple memories, and instructions for performing the above-described communication method may be stored therein.

The UE processor 1905 may control a series of processes so that the UE may operate according to the above-described embodiment. There may be multiple processors, and the processor may perform an operation of controlling elements of the UE by executing a program stored in the memory.

According to an embodiment of the disclosure, the UE processor 1905 may be configured to transmit, to a base station, UE capability reporting information, receive, from the base station, a higher layer parameter determined based on the capability reporting information including information about coherency between antennas of the UE, transmit, to the base station, a sounding reference signal (SRS) determined by the higher layer parameter, receive, from the base station, downlink control information (DCI) scheduling a physical uplink shared channel (PUSCH) determined based on the SRS, and transmit the PUSCH and an uplink (UL) phase tracking reference signal (PTRS) to the base station.

According to an embodiment, the higher layer parameter may include at least one of information about a precoder subset for uplink transmission, information about an SRS resource set, or information regarding an indicator indicating whether a codebook-based PUSCH or non-codebook-based PUSCH is supported.

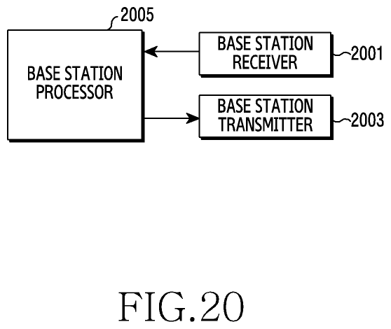

FIG. 20 illustrates a configuration of a base station in a wireless communication system according to an embodiment of the disclosure.

Referring to FIG. 20, the base station may include a transceiver that refers to a receiver 2001 and a transmitter 2003, a memory (not shown), and a base station processor 2005. The base station may include a communication interface (not shown) for wired or wireless communication with another base station through a backhaul link. Hereinafter, the base station processor 2005 will be described as a processor. The processor may be at least one processor, and may also be referred to as a controller. According to various embodiments of the disclosure described above, the processor may control the overall device of the base station so that the base station operates according to a combination of at least one embodiment. However, elements of the base station are not limited to the above-described examples. For example, a base station may include more or fewer elements than those described above. Furthermore, the base station receiver 2001, the base station transmitter 2003, the base station processor 2005, the memory, and the interface may be implemented as a single chip.

The transceivers 2001 and 2003 may transmit and receive signals to and from a UE. Here, the signal may include control information and data. To this end, the transceiver may include an RF transmitter for up-converting and amplifying the frequency of a transmitted signal, and an RF receiver for low-noise amplifying a received signal and down-converting the frequency thereof. However, this is only an example of the transceiver, and elements of the transceiver are not limited to the RF transmitter and the RF receiver.

In addition, the transceiver may receive a signal through a radio channel, output the signal to the processor, and transmit the signal output from the processor through the radio channel.

The memory may store programs and data necessary for the operation of the base station. In addition, the memory may store control information or data included in signals transmitted and received by the base station. The memory may include a storage medium such as a ROM, a RAM, a hard disk, a CD-ROM, and a DVD, or a combination of storage media. In addition, there may be multiple memories, and instructions for performing the above-described communication method may be stored.

The base station processor 2005 may control a series of processes so as to enable the UE to operate according to the above-described embodiment. There may be multiple processors, and the processors may perform an operation of controlling elements of the UE by executing a program stored in memory.

According to embodiments of the disclosure, a method performed by a base station in a wireless communication system may include receiving, from a terminal supporting 8 antenna ports, terminal capability information including information about a number of layers supported by the terminal and information about coherent supported by the terminal, wherein the maximum number of layers supported by the terminal is four or eight, transmitting, in case that the terminal supports partial coherent, to the terminal, configuration information for a coherent group based on a combination of two or four of the antenna ports supported by the terminal, and receiving an uplink signal from the terminal, based on the configuration information for the coherent group.

According to an embodiment, the method may further include determining first association information indicating an uplink signal-related demodulation reference signal (DMRS) port associated with the PTRS port in case that the terminal supports full coherent and there is one phase tracking reference signal (PTRS) port supported by the terminal, transmitting downlink control information (DCI) including the first association information to the terminal, and receiving, based on the DCI, the uplink signal from the terminal.

According to an embodiment, the uplink signal-related DMRS port associated with the PTRS port may correspond to a codeword (CW) having a higher modulation coding scheme (MCS) value among two codewords for transmission of the uplink signal.

According to an embodiment, the method may further include transmitting higher layer configuration information to the terminal, wherein the higher layer configuration information includes at least one of information on a precoder subset for uplink transmission, information on an SRS resource set, or information on an indicator indicating whether a codebook-based PUSCH or a non-codebook-based PUSCH is supported.

According to an embodiment, the method may further include determining second association information including a first indicator indicating an uplink signal-related DMRS port associated with a first PTRS port and a second indicator indicating an uplink signal-related DMRS port associated with a second PTRS port in case that the terminal supports full coherent and there are two PTRS ports supported by the terminal, transmitting DCI including the second association information to the terminal, and receiving, based on the DCI, the uplink signal from the terminal.

According to embodiments of the disclosure, a method performed by a terminal in a wireless communication system may include transmitting, to a base station, terminal capability information including information about a number of layers supported by the terminal and information about coherent supported by the terminal, wherein the terminal supports 8 antenna ports and the maximum number of layers supported by the terminal is four or eight, receiving, in case that the terminal supports partial coherent, from the base station, configuration information for a coherent group based on a combination of two or four of the antenna ports supported by the terminal, and transmitting an uplink signal to the base station, based on the configuration information for the coherent group.

According to an embodiment, the method may further include receiving downlink control information (DCI) including first association information from the base station, wherein in case that the terminal supports full coherent and there is one phase tracking reference signal (PTRS) port supported by the terminal, the first association information indicates an uplink signal-related demodulation reference signal (DMRS) port associated with the PTRS port, and transmitting, based on the DCI, the uplink signal to the base station.

According to an embodiment, the uplink signal-related DMRS port associated with the PTRS port may correspond to a codeword (CW) having a higher modulation coding scheme (MCS) value among two codewords for transmission of the uplink signal.

According to an embodiment, the method may further include receiving higher layer configuration information from the base station, wherein the higher layer configuration information includes at least one of information on a precoder subset for uplink transmission, information on an SRS resource set, or information on an indicator indicating whether a codebook-based PUSCH or a non-codebook-based PUSCH is supported.

According to an embodiment, the method may further include receiving DCI including the second association information from the base station, wherein the second association information includes, in case that the terminal supports full coherent and there are two PTRS ports supported by the terminal, a first indicator indicating an uplink signal-related DMRS port associated with a first PTRS port and a second indicator indicating an uplink signal-related DMRS port associated with a second PTRS port, and transmitting, based on the DCI, the uplink signal to the base station.

According to embodiments of the disclosure, a base station in a wireless communication system may include at least one transceiver, and at least one processor functionally coupled to the at least one transceiver, wherein the at least one processor is configured to receive, from a terminal supporting 8 antenna ports, terminal capability information including information about a number of layers supported by the terminal and information about coherent supported by the terminal, wherein the maximum number of layers supported by the terminal is four or eight, transmit, in case that the terminal supports partial coherent, to the terminal, configuration information for a coherent group based on a combination of two or four of the antenna ports supported by the terminal, and receive an uplink signal from the terminal, based on the configuration information for the coherent group.

According to an embodiment, the at least one processor may be further configured to, in case that the terminal supports full coherent and there is one phase tracking reference signal (PTRS) port supported by the terminal, determine first association information indicating an uplink signal-related demodulation reference signal (DMRS) port associated with the PTRS port, transmit downlink control information (DCI) including the first association information to the terminal, and receive, based on the DCI, the uplink signal from the terminal.

According to an embodiment, the uplink signal-related DMRS port associated with the PTRS port may correspond to a codeword (CW) having a higher modulation coding scheme (MCS) value among two codewords for transmission of the uplink signal.

According to an embodiment, the at least one processor may be further configured to transmit higher layer configuration information to the terminal, wherein the higher layer configuration information includes at least one of information on a precoder subset for uplink transmission, information on an SRS resource set, or information on an indicator indicating whether a codebook-based PUSCH or a non-codebook-based PUSCH is supported.

According to an embodiment, the at least one processor may be further configured to in case that the terminal supports full coherent and there are two PTRS ports supported by the terminal, determine second association information including a first indicator indicating an uplink signal-related DMRS port associated with a first PTRS port and a second indicator indicating an uplink signal-related DMRS port associated with a second PTRS port, transmit DCI including the second association information to the terminal, and receive, based on the DCI, the uplink signal from the terminal.

According to embodiments of the disclosure, a terminal in a wireless communication system may include at least one transceiver, and at least one processor functionally coupled to the at least one transceiver, wherein the at least one processor is configured to transmit, to a base station, terminal capability information including information about a number of layers supported by the terminal and information about coherent supported by the terminal, wherein the terminal supports 8 antenna ports and the maximum number of layers supported by the terminal is four or eight, receive, in case that the terminal supports partial coherent, from the base station, configuration information for a coherent group based on a combination of two or four of the antenna ports supported by the terminal, and transmit an uplink signal to the base station, based on the configuration information for the coherent group.

According to an embodiment, the at least one processor may be further configured to receive downlink control information (DCI) including first association information from the base station, wherein in case that the terminal supports full coherent and there is one phase tracking reference signal (PTRS) port supported by the terminal, the first association information indicates an uplink signal-related demodulation reference signal (DMRS) port associated with the PTRS port, and transmit, based on the DCI, the uplink signal to the base station.

According to an embodiment, the uplink signal-related DMRS port associated with the PTRS port may correspond to a codeword (CW) having a higher modulation coding scheme (MCS) value among two codewords for transmission of the uplink signal.

According to an embodiment, the at least one processor may be further configured to receive higher layer configuration information from the base station, wherein the higher layer configuration information includes at least one of information on a precoder subset for uplink transmission, information on an SRS resource set, or information on an indicator indicating whether a codebook-based PUSCH or a non-codebook-based PUSCH is supported.

According to an embodiment, the at least one processor may be further configured to receive DCI including the second association information from the base station, wherein the second association information includes, in case that the terminal supports full coherent and there are two PTRS ports supported by the terminal, a first indicator indicating an uplink signal-related DMRS port associated with a first PTRS port and a second indicator indicating an uplink signal-related DMRS port associated with a second PTRS port, and transmit, based on the DCI, the uplink signal to the base station.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. As an example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1.-15. (canceled)

16. A user equipment (UE) in a wireless communication system, the UE comprising:
a transceiver; and
a controller coupled to the transceiver, and configured to:
transmit, to a base station, first capability information indicating whether the UE supports 8 antenna ports and a first maximum number of layers supported by the UE,
receive, from the base station, first information configuring a second maximum number of layers for a physical uplink shared channel (PUSCH), wherein the second maximum number of layers is larger than four and smaller than or equal to eight,
receive, in case that the UE supports a coherent transmission, from the base station, second information configuring a codebook type for the PUSCH, wherein the codebook type is based on four antenna port groups, each of the four antenna port groups including two antenna ports, and
transmit, to the base station, the PUSCH using a precoding matrix based on a codebook corresponding to the codebook type.

17. The UE of claim 16,
wherein the controller is further configured to:
in case that the UE is scheduled with two codewords and is configured with one phase tracking reference signal (PTRS) port, receive, from the base station, first downlink control information (DCI) including first association information, and
wherein the first association information indicates that the one PTRS port is associated with a demodulation reference signal (DMRS) port for a codeword with a higher modulation coding scheme (MCS) value among the two codewords or for a codeword 0 if MCS values of the two codewords are same.

18. The UE of claim 16,
wherein the controller is further configured to:
in case that the UE is configured with two phase tracking reference signal (PTRS) ports, receive, from the base station, second downlink control information (DCI) including second association information,
wherein the second association information indicates an association between a PTRS port and a demodulation reference signal demodulation reference signal (DMRS) port corresponding to at least one of a sounding reference signal (SRS) resource indicator (SRI) or a number of layers, and
wherein two most significant bits (MSBs) of the second association information is for a PTRS port 0 and two least significant bits (LSBs) of the second association information is for a PTRS port 1.

19. The UE of claim 16, wherein the controller is further configured to:
transmit, to the base station, second capability information including information on a coherent supported by the UE, and
receive, from the base station, third information configuring at least one of information on a precoder subset for an uplink transmission, information on a sounding reference signal (SRS) resource set, or information on an indicator indicating whether a codebook-based PUSCH or a non-codebook-based PUSCH is supported.

20. A base station in a wireless communication system, the base station comprising:
a transceiver; and
a controller coupled to the transceiver, and configured to:
receive, from a user equipment (UE), first capability information indicating whether the UE supports 8 antenna ports and a first maximum number of layers supported by the UE,
transmit, to the UE, first information configuring a second maximum number of layers for a physical uplink shared channel (PUSCH), wherein the second maximum number of layers is larger than four and smaller than or equal to eight,
transmit, in case that the UE supports a coherent transmission, to the UE, second information configuring a codebook type for the PUSCH, wherein the codebook type is based on four antenna port groups, each of the four antenna port groups including two antenna ports, and
receive, from the UE, the PUSCH using a precoding matrix based on a codebook corresponding to the codebook type.

21. The base station of claim 20,
wherein the controller is further configured to:
in case that the UE is scheduled with two codewords and is configured with one phase tracking reference signal (PTRS) port, transmit, to the UE, first downlink control information (DCI) including first association information, and
wherein the first association information indicates that the one PTRS port is associated with a demodulation reference signal (DMRS) port for a codeword with a higher modulation coding scheme (MCS) value among the two codewords or for a codeword 0 if MCS values of the two codewords are same.

22. The base station of claim 20,
wherein the controller is further configured to:
in case that the UE is configured with two phase tracking reference signal (PTRS) ports, transmit, to the UE, second downlink control information (DCI) including second association information,
wherein the second association information indicates an association between a PTRS port and a demodulation reference signal (DMRS) port corresponding to at least one of a sounding reference signal (SRS) resource indicator (SRI) or a number of layers, and
wherein two most significant bits (MSBs) of the second association information is for a PTRS port 0 and two least significant bits (LSBs) of the second association information is for a PTRS port 1.

23. The base station of claim 20, wherein the controller is further configured to:
receive, from the UE, second capability information including information on a coherent supported by the UE, and
transmit, to the UE, third information configuring at least one of information on a precoder subset for an uplink transmission, information on a sounding reference signal (SRS) resource set, or information on an indicator indicating whether a codebook-based PUSCH or a non-codebook-based PUSCH is supported.

24. A method performed by a user equipment (UE) in a wireless communication system, the method comprising:
transmitting, to a base station, first capability information indicating whether the UE supports 8 antenna ports and a first maximum number of layers supported by the UE;
receiving, from the base station, first information configuring a second maximum number of layers for a physical uplink shared channel (PUSCH), wherein the second maximum number of layers is larger than four and smaller than or equal to eight;
receiving, in case that the UE supports a coherent transmission, from the base station, second information configuring a codebook type for the PUSCH, wherein the codebook type is based on four antenna port groups, each of the four antenna port groups including two antenna ports; and
transmitting, to the base station, the PUSCH using a precoding matrix based on a codebook corresponding to the codebook type.

25. The method of claim 24, further comprising:
in case that the UE is scheduled with two codewords and is configured with one phase tracking reference signal (PTRS) port, receiving, from the base station, first downlink control information (DCI) including first association information,
wherein the first association information indicates that the one PTRS port is associated with a demodulation reference signal (DMRS) port for a codeword with a higher modulation coding scheme (MCS) value among the two codewords or for a codeword 0 if MCS values of the two codewords are same.

26. The method of claim 24, further comprising:
in case that the UE is configured with two phase tracking reference signal (PTRS) ports, receiving, from the base station, second downlink control information (DCI) including second association information,
wherein the second association information indicates an association between a PTRS port and a demodulation reference signal (DMRS) port corresponding to at least one of a sounding reference signal (SRS) resource indicator (SRI) or a number of layers, and
wherein two most significant bits (MSBs) of the second association information is for a PTRS port 0 and two least significant bits (LSBs) of the second association information is for a PTRS port 1.

27. The method of claim 24, further comprising:
transmitting to the base station, second capability information including information on a coherent supported by the UE; and
receiving, from the base station, third information configuring at least one of information on a precoder subset for an uplink transmission, information on a sounding reference signal (SRS) resource set, or information on an indicator indicating whether a codebook-based PUSCH or a non-codebook-based PUSCH is supported.

28. A method performed by a base station in a wireless communication system, the method comprising:
receiving, from a user equipment (UE), first capability information indicating whether the UE supports 8 antenna ports and a first maximum number of layers supported by the UE;
transmitting, to the UE, first information configuring a second maximum number of layers for a physical uplink shared channel (PUSCH), wherein the second maximum number of layers is larger than four and smaller than or equal to eight;
transmitting, in case that the UE supports a coherent transmission, to the UE, second information configuring a codebook type for the PUSCH, wherein the codebook type is based on four antenna port groups, each of the four antenna port groups including two antenna ports; and
receiving, from the UE, the PUSCH using a precoding matrix based on a codebook corresponding to the codebook type.

29. The method of claim 28, further comprising:
in case that the UE is scheduled with two codewords and is configured with one phase tracking reference signal (PTRS) port, transmitting, to the UE, first downlink control information (DCI) including first association information,
wherein the first association information indicates that the one PTRS port is associated with a demodulation reference signal (DMRS) port for a codeword with a higher modulation coding scheme (MCS) value among the two codewords or for a codeword 0 if MCS values of the two codewords are same.

30. The method of claim 28, further comprising:
in case that the UE is configured with two phase tracking reference signal (PTRS) ports, transmitting, to the UE, second downlink control information (DCI) including second association information,
wherein the second association information indicates an association between a PTRS port and a demodulation reference signal (DMRS) port corresponding to at least one of a sounding reference signal (SRS) resource indicator (SRI) or a number of layers, and
wherein two most significant bits (MSBs) of the second association information is for a PTRS port 0 and two least significant bits (LSBs) of the second association information is for a PTRS port 1.

31. The method of claim 28, further comprising:
receiving, from the UE, second capability information including information on a coherent supported by the UE; and
transmitting, to the UE, third information configuring at least one of information on a precoder subset for an uplink transmission, information on a sounding reference signal (SRS) resource set, or information on an indicator indicating whether a codebook-based PUSCH or a non-codebook-based PUSCH is supported.
